(19) United States
(12) Patent Application Publication
(10) Pub. No.: US 2016/0203352 A1
(43) Pub. Date: Jul. 14, 2016

(54) USING SCANABLE CODES TO OBTAIN A SERVICE

(71) Applicant: FLASHBACK SURVEY, INC., Chapel Hill, NC (US)

(72) Inventor: Peter Joseph Marsico, Chapel Hill, NC (US)

(21) Appl. No.: 15/023,577

(22) PCT Filed: Sep. 15, 2014
(86) PCT No.: PCT/US14/55675

§ 371 Date: Mar. 21, 2016

Related U.S. Application Data
(60) Provisional application No. 61/960,544, filed on Sep. 20, 2013.
(60) Provisional application No. 61/961,298, filed on Oct. 10, 2013.
(60) Provisional application No. 62/011,750, filed on Jun. 13, 2014.

(51) Int. Cl. G06K 7/14; G08B 21/02

(52) U.S. Cl. CPC G06K 7/1417; G08B 21/02

(57) ABSTRACT

Disclosed are methods, systems and computer program products for surveying a user using a scanable information encoded graphic image, such as a bar code or a quick response (QR) code, near field communication (NFC) code/tag, radio frequency identification (RFID) code/tag. In one embodiment, a mobile communication device such as a smartphone, tablet computer or other mobile computer is adapted to include a scan client module for scanning and communicating scan-triggered service code in-formation to a scan-triggered application server. QR code scanning is accomplished by a camera module that is associated with the smartphone or other mobile computing device. The scan-enabled client module communicates the scanned QR code information to an associated server application for collecting, processing and reporting scan data.

### PRIORITY CLAIM

This application claims the benefit of U.S. Provisional Patent Application Ser. No. 61/960,544, filed Sep. 20, 2013, U.S. Provisional Patent Application Ser. No. 61/961,298, filed Oct. 10, 2013, and U.S. Provisional Patent Application Ser. No. 62/011,750, filed Jun. 13, 2014; the disclosures of which are incorporated herein by reference in their entireties.

### TECHNICAL FIELD

The subject matter described herein relates to methods and systems for using a scanable service code to initiate and facilitate a scan-triggered user service.

### BACKGROUND

Applications often require users, such as the users of mobile communication devices, to manually activate and interact with software in order to utilize the associated services. For example, information collection systems that are typically deployed to gather information from a consumer of goods and services are often intrusive and time consuming from the perspective of the consumer. While such information collection systems are capable of gathering detailed information from a consumer, these systems require a relatively high level of user interaction to obtain the associated services, and furthermore do not give the user an incentive to participate nor an easy way to obtain high-utility services.

In light of these problems, what is needed is a system and method for providing high-utility scan-triggered services to a user.

### SUMMARY

According to one aspect, the subject matter described herein includes systems and methods for surveying a user using a scanable information element, such as a radio frequency identification (RFID) encoded tag, a near field communication (NFC) encoded tag, or an encoded graphic image, such as a bar code or a quick response (QR) code tag. In one embodiment, a mobile communication device such as a smartphone, tablet computer, computer-integrated eyewear, wear-able computer or communication devices, or other mobile computer is adapted to include a scan-enabled client module for scanning and communicating scan-triggered service code information.

According to one aspect of the subject matter described herein, a scan-triggered service code is associated with a food product allergen notification service for users. A user may provision one or more food allergen profiles. A food manufacturer provisions food allergen information associated with a food or beverage product. An EatSafe square scan code is associated with the provisioned food allergen content information. When the user scans the EatSafe square scan code, food product and user identifying information is communicated to the hosting scan-triggered server, which uses the received information to determine whether a potential food allergen conflict exists for the user. If a conflict is determined to exist, the user is notified of the potential food or beverage allergen issue. Product recall and expiration information may also be returned to the user.

According to another aspect of the subject matter described herein, a scan-triggered service code is associated with a food or beverage recipe. A recipe square scan code is associated with the provisioned recipe information. When the user scans the recipe square scan code, recipe and user identifying information is communicated to the hosting scan-triggered server, which places the associated recipe in a digital recipe book associated with the user's scan-triggered service account. Recipe information may be accessed/browsed by the user. A reward may be credited to a digital reward wallet associated with the user's scan-triggered service account.

According to another aspect of the subject matter described herein, a scan-triggered service code is associated with one or more waypoint locations in a queue. A Q-Game square scan code is associated with each provisioned queue waypoint location. When a user scans a first Q-Game square waypoint scan code, queue waypoint and user identifying information is communicated to the hosting scan-triggered server, which timestamps and logs receipt of the first waypoint scan information. When the user scans a second Q-Game square waypoint scan code, queue waypoint and user identifying information is communicated to the hosting scan-triggered server, which timestamps and logs receipt of the second waypoint scan information. Inter-waypoint transit time metrics may be calculated and reported by the scan-triggered server. A digital reward, online game asset credit or video credit may be granted to the scanning user. A reward may be credited to a digital reward wallet associated with the user's scan-triggered service account.

According to another aspect of the subject matter described herein, a scan-triggered service code is associated with a digital reward. A Freebie Square scan code is associated with the provisioned digital reward information. When the user scans the Freebie Square scan code, digital reward and user identifying information is communicated to the hosting scan-triggered server, which determines whether the requested reward should be granted to the user and the value of the reward. A reward may be credited to a digital reward wallet associated with the user's scan-triggered service account.

According to another aspect of the subject matter described herein, a scan-triggered service code is associated with a survey question and associated response options. A question square scan code is associated with the provisioned survey question information. When the user scans the question square scan code, question and user identifying information is communicated to the hosting scan-triggered server, which uses the question identifying information to access the associated response option information. The response option content is returned or communicated and displayed to the scanning user. The user selects one or more response options and response option selection information is communicated to the scan-triggered server, where it is logged and recorded. A reward may be credited to a digital reward wallet associated with the user's scan-triggered service account.

The subject matter described herein for facilitating scan-triggered services may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a non-transitory computer readable medium having stored thereon computer executable instructions that when executed by the processor of a computer perform steps. Exemplary computer readable media suitable for implementing the subject matter described herein include disk memory devices, programmable logic devices, application specific integrated circuits, and downloadable electrical signals. In addition, a computer readable medium that implements the subject matter described herein may be located on a single device or computing platform distributed across multiple physical devices and/or computing platforms.

### BRIEF DESCRIPTION OF THE DRAWINGS

Embodiments of the subject matter described herein will now be explained with reference to the accompanying drawings of which:

FIG. 1 is a functional block diagram which illustrates a mobile communication device that includes a scanable code reader module, such as a quick response (QR) code scanner module and exemplary scan-enabled client module;

FIG. 2 is a functional block diagram which illustrates a scan-triggered application server that includes an exemplary server application module for providing scan-triggered services to users;

FIGS. 3A-3E illustrate exemplary embodiments of EatSafe square scan-triggered service;

FIGS. 3F-3H illustrate exemplary EatSafe square provisioning and scan transaction data;

FIGS. 4A-4C illustrate embodiments of a recipe square scan-triggered service;

FIGS. 4D-4E illustrate exemplary recipe square provisioning and scan transaction data;

FIGS. 5A-5F illustrate exemplary embodiments of Q-Game square scan-triggered service;

FIGS. 5G-5I illustrate exemplary Q-Game square provisioning and scan transaction data;

FIGS. 6A-6C illustrate exemplary embodiments of FreeBie square scan-triggered service;

FIGS. 6D-6E illustrate exemplary FreeBie square provisioning and scan transaction data;

FIGS. 7A-7B illustrate exemplary embodiments of question square scan-triggered service; and

FIG. 7C illustrates exemplary question square provisioning and scan transaction data.

### DETAILED DESCRIPTION

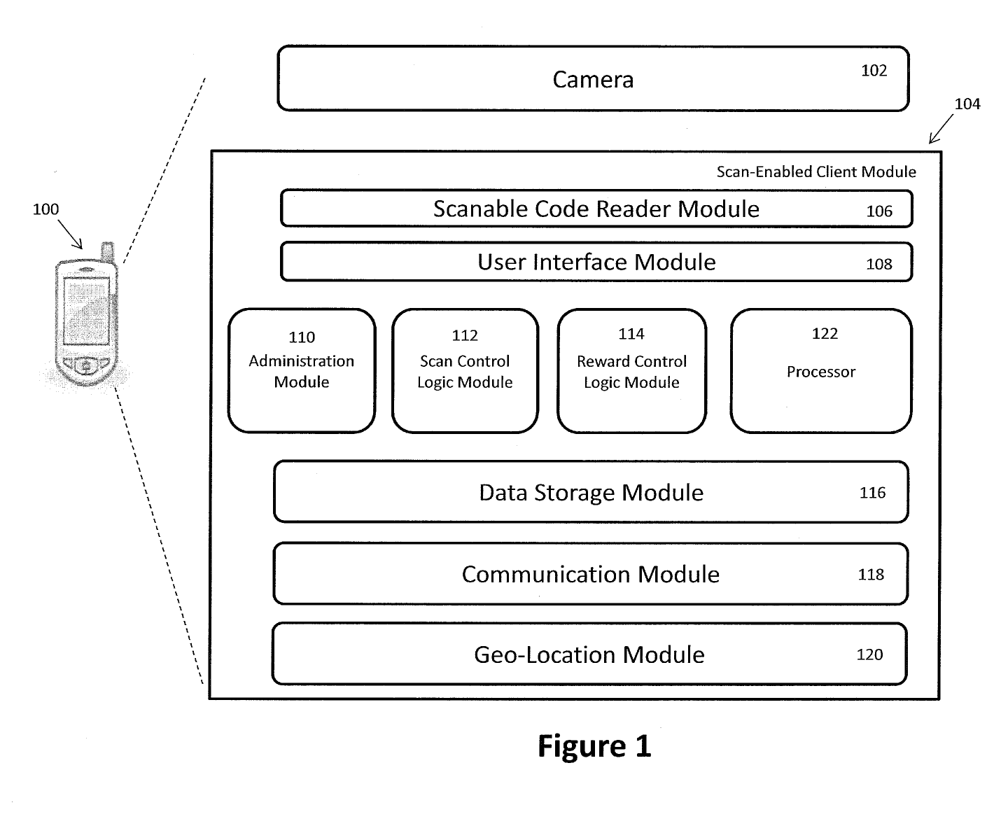

Disclosed are systems and methods for using a scanable code, such as quick response (QR) code, a near field communication (NFC) code, radio frequency identification (RFID) code, or similar optical, magnetic or electrical scanable codes, to provide a service to a user who scans the code. In a one embodiment, a scan code-based services system of the subject matter described herein includes a scan-enabled client module, which may be implemented in hardware, software, firmware or a combination thereof and which resides on a mobile communication device, such as a smartphone, tablet computer, netbook computer, computer-integrated eyeglasses, computer-integrated wristwatch, wearable electronics or other mobile computing device that is capable of communicating with a network server. The scan-enabled client module may include an executable computer program (e.g., C++, Java, etc.) that is adapted to be downloaded onto the mobile communication device, installed and executed. The scan-enabled client module may also include a web browser that is adapted to access and execute web-based software (e.g., JavaScript, etc.) that provides a least a portion of the necessary scan-enabled client functionality. FIG. 1 is a block diagram that illustrates an exemplary architecture of a smartphone-based scan-enabled client module. Mobile device 100, which may be a smart phone or other mobile computing device, includes a camera 102 that is adapted to capture and store an image in a digital format. Smartphone 100 also includes a scan-enabled client module 104. Scan-enabled client module 104 is comprised of scanable code reader module 106, a user interface module 108, an administration module 110, a scan control logic module 112, a participation reward control logic module 114, a data storage module 116, a communication module 118, and geo-location module 120, and processor module 122.

The extracted scan-triggered service information may comprise information that is representative, for example, of an alphanumeric text string, a numeric code. In one embodiment, the extracted scan-triggered service information may be used to identify and facilitate the providing of scan-triggered rewards based on the scanning of service scan codes. The decoded scan code information is provided to an associated server application module via communication module 118. In an alternate embodiment, scan code reader module 106 is adapted to receive digital image information from camera 102 and to communicate the digital image information (e.g., JPEG) to an associated server application module via communication module 118 where decoding processing is performed. In one embodiment, information that identifies or can be used to identify a scan-triggered service user (e.g., user name, user ID, session ID, etc.) is also provided to the server application module.

User interface module 108 is adapted to present the mobile device user with a graphical user interface for enabling the user to generally control and operate the functionality of the scan-enabled client module 104. User interface module 108 is adapted to present a menu structure to the user and enable the user to navigate this menu structure. The menu structure provides a user with access to administrative functions, such as scan triggered service account settings (e.g., username, password, service preferences, personal information, etc.), account log-in. Such administrative functions are controlled within scan-capable or scan-enabled client module 104 via administration module 110. The menu structure may also provide the user with the ability to control the associated smartphone camera. In some embodiments, the ability to access and operate the smartphone camera in the manner required to effectively photograph or scan a scan code icon, such as a QR code, is provided via scan control logic module 112. In one exemplary embodiment, scan-enabled client module 104 may include a native application that is adapted to execute on mobile device 100, and in such a case that native application may include QR scanning / decoding capability or alternatively scan-enabled client module 104 may simply invoke the services of a third-party QR scanner/decoder that is installed in the mobile device. In another exemplary embodiment, a third-party QR scanner/decoder may be invoked by the mobile device user to scan and decode a suitably provisioned QR, where decoding of the QR code causes a web browser instance to be launched and directed to a URL associated with the application server. In this case, information that identifies the relevant/necessary scan-triggered service information may be passed to the application server via the URL/URL parameters. For example, in one embodiment, information that identifies a scan-triggered service and relevant/necessary service information may be explicitly or implicitly communicated to the application server via the URL itself (e.g., the host name and/or path and/or query string components of the URL can be used by the application server to explicitly or implicitly identify the service information). In an alternate embodiment, for example, all communications between the user's mobile device and the application server may be addressed to a URL which points to a scan-based service provider (e.g., www.flashbacksurvey.com), and the information that identifies the scan-triggered service may be communicated to the scan-based service provider's application server via the path and/or query string parameter portions of the URL. In one embodiment, such a URL address associated with the scan-triggered service platform may be encoded or otherwise incorporated into a scan code associated with a scan-triggered service platform, or which requests scan-triggered application service from a scan-triggered service platform. In one embodiment, the URL which points scan-based service provider (e.g., www.flashbacksurvey.com), and the information that identifies the scan-triggered service may be encrypted, such that only a particular code scanner, native mobile code scanning application, or mobile web browser with integrated code scanning capability which has access to or is provisioned with the appropriate decryption/de-obfuscation key information can decode and process the scan-triggered service URL information and thereby facilitate the providing of the associated scan-triggered service. As such, a particular scan-triggered service code may be “locked” to all code scanners but the scanner that has access to/is provided with the appropriate decrypt/de-obfuscation key information, thereby providing users with an added measure of security with respect to accessing scan-triggered services.

The menu structure also provides the user with the ability to access and redeem participation rewards. Participation reward access and redemption functionality is provided by reward control logic module 114. Data storage module 116 is adapted to provide both long term storage of data associated with the scan-enabled client module, as well as short term, cache-type storage of scan client related data. Exemplary uses of the data storage are discussed in more detail in the disclosure that follows.

Communications module 118 is adapted to facilitate the communication of information between scan-enabled client module 104 and an associated server application module. For example, communication module 118 may receive information from scan control logic module 112 that is to be communicated to an associated server application module. Communication module 118 may package the information according to a pre-defined message format and forward the message to a data communications interface associated with the smartphone. Exemplary data communication interfaces may include, but are not limited to, a General Packet Radio Service (GPRS) interface, an Enhanced Data Rates for GSM Evolution (EDGE), High Speed Packet Access (HSPA), WiMax, Wi-Fi, LTE, etc. For example, in one embodiment, when a user scans a service scan code associated with a scan-triggered service, communication module 118 is adapted to communicate to an associated server application module information that was encoded in the scanned service code as well as information that can be used to identify the user. Information that can be used to identify the user may include a user identifier (e.g., username, email address, mobile IP address, session ID, etc.). It will be appreciated that the communication of such user identifying information to the server module may be triggered upon scanning of the QR code or may be triggered upon startup of software associated with scan-enabled client module 104 (e.g., auto-login, manual login, etc.). As such, the communication of user identifying information and information obtained from the scanning of a scan code may be accomplished via a single message that is communicated between scan-enabled client module 104 and an associated server module, or this information may be communicated via multiple messages to the application server module. In one embodiment, when a user presents login credentials (e.g., username and password) and is successfully authenticated, a communication channel or session is established between a scan-enabled client module (e.g., a smartphone web browser or native application) and a server application module (e.g., an application residing on a network-based host computer), and all subsequent communications made via the session or channel are associated with the user's login credential/identity information. In this way, a user's identity information may be provided before, during, or even after the scanning of an associated service scanable code (e.g., QR code, NFC code, RFID code, etc.), and thereafter bound to the information derived or obtained from scanning of the code. In another embodiment, the scanning of a scan code by a user triggers the scan-enabled client module 104 to access previously stored login credential information (e.g., login credential information stored in a file or cookie that is resident on mobile communication device 100. Scan-enabled client module 104 automatically provides the user's login credentials to the application server module, which then associates the information obtained from the scanning of the scan code with the user's account. Once the session is established, information obtained and provided to the application server module is automatically associated with the user's account. These same user identity binding techniques may be employed with any of the embodiments of the subject matter described herein.

Geo-location module 120 is adapted to determine geo-location information indicative of the geographic position of mobile communication device 100. Geo-location information determined by module 120 may include Global Positioning System (GPS) coordinate information (e.g., latitude, longitude, elevation). Module 120 may determine this geo-location information and generally facilitate the communication of this information to an associated server application module in conjunction with the communication of scanned graphic icon (e.g., QR code) information, thereby enabling the server application module to identify and store the location at which a QR code was scanned. Alternatively, geo-location or position information may be encoded in the QR code that was scanned, and once scanned the location information may be decoded by geo-location module 120 and passed along to a server application module associated with the scan code-based service system. It is understood that with the addition of scan-enabled client module 104, mobile device 100 becomes a special purpose computing platform that improves the functionality of mobile device 100 by providing direct access to a server application in response to receiving a scanned code from camera 102. Mobile device 100 with scan-enabled client module 104 also improves the technological field of network access to services because such services can be accessed automatically and quickly with a reduced likelihood of data entry errors. In some embodiments of the subject matter described herein, scan-enabled client module 104 may also improve the technological fields of food science and individual health management by providing automatic access to food information, including individualized food allergen information, in response to the scanning of a scanable code. Processor 122 is adapted to facilitate the execution of software and firmware associated with the operation of modules 106, 108, 110, 112, 114, 116, 118 and 120, which is used to provide the overall scan-enabled client module functionality described herein. Exemplary implementations of processor 122 include, but are not limited to, one or more single-core microprocessors, one or more multi-core microprocessors, and one or more programmable logic devices (e.g., complex programmable logic devices, a field-programmable gate arrays, etc.).

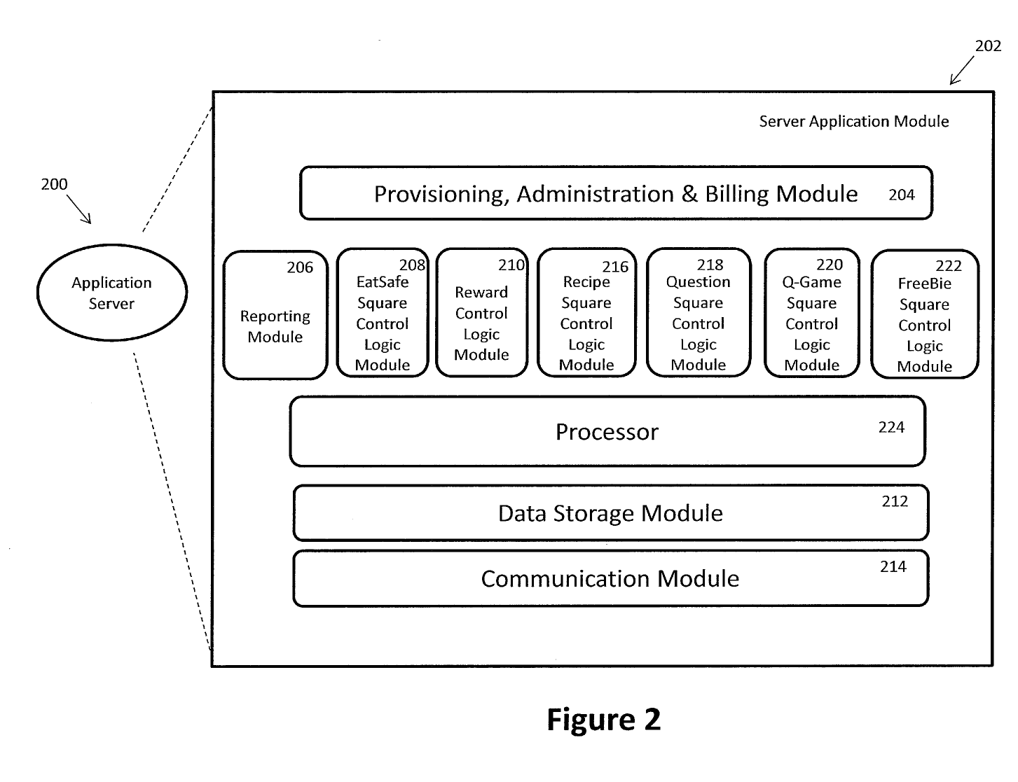

Shown in FIG. 2 is a block diagram that illustrates an exemplary architecture of a server application module 202, which resides and executes on a network or cloud-hosted application server 200. In the embodiment presented in FIG. 2, the server application module is comprised of a provisioning, administration and billing module 204, a reporting module 206, an EatSafe square control logic module 208, a reward control logic module 210, a data storage module 212, a communication module 214, a Recipe square control logic module 216, a question square control logic module 218, a Q-Game square control logic module 220, a Freebie square control logic module 222, and processor 224. The purpose and function of each of these modules and of the processor is described below. Server application module 202 executing on application server 200 makes application server 200 a special purpose computing platform that improves the functionality of application server 200 by configuring application server 200 to process received scanned codes and providing the indicated service in response to receiving the scanned codes. As such, server application module 202 improves the technological fields of network access to services by providing such services automatically in response to receiving the scanned codes and with a reduced likelihood of data entry error. In some embodiments of the subject matter described herein, server application module 202 may also improve the technological fields of food science and individual health management by providing automatic access to food information, including individualized food allergen information, in response to the scanning of a scanable code. The purpose and function of each of these modules is described below.

Provisioning, administration and billing module 204 is adapted to provide access for a provisioning entity or user, such as a medical office administrator, merchant entity, a delivery service vendor entity, an event venue entity, mobile user entity or a system administrator, to provision registration information, subscription configurations/preference information, service configuration information, and participation reward content information. In the context of this disclosure, a user is considered to be the operator or user of a mobile communication device (e.g., computer integrated eyewear, wearable computer, smartphone, tablet computer, etc.) that includes a scan-enabled client module, and is therefore capable of scanning a QR code (or other encoded, scanable code) and provide, trigger, initiate or facilitate the providing of a service to the user. For example, a user may be a consumer of goods and services provided by a merchant, an attendee of an event, a medical patient, a shopper, or an employee of a corporation.

In all of the embodiments disclosed herein, a scanning user may be granted or credited with a digital reward or coupon in response to the scanning of an associated scan-triggered service code. Exemplary digital rewards may include, but are not limited to, a digital or electronic coupon associated with a good or a service, a credit for an online gaming service, a credit for an online video, an audio or video download. In one embodiment, the value of a granted digital reward may be determined, based at least in part, on the type/brand/manufacturer of the mobile phone that was used to scan the associated scan-triggered service scan code. In one embodiment, such rewards may be credited or placed in a digital reward wallet associated with the user, whereby the user can access and redeem a granted reward. In one embodiment, a reward granted to a user may be granted at a first value (e.g., $1 off next purchase) and subsequently modified to a second value (e.g., $2 off next purchase) at a later by Reward Control Module 210.

Module 210 may facilitate the sharing of a scan-triggered service platform-granted reward from one user to another user, where sharing may include the gifting, transferring, or cloning of a granted reward. In this case, a first user who is the current owner of a reward selects the reward and identifies a second user to whom the reward is to be transferred. The first user then communicates information that identifies both the reward and the “transferred to” user to module 210. The information that identifies the “transferred to” or recipient user may be a username or user ID provided by the recipient user at the time of registration by the recipient user. Module 210 receives, processes and logs the transfer request and updates the appropriate reward data so as to execute the transfer. In one embodiment, reporting module 206 enables an administrative entity or user to view, track and analyze such reward transfers. In various embodiments of the subject matter described herein, restrictions/limitations/qualifications may be imposed on rewards that are to be transferred or gifted from one user to another. For instance, module 210 may include reward transfer or gifting rules that specify those conditions under which a reward may be transferred and/or those conditions under which a reward may not be transferred. These rules may be stored in a database, table, or data structure that is contained within or accessible by module 210. An exemplary rule may state that a reward may only be transferred or gifted to a new user (e.g., a user that has registered for service within the past 30 days, etc.). In order to enforce this rule module 210 may access user registration data that is maintained in data storage module 212. Another exemplary rule may state that a reward may only be transferred or gifted to a user who has not previously patronized the scan-triggered service client entity with which the reward is associated. In order to enforce this rule module 210 may access user transaction data that is maintained in data storage module 212.

In one embodiment, reward sharing functionality includes functionality where an existing user may clone/copy, transfer or gift a reward to an individual who has not yet become a registered scan-triggered service user. To facilitate such a special transfer, the existing user communicates information that identifies both the reward and the “transferred to” or recipient user to module 210. In this case, since the recipient user is not yet a registered user of the system/service, the existing user must specify a public contact address for the intended recipient. Exemplary public contact addresses may include, but are not limited to, an email address, a mobile telephone number, a mobile subscriber ISDN (MSISDN), a Twitter address, an instant message address. Module 210 receives processes and logs the transfer request. In one embodiment, module 210 is adapted to generate a message that is addressed to the specified public contact address (e.g., email address). In one embodiment, the message may include the transferred reward or information specifying how the transferred reward may be obtained and redeemed. In another embodiment, the message may include information that describes the pending reward transfer and also provides a hyperlink/URL associated with a web page where the intended recipient may register and thereby receive and redeem the transferred reward. The existing user that transferred or gifted the reward (thereby resulting in the recruitment/registration of a new subscriber) may be issued a new reward as a result of the transfer. The new reward may be the same as the transferred reward or different. The new reward may be issued by reward control logic module 210.

Processor 224 is adapted to facilitate the execution of software and firmware associated with the operation of modules 204, 206, 208, 210, 212, 214, 216, 218, 220 and 222, which is used to provide the overall server application module functionality described herein. Exemplary implementations of processor 224 include, but are not limited to, one or more single-core microprocessors, one or more multi-core microprocessors, and one or more programmable logic devices (e.g., complex programmable logic devices, a field-programmable gate arrays, etc.).

EatSafe Square

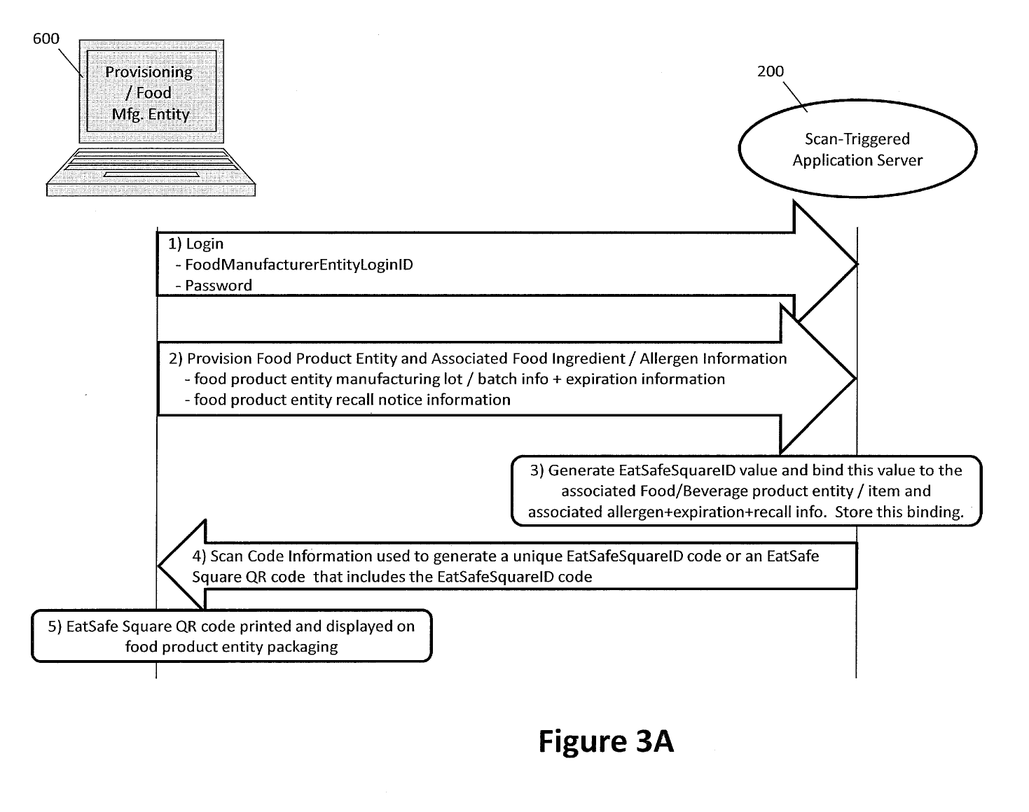

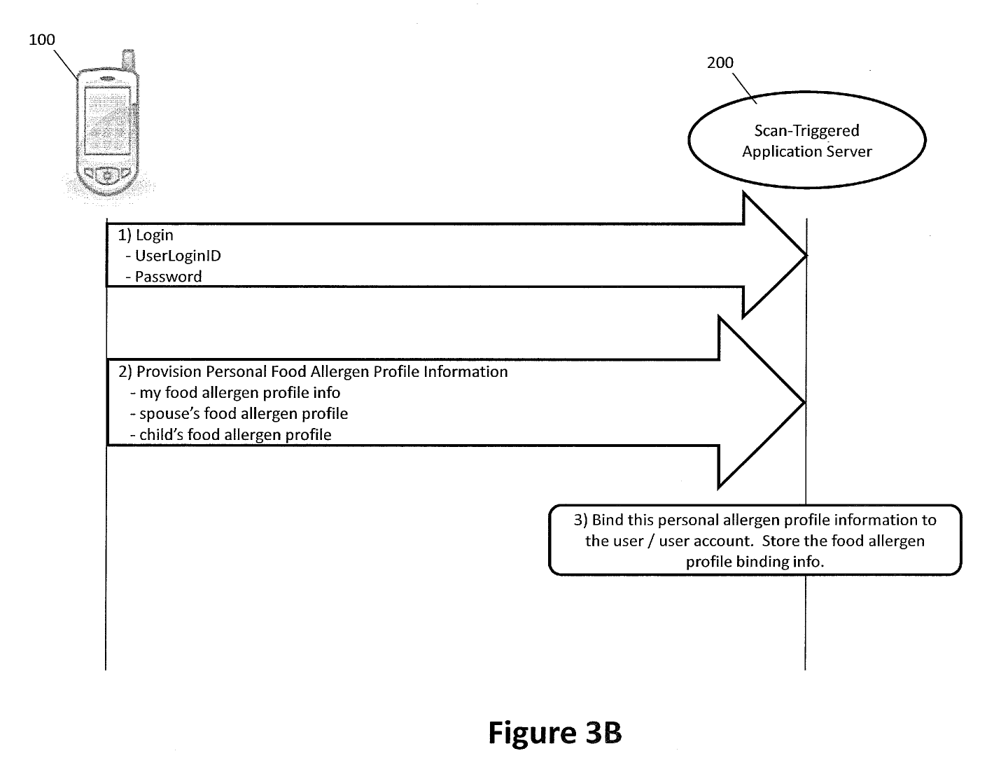

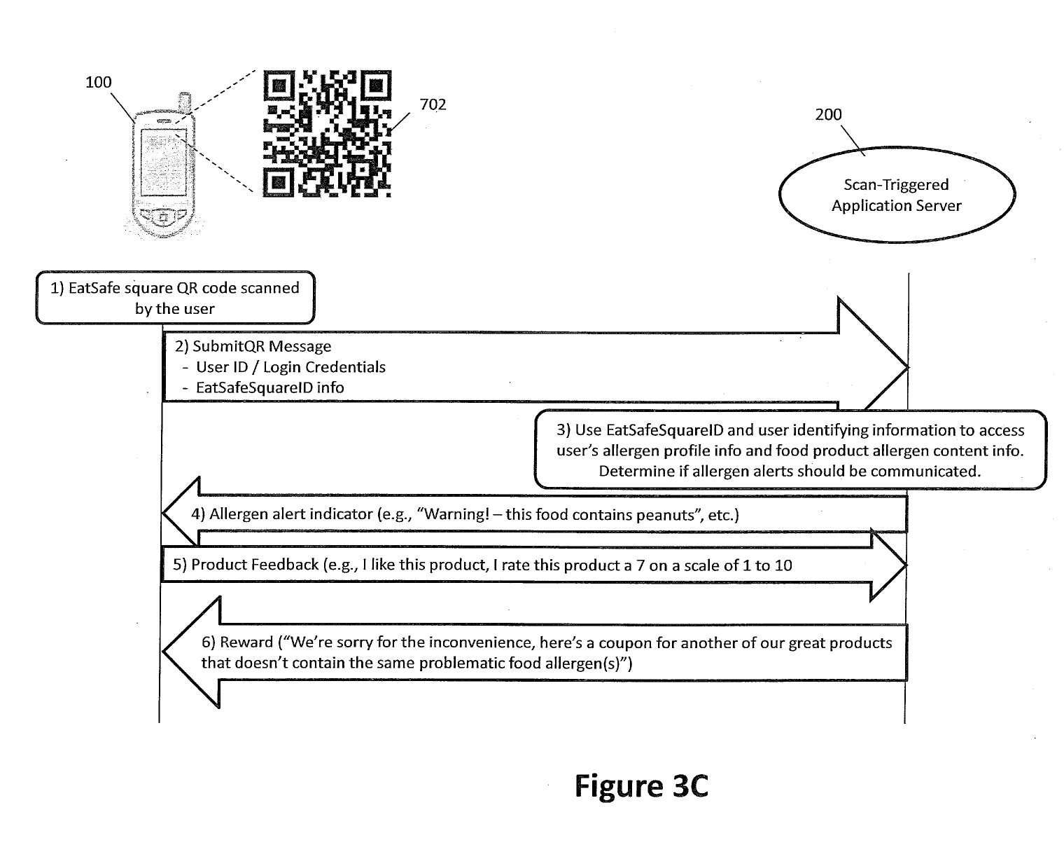

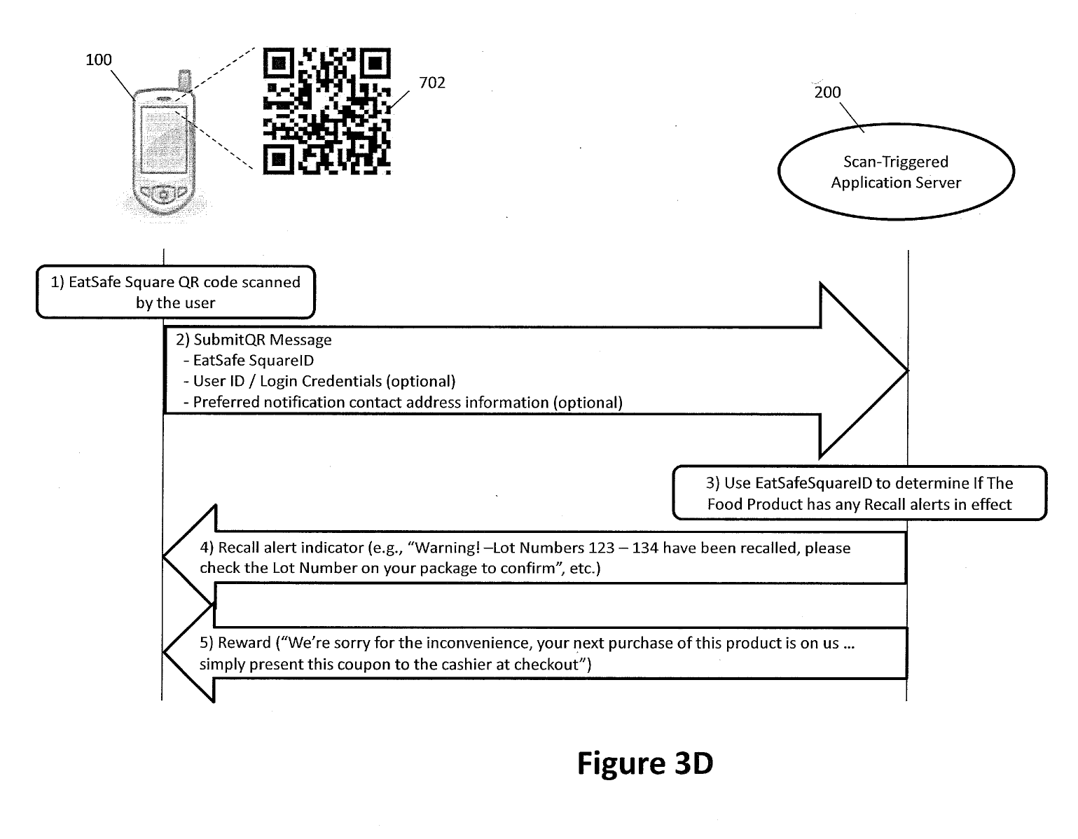

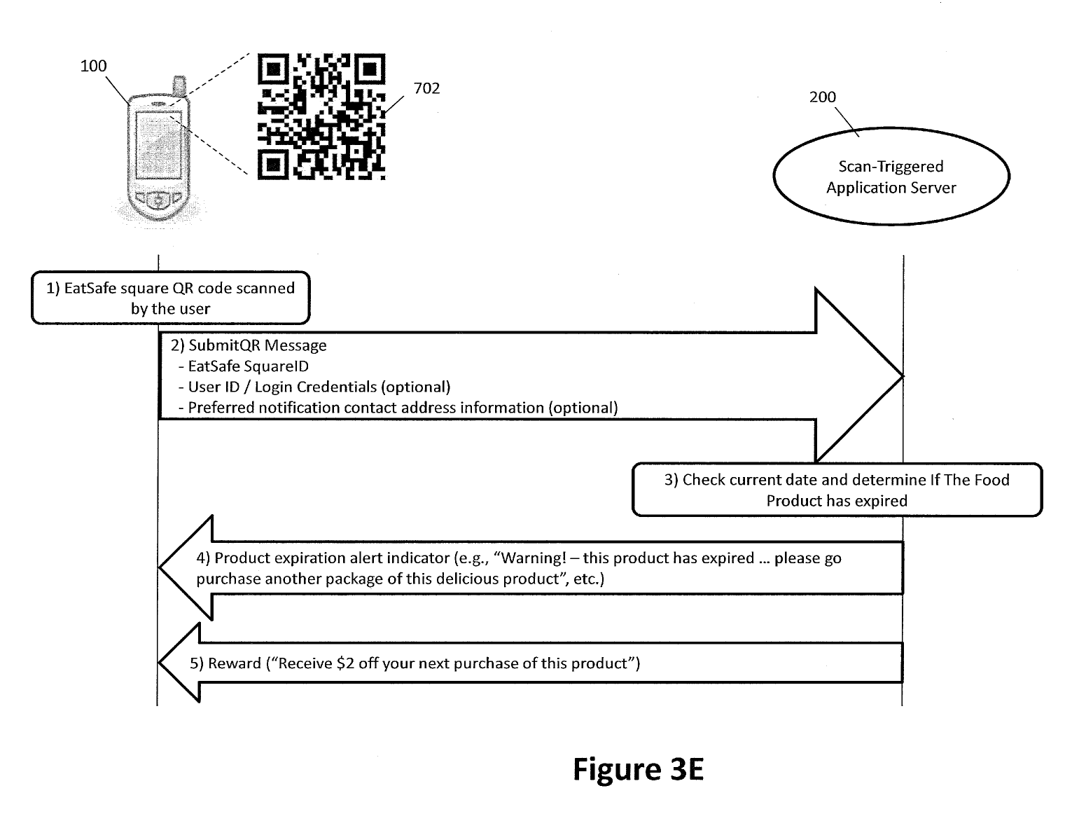

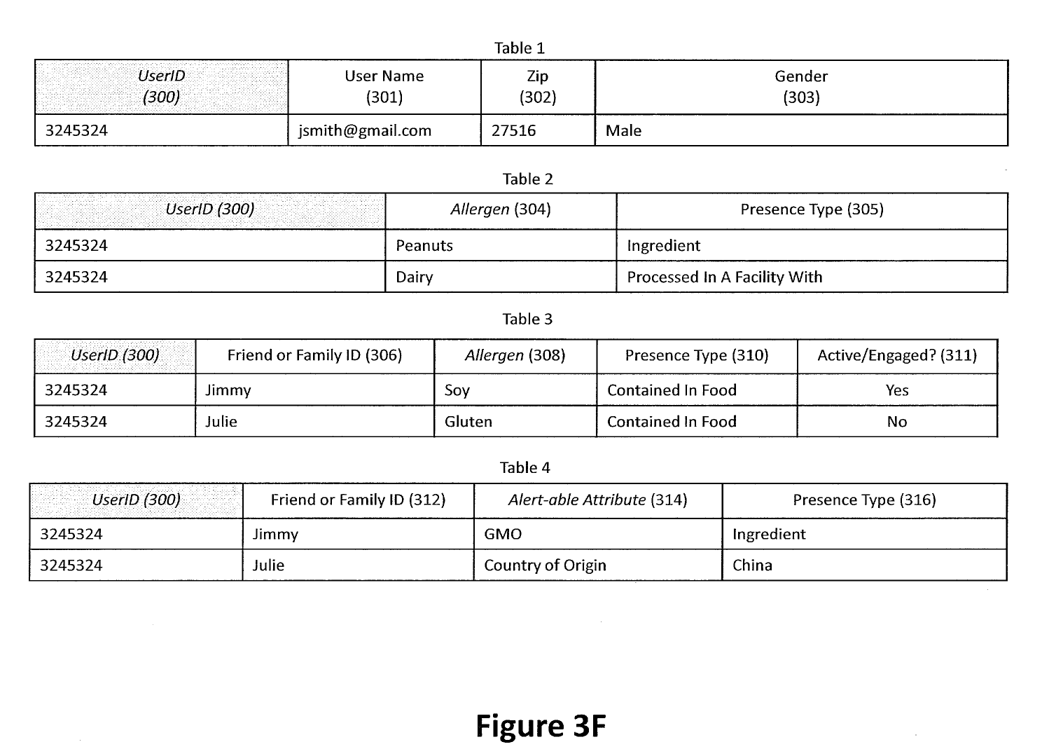

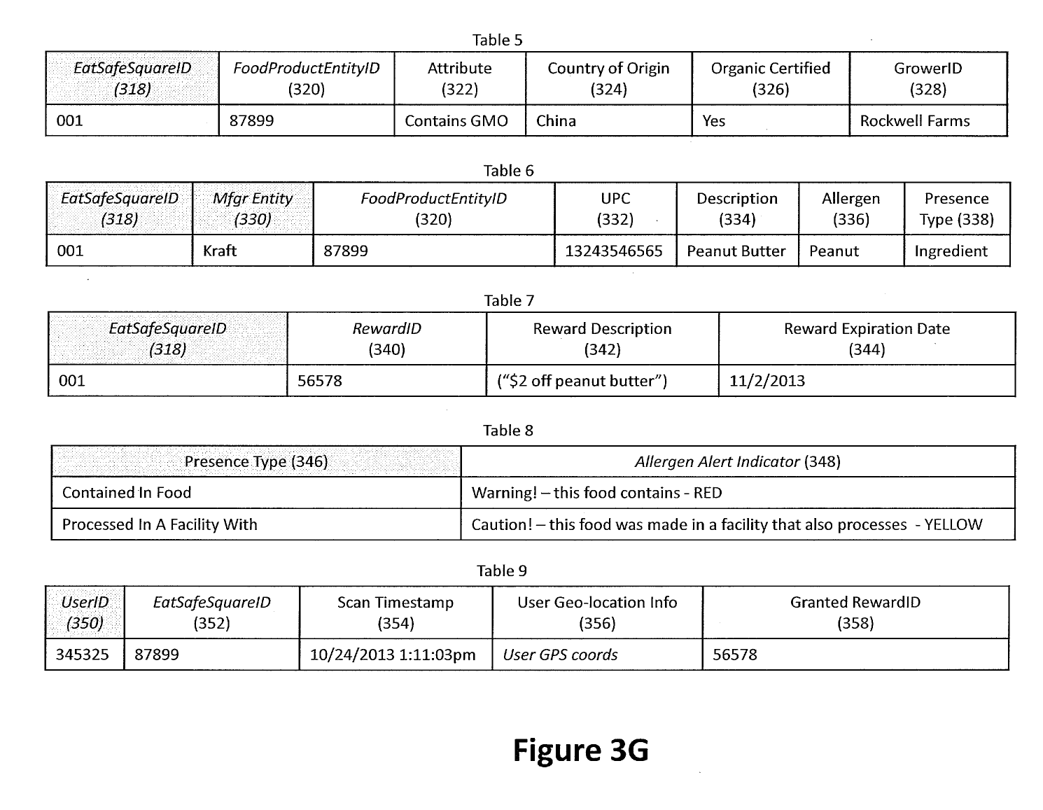

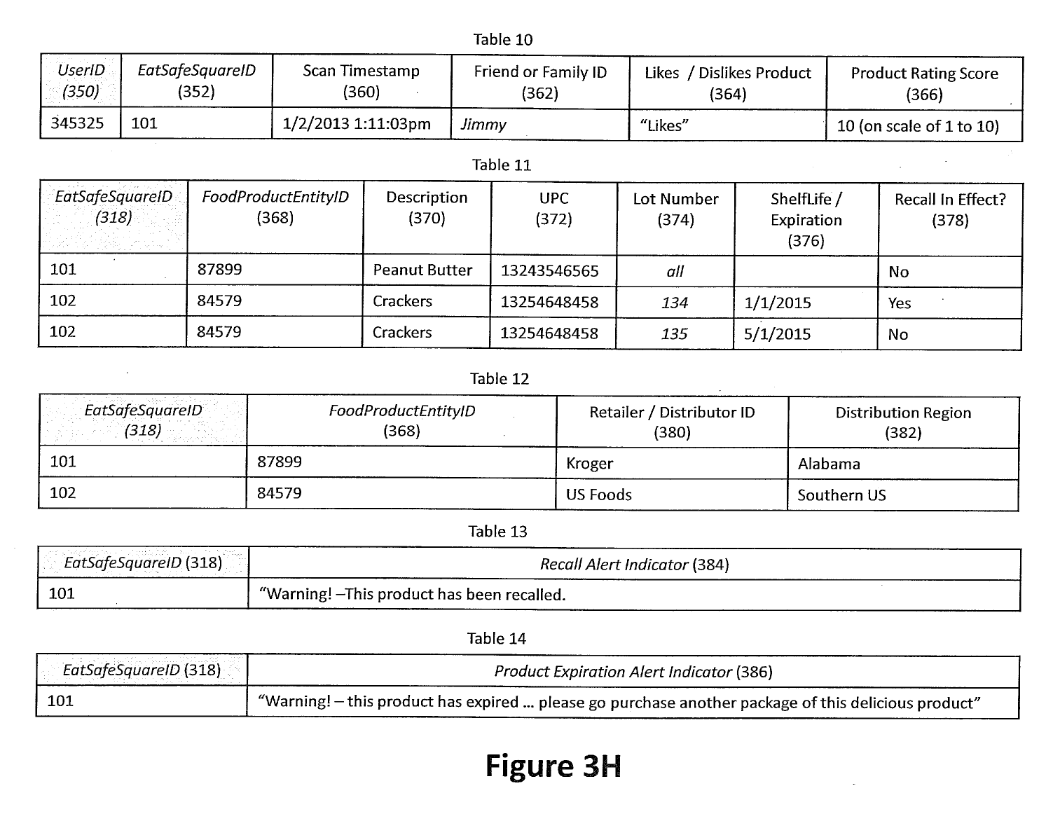

Shown in FIG. 3A is diagram that generally illustrates the provisioning of information associated with one embodiment of a service of a scan code-based service system. This service is referred to herein as EatSafe square service, which is a service that enables a user to quickly determine whether a product (e.g., food product, drink product, etc.) contains or is otherwise associated with an allergen or set of allergens that the user has previously provisioned, where the determination is triggered via the scanning of an EatSafe square service scan code by the user. One exemplary use of EatSafe square service might involve a food manufacturer, who has placed an EatSafe square on the packaging of one of the manufacturer's food products. In this example, the food manufacturer creates an EatSafe square account and provisions/specifies a list of all ingredients or potential allergens that associated with the food product. The food manufacturer may also specify other information associated with the food or drink item such as, whether the item includes genetically modified organisms (GMOs), the country of origin of the ingredients, the grower or producer of some or all of the ingredients, whether the food item is certified organic, product expiration information, and product recall information, etc. The EatSafe service generates or facilitates the generation of an EatSafe square scan code, such as a QR code, that is placed on the packaging or otherwise associated with the food product item. Separately, a user creates an EatSafe square account with a scan-triggered EatSafe service provider and provisions some or all of the user's (and/or the user's family & friends) known food allergens (e.g., peanuts, dairy, etc.). Subsequently, when the user scan's the EatSafe square QR code associated with the food product item, information that identifies or can be used to identify the food product item (e.g., an EatSafe square identifier) and the user is communicated to the EatSafe square service provider. In one example, the EatSafe square service provider compares the user's allergen list against the food product's ingredient/allergen list and identifies any matches. If any of the user's allergens are identified as being in or associated with the production of the food product item, the EatSafe square service communicates a notification of the allergen issue to the user. If a recall is in effect for the associated product, then product recall notification information may be communicated to the user. If the product is near or has passed an expiration date, then product expiration notification information may be communicated to the user. In various embodiments, the food manufacturer may also provision participation rewards, such as digital loyalty rewards, which may be distributed to those users who scan EatSafe square scan codes and thereby participate in the EatSafe square service.

In this example, to provision an EatSafe square code, a food manufacturer entity uses computer terminal 600 to log into a provisioning interface associated with a scan-triggered application server 200 that adapted to host an EatSafe square service application, as indicated in step 1. In step 2, food product item information is provisioned and stored at/by server 200. Exemplary provisioned food product item information Is shown in Tables 5-8, and includes an EatSafeSquareID identifier 318, a food product entity identifier 320, a food product attribute identifier 322 (e.g., contains GMO, organic, etc.), a country of origin identifier 324, an food or beverage standards body certification compliance indicator 326, a food grower/farm/distributor identifier 328, a food product manufacturer identifier 330, food/beverage product name 334, ingredients, allergen information 336, allergen presence type 338 (e.g., food contains the allergen, food manufactured in a facility with the allergen, etc.) processing facility information, processing facility allergen information, ingredient country of origin, ingredient farm or producer of origin, ingredient packaging facility information, ingredient organic certification information, ingredient genetically modified organism content information, universal product code (UPC)/GTIN information 332, product description text, uniform resource identifier or locator information associated with the food manufacturer's website or product, related product identifiers/descriptions, product price information, product recall information, product expiration information, and associated participation reward (e.g., Reward that is granted in response to scanning the EatSafe square code) information is provisioned. Exemplary data tables and data structures associated with various embodiments of EatSafe square service are presented in FIGS. 3D-3H. Once provisioning is completed for the food product item, an EatSafe square QR code 702 is generated by or for the food product entity with the aid of EatSafe Square application server 200, where the EatSafe square QR code includes information that can be used to identify the food product item. The EatSafeSquareID value 318 is bound to the associated food product entity information, and the binding is stored by module 208 (step 3). In this example, an EatSafeSquareID value is generated by EatSafe square Control Logic Module 208 and incorporated into the EatSafe square QR code (step 4). In one embodiment, an EatSafeSquareID may be randomly or algorithmically generated and assigned to an associated food product entity/item by module 208 during the provisioning process. In other embodiments, an EatSafeSquareID may include or incorporate a UPC or other Global Trade Item Number (GTIN) associated with the food/beverage product entity.

In one embodiment, a participation reward may be associated with an EatSafe Square scan code and granted to a scanning user. Exemplary provisioned reward information is shown in Table 7 and includes an EatSafeSquareID identifier 318, a reward identifier 340, a reward description/value information 342, and reward expiration information 344. Provisioned food allergen alert or notification information is shown in Table 8 and includes allergen presence type information 346, and allergen alert indicator message content information 348.

In one embodiment, information that identifies or can be used to identify application server 200 is also encoded in the EatSafe square QR code. The exemplary EatSafe square QR code also includes information that identifies or can be used to identify and establish communications with a network server or host computer that provides EatSafe square service. Exemplary information that identifies or can be used to identify a network server or host computer for providing EatSafe square service may include, but is not limited to, a uniform resource locator (URL) and URL parameters, an Internet protocol (IP) address and port identifier. As such, EatSafe square service may be obtained by a user via any standard QR code scanning application that resides on the user's mobile communication device (e.g., smartphone, computer-integrated eyewear, etc.). It will be appreciated with regard to the EatSafe square service embodiments described above that such services may also be provided via a native EatSafe square application that is installed on the user's smartphone. In such cases, information that identifies or can be used to identify the address of an EatSafe square server to which the EatSafeSquareID and associated scan information should be communicated need not be encoded within the EatSafe square QR code that is displayed to and scanned by a user. In such native application deployments, the information that identifies or can be used to identify the address of an EatSafe square server may be pre-configured and stored in the smartphone's memory, such as in data storage module 116. Alternatively, the native application may dynamically determine the address of the appropriate EatSafe square server at the time of the EatSafe square QR code scan by a user. In such scenarios, EatSafe square processing is very similar to that described above, except that the address of the EatSafe square server is not obtained by a user scan of an EatSafe square QR code.

Copies of the EatSafe square QR code 702 may be deployed in any number of ways and formats including, but not limited to, on packaging of food or drink products, on displays or shelves where a food or drink product is sold, on a receipt associated with the purchase of a food or drink item, on a food or drink vending machine, etc. (step 5).

Shown in FIG. 3B, a user, using mobile device 100, logs into the user's EatSafe square account which, in this example, is hosted by scan-triggered application server 200 (step 1). In step 2, the user provisions a list of food ingredient allergens about which the user is concerned, or which are problematic for the user or the user's family and/or friends. Exemplary user food allergen profile information is presented in Tables 1-4, and includes a user identifier 300, username 301, user address/location information 302, user gender 303, user allergen information 304, allergen presence type 305, family member/friend identifier information 306, family member/friend allergen information 308, family member/friend allergen presence type 310, family member/friend identifier 312, alert-able attribute identifier information 314, and allergen presence type information 316. In one embodiment, a user's food allergen profile may also include other food attribute information with which the user is interested/concerned/or would otherwise like to be alerted about, such as GMO content information, country of origin information, grower/producer information, etc. Exemplary user profile information is shown in Table 4, which includes a user identifier 300, family member/friend identifier information 312, food product entity attribute 314, and attribute presence type 316. Exemplary provisioned food attribute data is shown in Table 5 in FIG. 3G, which includes food product entity identifier information 320, food attribute type 322, country of origin 324, organic certification status 326, grower identifying information, 328, distributor identifying information. In one embodiment, a user may provision allergen data for other individuals of interest/concern, such as family members or friends. Such friend and family allergen data is shown in Table 3. The provisioned user allergen profile information is associated with/bound to the user's account and stored by server 200 (step 3).

FIG. 3C illustrates an exemplary information/process flow associated with one embodiment of EatSafe square scan-triggered service. In step 1, a user scans EatSafe square code 702. Scanning of the EatSafe square code causes the scan-enabled client module 104 to communicate user identifying/user login credentials and extracted EatSafeSquareID information to EatSafe square application server 200, as indicated in step 2. When the EatSafe square QR code is scanned by the user's QR code scanner, the encoded EatSafeSquareID information and, in this example, EatSafe square scan-triggered host server identifier or address information is extracted by the QR code scanner and the information that identifies or can be used to identify a EatSafe square scan-triggered host application server is used to facilitate communication of the extracted EatSafeSquareID information to the identified EatSafe square application server. It will be appreciated that in various embodiments of the subject matter described herein, the EatSafeSquareID information may be encrypted or obfuscated during communication from the user's mobile communication device to the EatSafe square application server. In other embodiments, the information that identifies or can be used to identify an EatSafe square application server may itself be encrypted or obfuscated when read by the QR code scanner, and may be subsequently decrypted/de-obfuscated by scan control logic module 112 so as to obtain the information necessary to identify the EatSafe square application server to be contacted. Also communicated to the EatSafe square application server is information that identifies or can be used to identify the user (e.g., the person that scans the EatSafe square QR code). This user identifying information may be provided to the EatSafe square application server 200 before, after, or at the same time that the previously discussed scanned information is provided. For example, in one embodiment, the user may log in (i.e., provide login credentials that are sufficient to identify and authenticate the user) prior to scanning the EatSafe square QR code, and application server 200 is adapted to associate the subsequently received EatSafeSquareID information with the user.

Alternatively, the user's login credentials may be provided at the time of/as a result of the EatSafe square QR code scan, along with the EatSafeSquareID information.

In step 3, EatSafe square application server 200 receives the scan code and user identifying information, and uses this information to access the previously provisioned user allergen profile information and the associated food product entity allergen content information that is stored in the previously provisioned binding records. Server 200 logs or records the received scan data in a scan transaction record. In this example, the accessed information is used to determine if a food allergen conflict/problem exists for the user based on the user's provisioned food allergen profile information, where the user's provisioned food allergen profile information may include food allergen information for the user, as well as the user's family members and/or friends. If a food allergen conflict/match is detected, based on the user allergen profile information and the associated food product entity allergen content information, then food allergen alert information (such as, for example, that shown in Table 8) is communicated to the user of mobile device 100, as indicated in step 4. In one embodiment, server 200 may also communicate a description of the associated food product item, which is displayed to the scanning user (not shown in FIG. 3C). Such “echo” information may be useful for insuring that a user scanned the correct or intended EatSafe square scan code, and/or that a particular EatSafe square scan code was not inadvertently associated with the wrong food product item.

In one embodiment, the alert or notification information may include information that describes the potential food allergy or food attribute issue, such as allergen alert indicator 348. In another embodiment, the alert or notification information may include a simple indicator, such as a color coded indicator that conveys information as to the allergy or food attribute issue. For example, a green display indicator signifies “no potential allergy problems,” a yellow display indicator signifies that the associated food/beverage product was manufactured in a facility that processes one or more of the allergens identified in the user's allergen profile. It will be appreciated that in cases where a user has provisioned multiple allergen profiled, for instance for family members, that indicators may also be provided/displayed for each provisioned allergen profile. In one embodiment, a user may, through a user accessible settings tab or screen, temporarily de-activate or disengage (see control setting element 311) a family member or friends allergen profile, such that the disengaged allergen profile is not considered by module 208 when determining whether to generate a food allergen alert. In one embodiment, the alert or notification information may include a summary of the user's current food allergy and/or food attribute settings. If appropriately provisioned, the alert or notification information may include information that identifies the potentially effected friends or family members.

In step 5 of this exemplary embodiment, user of mobile device 100 is adapted to communicate product feedback or product rating information to module 208. For example, module 208 may communicate a question and associated response options (e.g., “How did you like our product?”, “Liked it”, “It was Ok”, “Loved it”) to user of mobile device 100 (not shown in FIG. 3C). In one embodiment, the response options are displayed on the user's smartphone screen as tap-selectable buttons. The user taps the button associated with the user's desired feedback response option, and information which can be used to identify the selected feedback response option is communicated to server 200, where it is logged and stored, as illustrated in step 5. Product rating score information may be collected in a similar manner, where module 208 provides the user with rating scale information which is displayed on the user's mobile device. The user specifies a rating score and the rating score information is communicated to server 200, where it is logged and stored and may be later analyzed and reported. Such feedback/rating data collection functionality may be deployed with all embodiments of EatSafe square service, although for the purpose of illustration is only explicitly shown in the embodiment presented in FIG. 3C. Exemplary EatSafe square scan transaction data that is stored by module 208 in response to receipt of a user scan is shown in Tables 9 and 10-, and includes scanning user identifying information 350, the associated EatSafeSquareID value 352, scan timestamp information 354 and 360, user geolocation information 356, granted reward identifier information 358, the associated user identifier/profile information 362, user feedback information 364, and user rating score information 366.

In step 6, EatSafe control logic module 208 determines that the user should be granted a participation reward in exchange for scanning the EatSafe square code. If a reward is to be granted, Reward Control Logic Module 210 may facilitate the crediting of the granted reward to the user's account. Exemplary participation reward data is illustrated in Table 7.

It will be appreciated with regard to the EatSafe square service embodiments described above that such services may also be provided via a native EatSafe square application that is installed on the user's smartphone. In such cases, information that identifies or can be used to identify the address of an EatSafe square server to which the appointment information should be communicated need not be encoded within the

EatSafe square QR code that is displayed to and scanned by a user. In such native application deployments, the information that identifies or can be used to identify the address of an EatSafe square server may be pre-configured and stored in the smartphone's memory, such as in data storage module 116. Alternatively, the native application may dynamically determine the address of the appropriate EatSafe square server at the time of the EatSafe square QR code scan by a user. In such scenarios, EatSafe square processing is very similar to that described above, except that the address of the EatSafe square server is not obtained by a user scan of an EatSafe square QR code.

EatSafe square services may be provisioned and/or utilized by EatSafe square scan-triggered service client entities. Exemplary EatSafe client entities may include, but are not limited to, food and beverage manufacturers, an expire-able good manufacturer, a pharmaceutical manufacturer, a retail business entity, a grocer entity, a product distribution retailer/outlet (e.g., Walmart, etc.), etc. The subject matter described herein, as described with respect to the following exemplary embodiments, is relevant to and intended to include implementations that involve any type of product that has a finite shelf-life/expiration date (i.e., a potential expiration issue for consumers), or has the potential to be recalled.

Exemplary EatSafe provisioned data associated with the following exemplary recall and expiration notification embodiments is presented in Table 11, and includes a food product entity identifier 368, a food product description 370, a GTIN or UPC code 372, a manufacturing lot or batch number/identifier 374, product shelf-life/expiration information 376, and product recall status information indicator 378. Shown in Table 12 is exemplary information which may be associated with an EatSafeSquareID so as to permit the association of an EatSafe Square scan code with a particular retail distributor or grocer 380, and/or geographic location identification information, such as a geographic region 382. Shown in Tables 13 and 14 are exemplary notification message content including product recall alert indicator content 384 and product expiration alert indicator content 386. It will be appreciated that such indicator content may include web URL hyperlinks or other network address links that are intended to direct a user to additional network hosted information.

In one exemplary embodiment, reporting module 206 is adapted to provide access to EatSafe service and service request data that has been collected, user access statistics and metrics, sponsored content access statistics and metrics, as well as access to reward distribution and redemption information. In one embodiment, reporting module 206 analyzes collected EatSafe service data and generates summary reports associated with the data. Module 206 may generate and report statistics that are based on collected EatSafe service data. Reports generated by module 206 may be viewed, for example, by an EatSafe client entity via a web browser or other software interface. Module 206 may also provide EatSafe service user scan data, participation reward and redemption data and associated statistics in a downloadable format, such as a spreadsheet or portable document format. In one embodiment, report module 206 may enable a user to access and view user account information, including user settings, user preferences, rewards earned, reward redemption information, reward transfers to other users, etc.

In one exemplary embodiment, EatSafe scan code module 208 is adapted to receive and process scanned EatSafe service scan code (e.g., QR code) information from one or more scan-enabled client modules, and facilitate the providing of EatSafe service and features to the scanning user(s). Module 208 includes the logic and control structures necessary to interpret information received from a user via the scanning of an EatSafe scan code, and to provide the associated EatSafe services and features to the user. Module 208 facilitates the execution of application control processing logic associated with EatSafe service, which provides various EatSafe features and functionality to users. In one exemplary embodiment, module 208 is further adapted to facilitate the storage of EatSafe scan information within an associated data storage module. In an alternate embodiment, module 208 is adapted to decode or “read” an image provided by a scan-enabled client module. The image may be, for example, a JPEG formatted graphic image of a QR code icon. The decoded information extracted from the QR code icon is then processed and optionally stored in a manner similar to that described above.

In one exemplary embodiment, reward control logic module 210 is adapted to operate in conjunction with module 208 so as to receive or be informed of scanned EatSafe service code (e.g., QR code) information provided by a user/scan-enabled client module. In one embodiment, module 210 is adapted to distribute a reward, such as a digital coupon or voucher that may be exchanged for a good or service, to a user based on EatSafe scan code (e.g., QR code) information received from the user.

Reward control module 210 is adapted to receive and process a request by a user/scan-enabled client module to redeem a previously granted reward. The user/scan-enabled client module requesting to redeem a reward provides information which identifies the reward to be redeemed and the redemption entity. A redemption entity is defined herein as any entity (e.g., retail merchant, corporation, etc.) that exchanges a reward for a good or service. Module 210 is adapted validate the redemption request. Validation of a redemption request may include, but is not limited to, confirming that the requesting user has been previously given the reward associated with the redemption request, confirming that the reward associated with the redemption request has not expired, confirming that the redemption entity information provided is valid, confirming that the user has an account that is in good standing.

In one embodiment, module 210 is adapted to facilitate the sharing, gifting, or transfer of a reward from one user to another user. In this case, a first user, who is the current owner of a reward, selects the reward and identifies a second user to whom the reward is to be transferred. The first user then communicates information that identifies both the reward and the “transferred to” user to module 210. Module 210 receives, processes and logs the transfer request and updates the appropriate reward data so as to execute the transfer. In one embodiment, reporting module 206 enables an EatSafe Client entity or user to view, track and analyze such reward transfers.

Returning to FIG. 2, data storage module 212 is adapted to include or have access to the data structures, databases, and data tables associated with the storage of EatSafe service data described and suggested herein, some of which is illustrated in Tables 1 through 14. In any event, data storage module 212 may utilize a variety of physical storage mediums to provide the described functionality including, but not limited to, magnetic storage media and optical storage media. In one embodiment, at least a portion of reporting and data storage functionality may be provided by external servers and/or data storage backend platforms. For example, reporting module 206 may communicate and interoperate with an external, cloud-based reporting and database system, such as that provided by SalesForce.com. Likewise, in other embodiments of the subject matter described herein, the various functions described with herein with respect to server application module 202 may be distributed over one or more cloud-based application and/or database server platforms.

According to one aspect, communication module 214 is adapted to facilitate communication with one or more scan-enabled client modules, as previously described herein. As such, communication module 214 is adapted to interoperate with and generally facilitate communications with scan-enabled client module 104 via communication module 118. A variety of communication protocol stacks and languages may be implemented by communication module 214 within the scope of the subject matter described herein, including but not limited to, transmission control protocol/Internet protocol (TCP/IP), user datagram protocol/Internet protocol (UDP/IP), Hypertext Transfer Protocol (HTTP), Extensible Markup Language (XML), Hypertext Markup Language (HTML), Simple Object Access Protocol (SOAP), Session Initiation Protocol (SIP), etc.

According to another aspect, communication module 214 is adapted to facilitate communication with a mobile user via a communication interface other than a native, smartphone-based application driven user interface (UI) that is supported by scan-enabled client module 118. For example, communication module 214 is adapted to facilitate communications with a web browser (e.g., Chrome, Internet Explorer, Firefox, etc.). Such web browser interface support may be used, for example, by an EatSafe square service provisioning administrator or mobile user to provision scan-triggered service (e.g., EatSafe square service) application information.

Illustrated in FIG. 3D is an information and processing flow diagram associated with an exemplary embodiments of the subject matter described herein that involves the distribution of food/beverage product recall and expiration information to users via the scanning of a scan-triggered service code. In step 1, a mobile user, using a mobile communication device 100, scans an EatSafe scan code 702. In step 2, the EatSafe service information encoded in EatSafe scan code 702 is read and transmitted, along with optional information that can be used to identify the user to EatSafe application server 200. It will be appreciated that embodiments of the subject matter described herein that distribute/disseminate product recall and expiration notifications may be operated without requiring user identification from the scanning user. For the purposes of illustration, the following example assumes that user identifying information is provided to server 200. In one exemplary embodiment, network/server address information that can be used to direct the message to EatSafe server 200 is read/decoded from EatSafe scan code 702 and used by mobile device 100 to direct the message to or towards EatSafe server 200. Exemplary EatSafe server address information may include a uniform resource locator (URL), an Internet protocol address, etc. In an alternate embodiment, for example an embodiment which includes a native mobile phone EatSafe client/native application that is adapted to execute on mobile device 100, EatSafe server address information may be stored/maintained on the mobile device or may be obtained from a network server at the time of the scan, and consequently is not read or decoded during the scanning of a EatSafe square scan code. In any event, information that can be used to identify the EatSafe service request is extracted/decoded from the scanned EatSafe square scan code 702 by mobile communication device 100 and provided to EatSafe server 200. In this example, an EatSafeSquareID value is extracted/decoded by mobile device 100 during the scanning of scan code 702 and this EatSafe service parameter information is communicated to EatSafe server 200. In one embodiment, information that can be used to identify the user of mobile device 100, which has been previously stored on mobile communication device (e.g., data storage module 116) is accessed at the time of the scan and transparently provided to EatSafe server 200. For example, such user identifying information may include scan-triggered service user login credential information (e.g., username, password, email address, mobile telephone number, mobile IP address, etc.), which is stored in a cookie on in data storage module 116 of mobile device 100. Alternatively, at the time of the EatSafe square code scan, the user may be prompted to enter user identifying information that is provided to EatSafe scan-triggered server 200. In one embodiment, the user of mobile device 100 is also prompted to enter/provide preferred notification contact mode and address information (e.g., preferred contact mode: email, jsmith@gmail.com, preferred contact mode: short message service (SMS), (919)555-1212, preferred contact mode: Twitter, Twitter handle, etc.). In one embodiment, the scanning user's current geo-location/positional information may be communicated to and stored by EatSafe server 200 at the time of the EatSafe square code scan. For example, such geo-location information may include GPS information that is obtained or provided by geo-location module 120 onboard mobile device 100. In step 3, server 200 receives the EatSafeSquareID and userID information and module 208 determines, based at least in part on the received EatSafeSquareID information, whether there is a product recall issue. If there is, module 208 is adapted to communicate a recall alert notification message to the user, step 4. This message may be displayed onscreen, immediately following the scan or the message may be communicated to the user via an external communication mode, such as email, SMS, instant message, Tweet, etc., if an external contact address has been/is provided by the scanning user of mobile device 100. Module 208 may also generate and store a scan transaction record associated with the scan, such as the exemplary scan related information shown in Table 10 illustrated in FIG. 3H. In step 5, a digital coupon or reward is distributed to the user in response to the user scan, in a manner similar to that previously described.

It will be appreciated that, in some embodiments of the subject matter described herein, an EatSafe SquareID service code value may include or incorporate a GTIN/UPC identifier associated with a product. In general, use of a GTIN such as a UPC value by itself would not be sufficient to determine recall and expiration status information for an individual food product item, as the same UPC is applied to every package of a particular food product. Consequently, EatSafe services can be most effectively provided to users when the EatSafeSquareID service code values chosen are sufficient to enable module 208 to identify not only the general product (e.g., “Peter Pan Peanut Butter 12 oz.”), but also to identify a particular manufacturing lot or batch.

In any event, EatSafe user scan data received by module 208 may be stored in data storage module 212, where it may later be analyzed to reveal user scan trends by retailer, by distributor, by geographic region or sales region, by time/date based.

As illustrated in FIGS. 3C and 3E, in exemplary embodiments, EatSafe square service may be configured to grant or credit digital coupons or rewards to a user who scans an EatSafe square scan code. In one embodiment, a reward may be credited to a digital reward wallet associated with the scan-triggered services platform that is providing EatSafe service. In such a case, a user may simply log into the user's scan-triggered services platform account to view/access the user's digital reward wallet and select/redeem a reward that has been granted or credited to the user's account. In an alternate embodiment, in response to the scanning of an EatSafe square, reward control module 210 may communicate a reward to the scanning user via an external communication mode, such as email, text message service, instant message service, Twitter, etc.

FIG. 3E illustrates the communication of product notification information, such as product recall or product expiration information, to a user who scans an EatSafe square scan code associated with a food product (step 1). In a manner similar to that described above, information that can be used to identify the EatSafe service request is extracted/decoded from the scanned EatSafe square scan code 702 by mobile communication device 100 and provided to EatSafe server 200 (step 2). In the example shown in FIG. 3E, an EatSafeSquareID value is extracted/decoded by mobile device 100 during the scanning of scan code 702 and this EatSafe service parameter information is communicated to EatSafe server 200. In one embodiment, information that can be used to identify the user of mobile device 100, which has been previously stored on mobile communication device (e.g., data storage module 116) is accessed at the time of the scan and transparently provided to EatSafe server 200. For example, such user identifying information may include scan-triggered service user login credential information (e.g., username, password, email address, mobile telephone number, mobile IP address, etc.), which is stored in a cookie on in data storage module 116 of mobile device 100. Alternatively, at the time of the EatSafe square code scan, the user may be prompted to enter user identifying information that is provided to EatSafe server 200. In one embodiment, the user of mobile device 100 is also prompted to enter/provide preferred notification contact mode and address information (e.g., preferred contact mode: email, jsmith@gmail.com, preferred contact mode: SMS, (919)555-1212, preferred contact mode: Twitter, Twitter handle, etc.). In one embodiment, the scanning user's current geo-location/positional information may be communicated to and stored by EatSafe server 200 at the time of the EatSafe square code scan. For example, such geo-location information may include GPS information that is obtained or provided by geo-location module 120 onboard mobile device 100. In step 3, server 200 receives the EatSafeSquareID and userID information and module 208 determines, based at least in part on the received EatSafeSquareID information, whether the food product associated with the scanned EatSafe square scan code has expired or is nearing expiration. If there is an expiration issue, module 208 is adapted to communicate an expiration alert notification message to the user. This message may be displayed onscreen, immediately following the scan (shown in step 4) or the message may be communicated to the user via an external communication mode, such as email, SMS, instant message, Tweet, etc. Module 208 may also generate and store a scan transaction record associated with the scan, such as the exemplary scan related information shown in Table 10. In step 5, the distribution or crediting of a digital coupon or reward to mobile device 100 is triggered by the scanning of the EatSafe square scan code. Exemplary reward data is presented in Table 19.

EatSafe user scan data received by module 208 may be stored in data storage module 212, where it may later be analyzed to reveal user scan trends by retailer, by distributor, by geographic region or sales region, by time/date based.

The embodiments of EatSafe service illustrated above all include the communication of user identifying information to server 200 at or around the time of the EatSafe square code scan. It will be appreciated that such user identifying information is not strictly required in all cases/contemplated embodiments of the present EatSafe system. “Anonymous” use cases of the subject matter described herein are possible. In such cases no user identifying information is communicated to the EatSafe server 200. The only information that is required to be communicated to EatSafe server 200 in such cases in an EatSafe SquareID identifier. Using the EatSafe SquareID identifier, module 208 can determine and provide expiration and recall status alert information to the scanning user via an immediate on-screen display of notification information. In such scenarios, scan transaction records that include user identifying information cannot be constructed/maintained/analyzed. Also, the rewards described above cannot be credited to a user's reward wallet in such scenarios.

### Reward Sharing

In one embodiment, module 210 may facilitate the sharing, gifting, or transfer of an EatSafe-granted reward from one user to another user. In this case, a first user, who is the current owner of a reward, selects the reward and identifies a second user to whom the reward is to be transferred. The first user then communicates information that identifies both the reward and the “transferred to” user to module 210. The information that identifies the “transferred to” or recipient user may be a username or user ID provided by the recipient user at the time of registration by the recipient user. Module 210 receives, processes and logs the transfer request and updates the appropriate reward data so as to execute the transfer. In one embodiment, reporting module 206 enables an EatSafe client entity or user to view, track and analyze such reward transfers. In various embodiments of the subject matter described herein, restrictions/limitations/qualifications may be imposed on rewards that are to be transferred or gifted from one user to another. For instance, module 210 may include reward transfer or gifting rules that specify those conditions under which a reward may be transferred and/or those conditions under which a reward may not be transferred. These rules may be stored in a database, table, or data structure that is contained within or accessible by module 210. An exemplary rule may state that a reward may only be transferred or gifted to a new user (e.g., a user that has registered for service within the past 30 days, etc.). In order to enforce this rule module 210 may access user registration data that is maintained in data storage module 212. Another exemplary rule may state that a reward may only be transferred or gifted to a user who has not previously patronized the EatSafe client entity with which the reward is associated. In order to enforce this rule module 210 may access user transaction data that is maintained in data storage module 212.

In one embodiment, an existing user may transfer or gift a reward to an individual who has not yet become a registered EatSafe service user. To facilitate such a special transfer, the existing user communicates information that identifies both the reward and the “transferred to” or recipient user to module 210. In this case, since the recipient user is not yet a registered user of the system/service, the existing user must specify a public contact address for the intended recipient. Exemplary public contact addresses may include, but are not limited to, an email address, a mobile telephone number, a mobile subscriber ISDN (MSISDN), a Twitter address, an instant message address. Module 210 receives processes and logs the transfer request. In one embodiment, module 210 is adapted to generate a message that is addressed to the specified public contact address (e.g., email address). In one embodiment, the message may include the transferred reward or information specifying how the transferred reward may be obtained and redeemed. In another embodiment, the message may include information that describes the pending reward transfer and also provides a hyperlink/URL associated with a web page where the intended recipient may register and thereby receive and redeem the transferred reward. The existing user that transferred or gifted the reward (thereby resulting in the recruitment/registration of a new subscriber) may be issued a new reward as a result of the transfer. The new reward may be the same as the transferred reward or different. The new reward may be issued by reward control logic module 210.

It will be appreciated that embodiments of the EatSafe square service enable a user to obtain food allergy and/or food attribute information in a manner that keeps the user's identity and interest hidden from the vendor who generates and displays the EatSafe square scan code. Users may, at their discretion, choose to allow a food manufacturer entity associated with an EatSafe square code that the users have scanned to obtain access to information that identifies the users

### Recipe Square

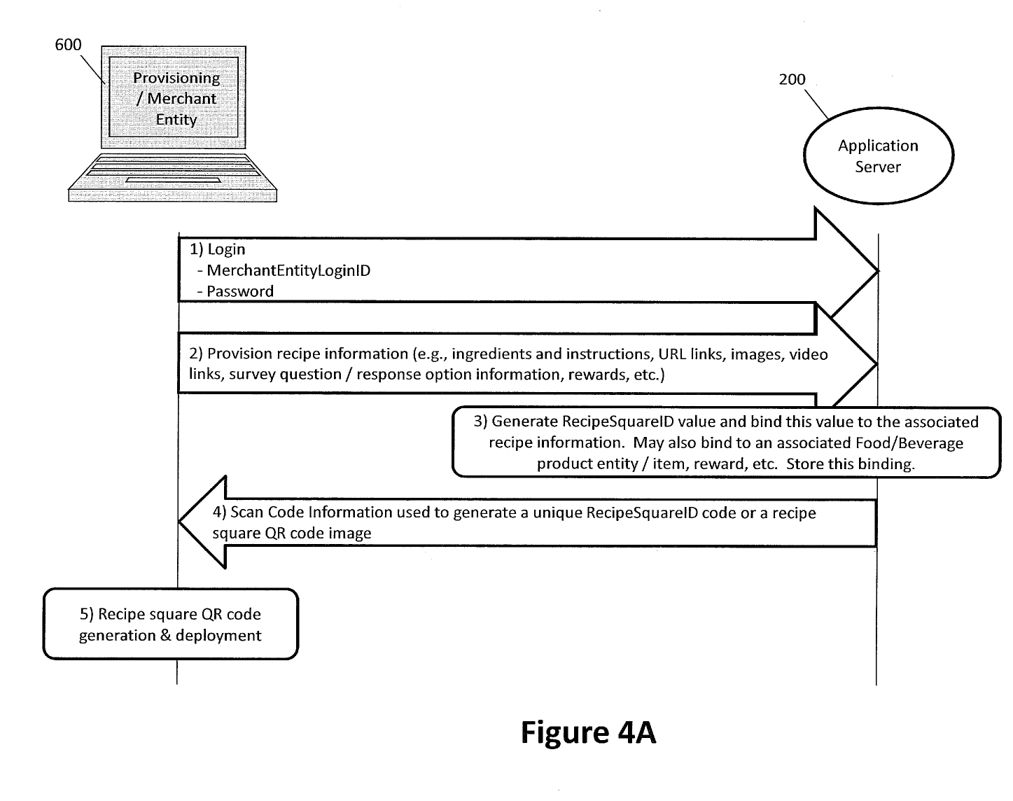

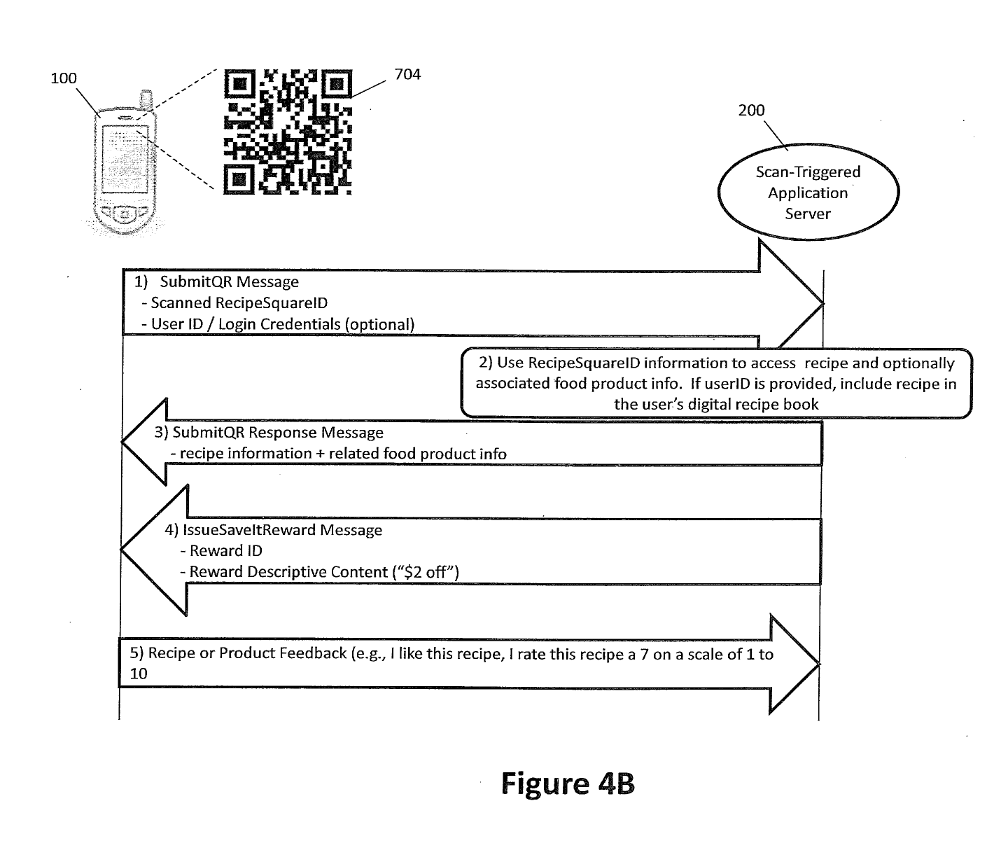

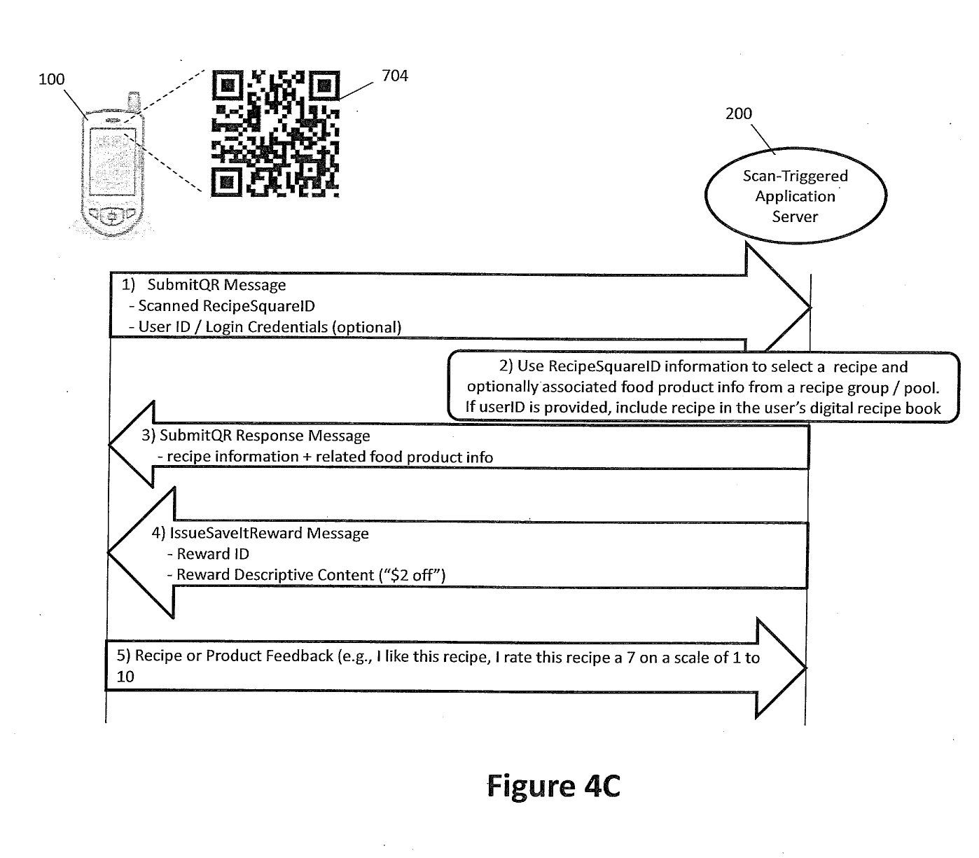

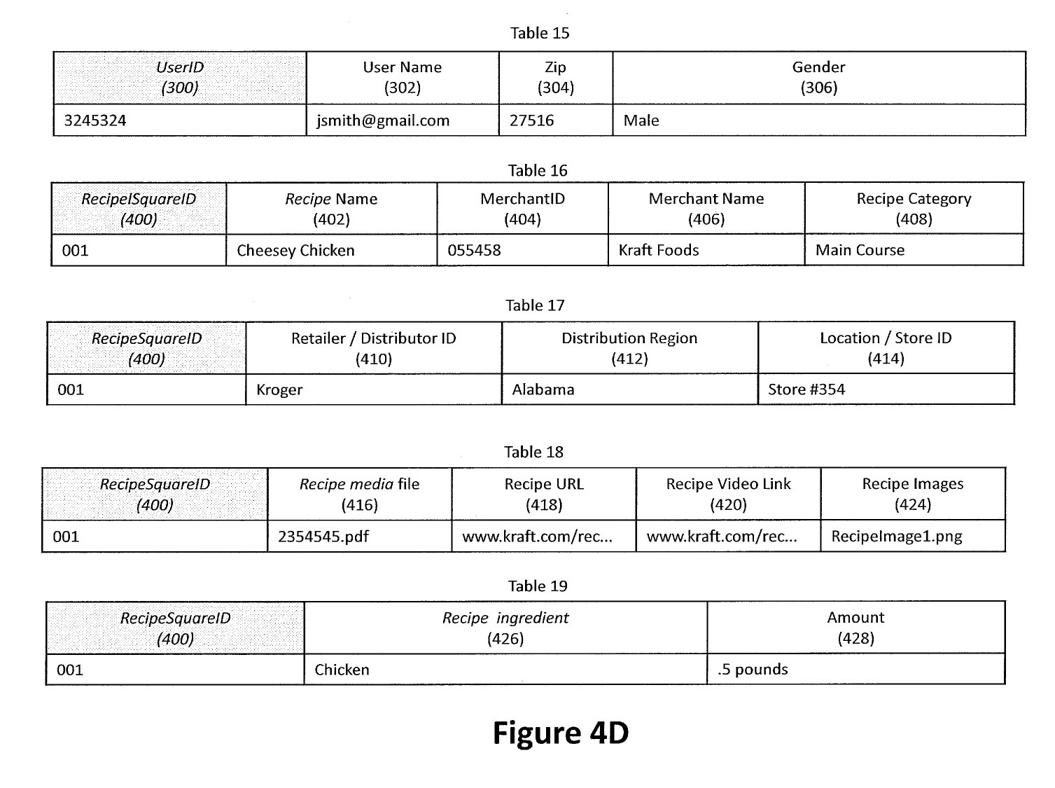

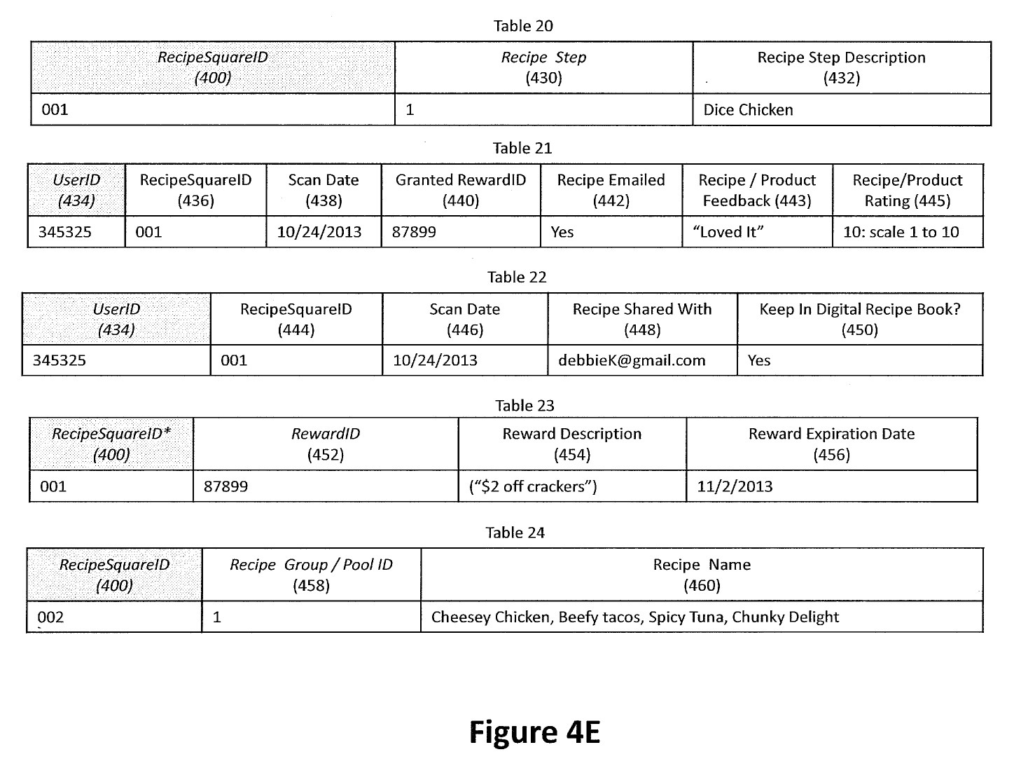

Shown in FIG. 4A is diagram that generally illustrates the provisioning of information associated with one embodiment of a service of a scan code-based service system of the subject matter described herein.

This service is referred to herein as recipe square service, which is a service that facilitates the addition of a recipe and recipe information to a recipe vault associated with a user that is triggered via the scanning of a recipe square service scan code by the user. One exemplary use of recipe square service might involve a food manufacturer who would like to distribute a recipe associated with the manufacturer's food or drink product to a consumer. A user who would like to obtain a copy of the recipe scans a recipe square QR code associated with the particular food manufacturer or food product item using the QR code scanner on the user's mobile phone. Scanning of the recipe square causes recipe information (e.g., recipe name, recipe ingredients, recipe preparation instructions, web site URL, related food product information) to be saved in the user's recipe square data vault that is maintained for the user by a recipe square service provider. The user can then log into the user's recipe square vault at any time and browse all of the user's saved recipe information. The recipe square service may also provide the user with a participation reward for scanning the recipe square scan code (e.g., QR code) associated with a particular food manufacturer or food product item. The participation reward may be a digital reward or coupon for one or more of the ingredients related to the recipe obtain from scanning of the Recipe Square QR code. The recipe square service may facilitate and track redemption of the participation reward by the user.

User information, such as user scan-triggered service account information may be provisioned for or by a user. Exemplary user information is shown in Table 15 illustrated in FIG. 4D and include user identifier information 300, username information 302, user address/zip code information 304, and user gender information 306.

In this example, to provision a recipe square code, a provisioning entity, such as a food manufacturer or merchant entity uses computer terminal 600 to log into a provisioning interface associated with an application server 200 that is hosting the scan-triggered recipe square application, as indicated in step 1. In step 2, the merchant entity provisions recipe information (e.g., recipe name, ingredients, preparation instructions, etc.), food product item with which the recipe is to be associated (e.g., description and universal product code (UPC) of a food item product, on who's packaging the recipe square QR code will be placed, etc.) related food product items (e.g., other food product items that may be used as ingredients in the recipe, etc.), participation reward information and distribution criteria, and uniform resource identifier or locator information associated with the merchant's website. Exemplary recipe square provisioned data is presented in Tables 16-20, and includes a RecipeSquareID 400, recipe name information 402, associated food/beverage product merchant or manufacturer identifier information 404, associated food/beverage product merchant or manufacturer name information 406, recipe category information 408, associated food/beverage product retailer/distributor identifier information 410, distribution or retail sales geographic location information 412, retail store identification information 414, recipe media file (e.g., PDF, etc.) identifying information 416, recipe URL address information 418, recipe video/video link address information 420, recipe image/image link address information 424, recipe ingredient information 426, recipe ingredient amount information 428, recipe step information 430, and recipe step description 432.

Exemplary data tables and data structures associated with various embodiments of recipe square service are presented in FIGS. 4D and 4E. Once provisioning is completed for the recipe, it is associated with a RecipeSquareID value (step 3). In one embodiment, a RecipeSquareID may be randomly or algorithmically generated and assigned to an associated recipe/provisioned recipe information. In one embodiment, a RecipeSquareID value may be further associated with a food product entity/item by module 208 during the provisioning process. In some embodiments, a RecipeSquareID may include or incorporate a UPC or other Global Trade Item Number (GTIN) associated with the food/beverage product entity.

In step 4, the RecipeSquareID value or a recipe square QR code 704 that includes or contains the RecipeSquareID value (or an encoded version of the RecipeSquareID value) is generated and communicated to the provisioning entity 600 with the aid of recipe square application server 200, where the recipe square QR code includes information that can be used to identify a recipe. In this example, a RecipeSquareID value is generated by recipe square control logic module 216 and incorporated into the recipe square QR code, which can then be deployed (e.g., printed on product packaging, etc.), as indicated in step 5.

In one embodiment, information that identifies or can be used to identify application server 200 is also encoded in the recipe square QR code. The exemplary recipe s QR code also includes information that identifies or can be used to identify and establish communications with a network server or host computer that provides recipe square service. Exemplary information that identifies or can be used to identify a network server or host computer for providing recipe square service may include, but is not limited to, a uniform resource locator (URL) and URL parameters, an Internet protocol (IP) address and port identifier. It will be appreciated with regard to the recipe square service embodiments described above that such services may also be provided via a native Recipe Square application that is installed on the user's smartphone. In such cases, information that identifies or can be used to identify the address of a Recipe Square server to which the appointment information should be communicated need not be encoded within the recipe square QR code that is displayed to and scanned by a user. In such native application deployments, the information that identifies or can be used to identify the address of a recipe square server may be pre-configured and stored in the smartphone's memory, such as in data storage module 116. Alternatively, the native application may dynamically determine the address of the appropriate Recipe Square server at the time of the recipe square QR code scan by a user. In such scenarios, recipe square processing is very similar to that described above, except that the address of the Recipe Square server is not obtained by a user scan of a Recipe Square QR code.

Copies of the recipe square QR code 704 may be deployed in any number of ways and formats including, but not limited to, on packaging of food or drink products, on displays or shelves where a food or drink product is sold, on a receipt associated with the purchase of a food or drink item, printed tags that are placed on the shelf that holds/displays the associated product, direct mailing collateral, in-store displays, computer monitor display, magazine advertisements, purchase receipts, as per step 5.

Shown in FIG. 4B, a user scans recipe square QR code 704. Scanning of the recipe square code causes the scan-enabled client module 104 to communicate user identifying/user login credentials and Recipe information to recipe square application server 200, as indicated in step 1. When the recipe square QR code is scanned by the user's QR code scanner, the encoded RecipeSquareID information and recipe square server identifier or address information is extracted by the QR code scanner and the information that identifies or can be used to identify a recipe square application server is used to facilitate communication of the extracted RecipeSquareID information to the identified recipe square scan-triggered application server. It will be appreciated that in various embodiments of the subject matter described herein, the RecipeSquareID information may be encrypted or obfuscated during communication from the user's mobile communication device to the Recipe Square application server. In other embodiments, the information that identifies or can be used to identify a Recipe Square application server may itself be encrypted or obfuscated when read by the QR code scanner, and may be subsequently decrypted/de-obfuscated by scan control logic module 112 so as to obtain the information necessary to identify the recipe square application server to be contacted. In some embodiments of Recipe Square service, user identifying information may also be provided to server 200 at or near the time of the scan. While user identifying information is not required, for the purposes of illustration, the embodiment described herein assumes that user identifying information is provided to server 200 at or near the time of the scan. This user identifying information may be provided to the recipe square application server 200 before, after, or at the same time that the previously discussed scanned information is provided. For example, in one embodiment, the user may log in (i.e., provide login credentials that are sufficient to identify and authenticate the user) prior to scanning the Recipe Square QR code, and application server 200 is adapted to associate the subsequently received RecipeSquareID information with the user. Alternatively, the user's login credentials may be provided at the time of/as a result of the Recipe Square QR code scan, along with the RecipeSquareID information.

Recipe square application server 200 receives the scan code information, which includes user identifying/user login credentials and RecipeSquareID information, and in step 2, uses the provided RecipeSquareID information to access the associated recipe information. Server 200 logs/records the received scan information in a scan transaction record. If provided, module 216 may automatically add the associated recipe or a link/pointer to the associated recipe to a digital recipe book repository associated with the user's scan-triggered service account. The user can log into the user's scan-triggered service account and access any of the recipe information in the user's digital recipe book from any network connected computing device, via a purpose-built client software application or a web browser client that is adapted to access the user's digital recipe book information from a scan-triggered application server associated network storage resource. In an alternate embodiment (not shown), module 216 may first ask user of mobile device 100 for confirmation that the recipe should be added to the user's digital recipe book prior to adding the recipe to the user's digital recipe book. It will also be appreciated that, in one embodiment, a user's digital recipe book may be facilitated through the maintenance of scan-transaction and use input logs that store data such as that shown in Tables 21 and 22. For instance, a digital recipe book inclusion flag 450 may be used to track which recipes are in a user's digital recipe book. In such a case, the scan log file serves as a binding point for the user and the user's associated digital recipe book contents. It will be appreciated that other data structures may be used/implemented by server 200 to facilitate such digital recipe book functionality. Exemplary scan transaction record information includes user identifying information 434, RecipeSquareID information 436, scan timestamp information 438, granted reward ID information 440, recipe to be/was emailed to the user flag/indicator information 442, user feedback information 443, user rating score information 445, recipe shared-with entity information 448, and keep in digital recipe book indicator flag 450.

In step 3, server 200 responds with an acknowledgement message that includes information that causes the associated recipe descriptive information (e.g., recipe name, ingredients list, preparation steps, associated food product items, etc.) to be immediately displayed to the scanning user.

Recipe square control logic module 216 binds the recipe associated with the scan to the user's recipe square recipe data log or vault using the received recipe identifying information. Via a mobile user browsing interface or a desktop user interface, the user may log into the Recipe Square application server 200 and browse the contents of the user's Recipe Square recipe data/vault.

In one embodiment, Recipe Square Control Logic Module 216 may determine (based on prior provisioned rules) whether the user should be granted a reward in exchange for scanning the Recipe Square code. If a reward is to be granted, reward control logic module 210 may facilitate the crediting of the granted reward to the user's account (step 4).

In step 5 of this exemplary embodiment, user of mobile device 100 is adapted to communicate recipe and/or product feedback or product rating information to module 216. For example, module 216 may communicate a question and associated response options (e.g., “How did you like this recipe?”, “Liked it”, “It was Ok”, “Loved it”) to user of mobile device 100 (not shown in FIG. 4B). In one embodiment, the response options are displayed on the user's smartphone screen as tap-selectable buttons. The user taps the button associated with the user's desired feedback response option, and information which can be used to identify the selected feedback response option is communicated to server 200, where it is logged and stored, as illustrated in step 5. Recipe (and/or associated product item) rating score information may be collected in a similar manner, where module 216 provides the user with rating scale information which is displayed on the user's mobile device. The user specifies a rating score and the rating score information is communicated to server 200, where it is logged and stored and may be later analyzed and reported. Such feedback/rating data collection functionality may be deployed with all embodiments of recipe square service, although for the purpose of illustration is only explicitly shown in the embodiment presented in FIG. 4B. Exemplary recipe square scan transaction data that is stored by module 216 in response to receipt of a user scan is shown in Table 21 illustrated in FIG. 4E, and may include, for example, the associated RecipeSquareID value 436, scan timestamp information 438, user feedback information 443, and user rating score information 445. Also, user of mobile device 100 may elect to have the recipe associated with a scanned recipe square emailed (see control element 442) to the user and/or the user may provide a contact address associated with a friend to which the recipe is to be shared. In response to the share request, module 216 is adapted to generate an email that includes the recipe (which is emailed to the provided contact address) or post the recipe to a social media account (e.g., Facebook) associated with the scanning user or the shared-with user.

In an alternate embodiment, a merchant or food manufacturer may choose to deploy recipe square services in a slightly different manner. In this alternate deployment approach, the merchant provisions recipe information in a manner that is similar to that previously described. In this deployment strategy, a recipe square scan code is generated which includes information (e.g., RecipeSquareID) that identifies or is associated with a group or pool of recipes. In this case, the RecipeSquareID does not identify/is not associated with a single recipe. When a user scans the recipe square QR code, the RecipeSquareID information is communicated to application server 200, such as is illustrated in step 1 of FIG. 4C. Recipe square control logic module 216 examines the RecipeSquareID information and accesses a set or collection recipes that have been previously provisioned by the merchant in a manner similar to the provisioning already described. Exemplary recipe group/pool data is shown in Table 24, and includes a recipe group identifier 458 and a list of recipes in the group/pool 460. One of the recipes is selected and may be subsequently added to the user's digital recipe book in a manner similar to that previously described (step 2). Recipe information is returned to the user in a manner similar to that previously described (step 3). A digital reward may be granted to the user (step 4), and feedback may be collected (step 5). In yet another related embodiment, a different recipe may be provisioned and generally made available for distribution every week (or some other arbitrary period of time). When a user scans a recipe square QR code associated with the merchant, the “current” recipe is added to the user's digital recipe book.

It will be appreciated that embodiments of the recipe square service enable a user to collect and maintain merchant-provided recipe information (and associated goods/services information) in a manner that keeps the user's identity and interest hidden from the merchant who generates and displays the recipe square scan code. Users may, at their discretion, choose to allow a vendor associated with a recipe square code that the users have scanned to obtain access to information that identifies the users.

According to one aspect, the subject matter described herein includes a system for facilitating the collection and storage of recipe information via the scanning of a scanable code by a scan-enabled client module. The system includes a computing platform including at least one processor. The system further includes a server application module executable by or embodied within the at least one processor. The server application module is configured to receive from the scan-enabled client module a request from a user for a recipe, where the request is generated by the scanning of a scan code by the user. The server application module is further configured to, in response to receiving the request, store an association that binds the recipe to the requesting user.

### Q-Game Square

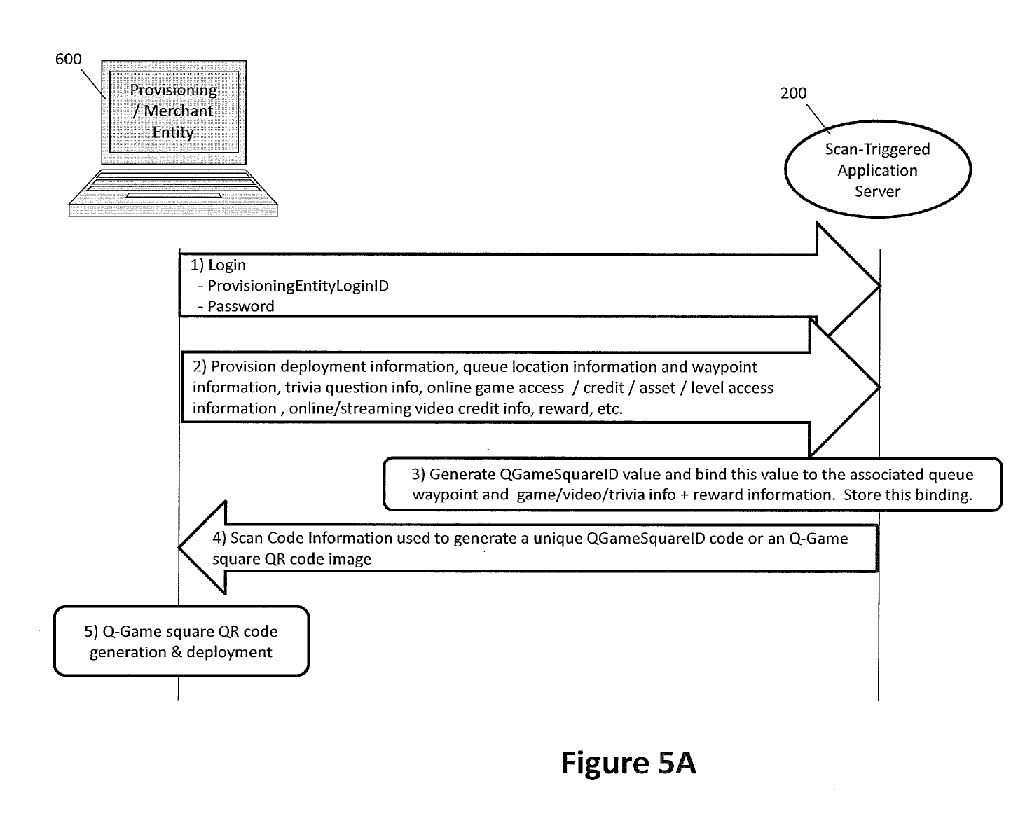

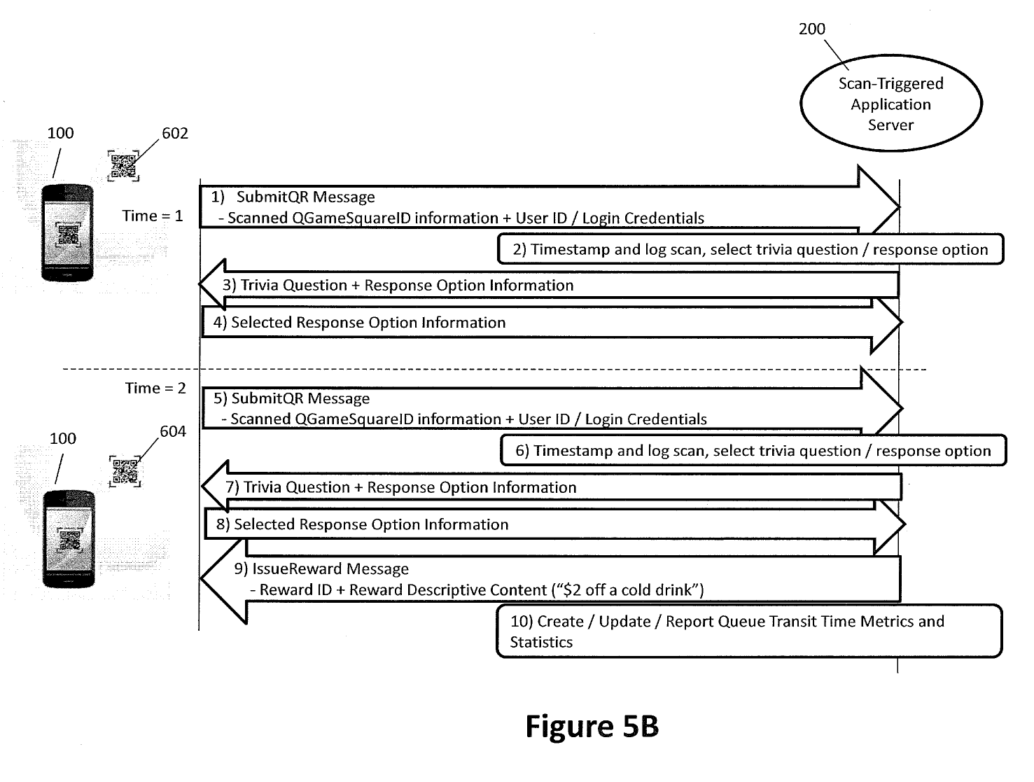

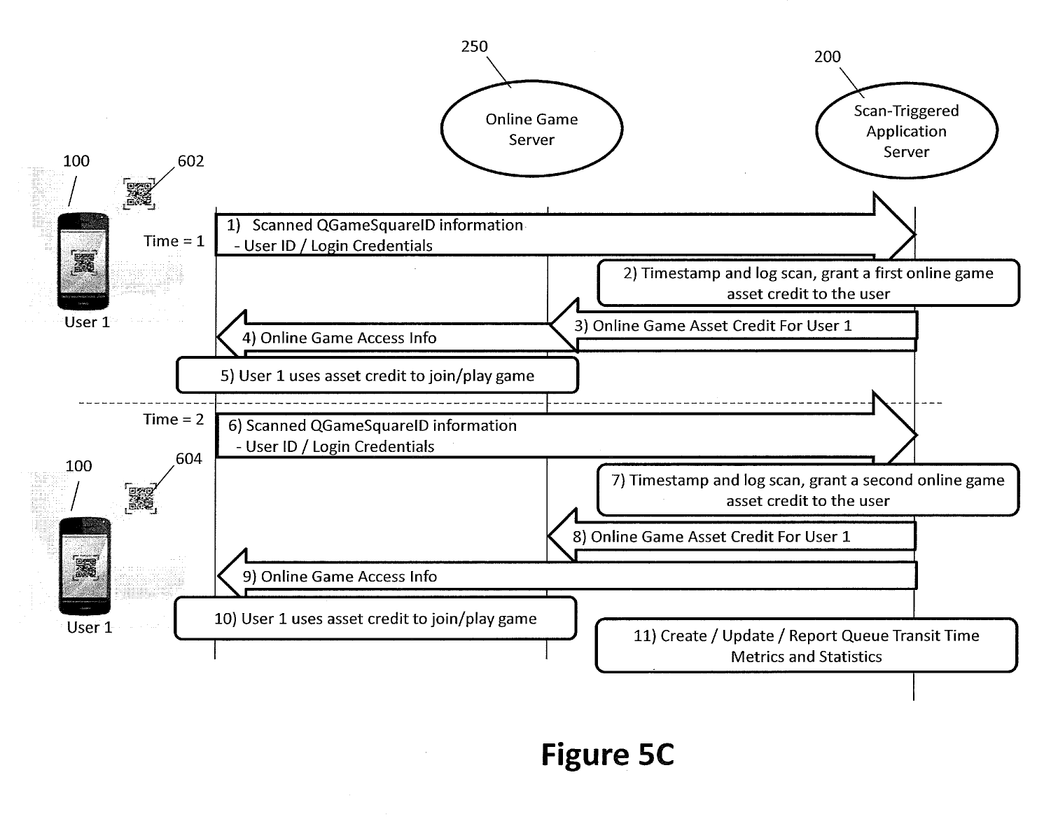

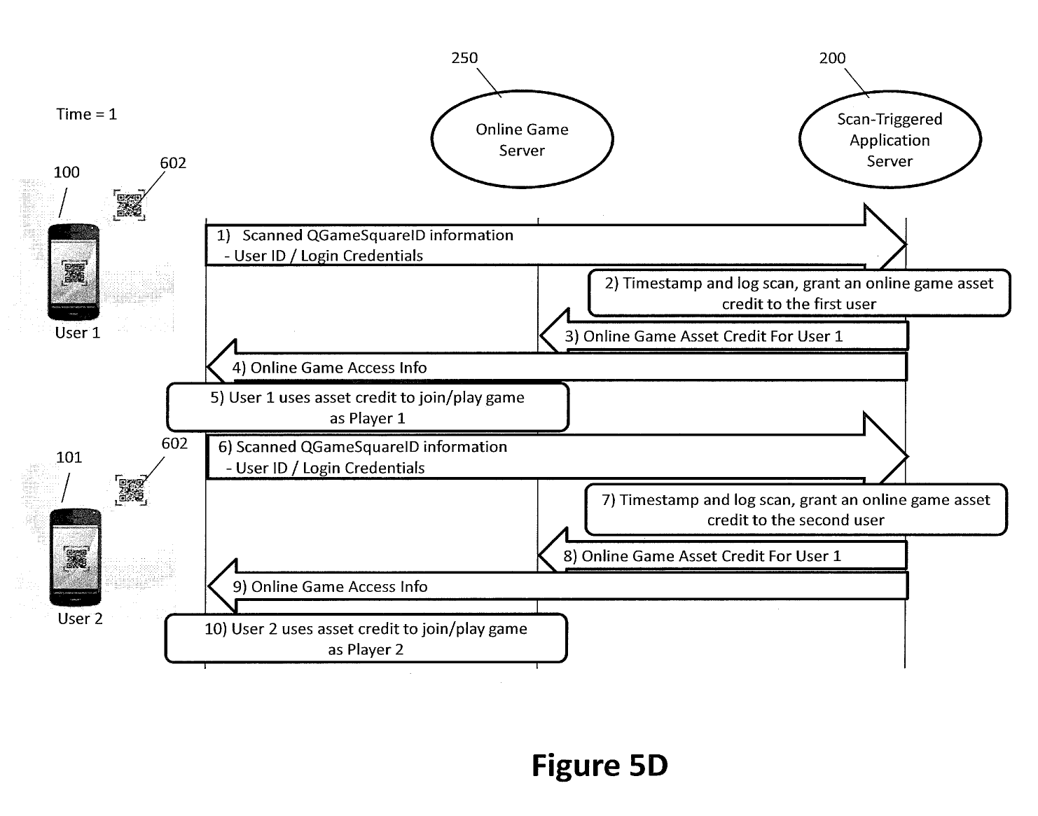

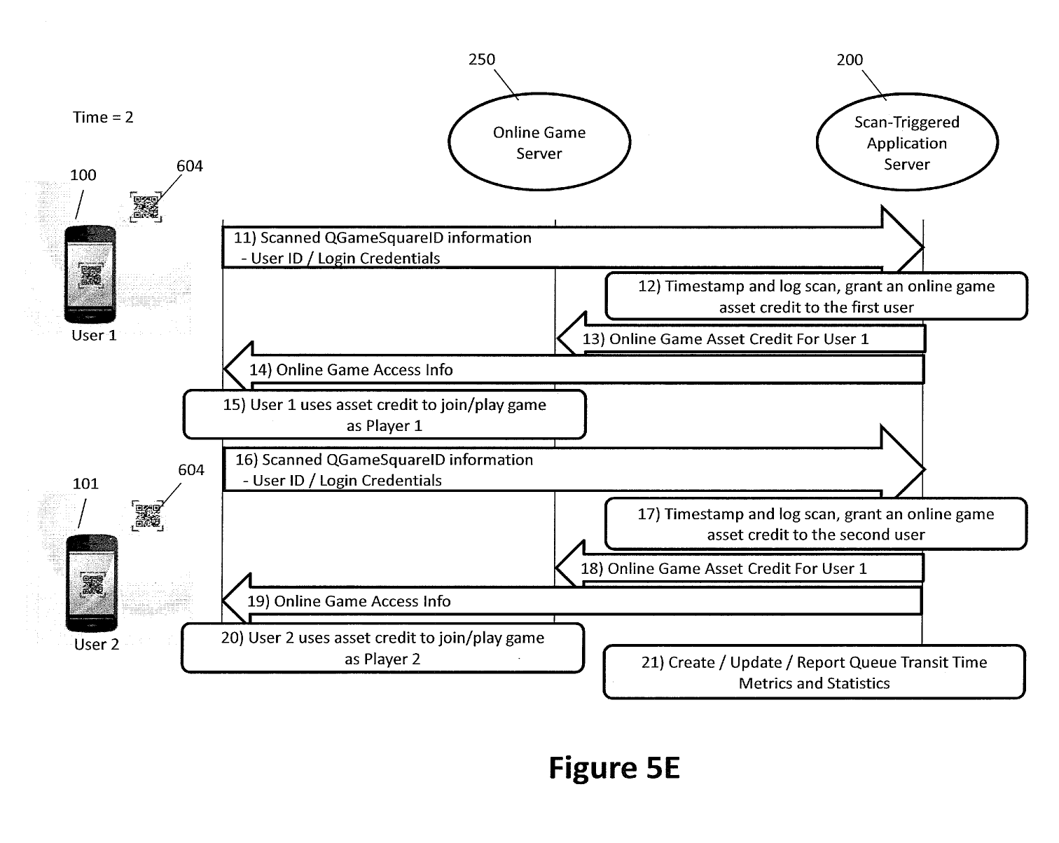

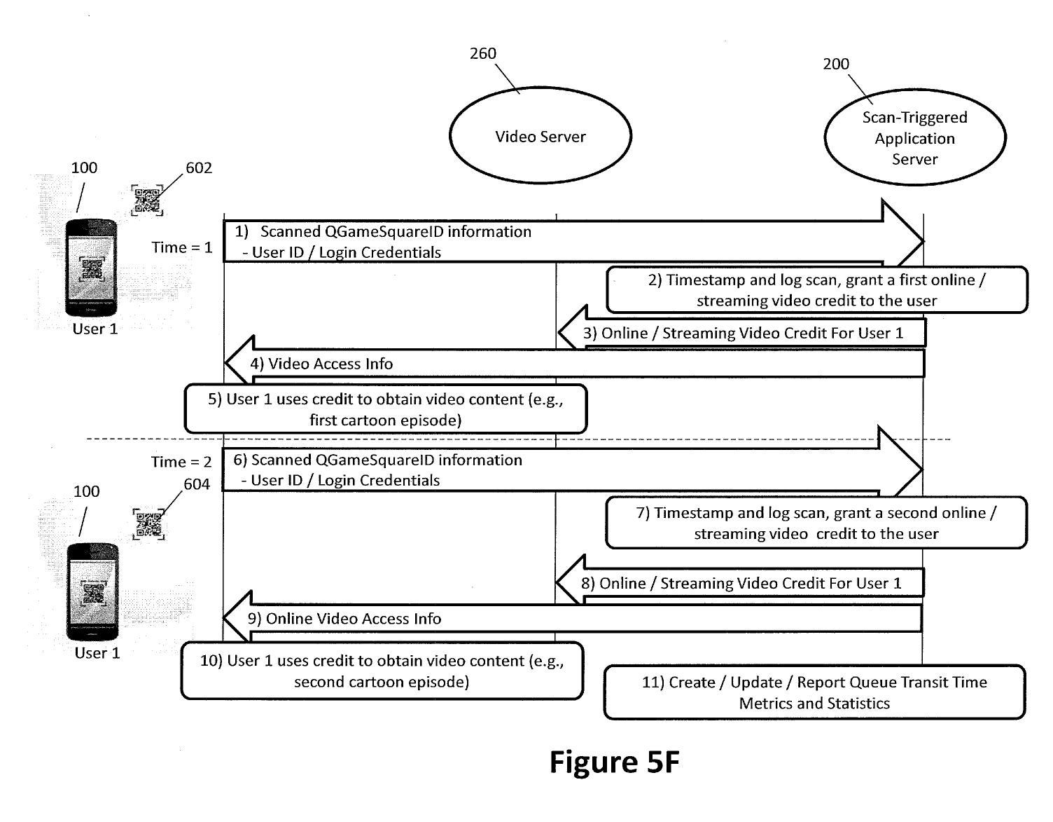

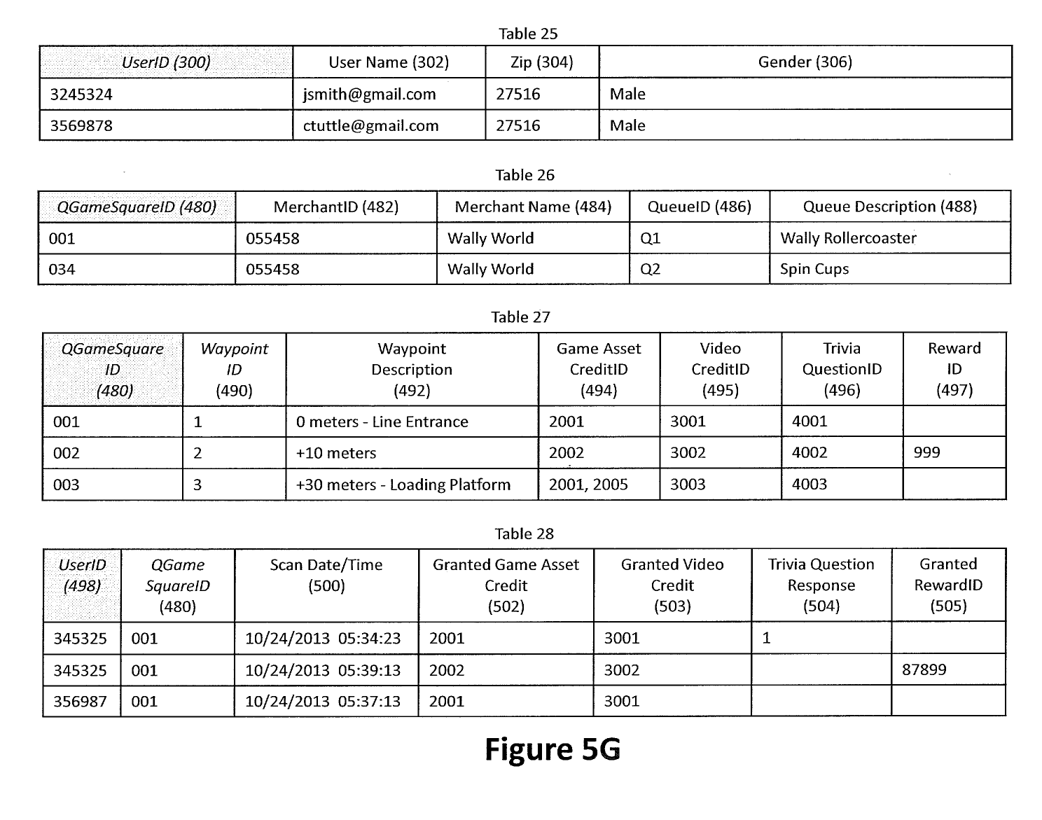

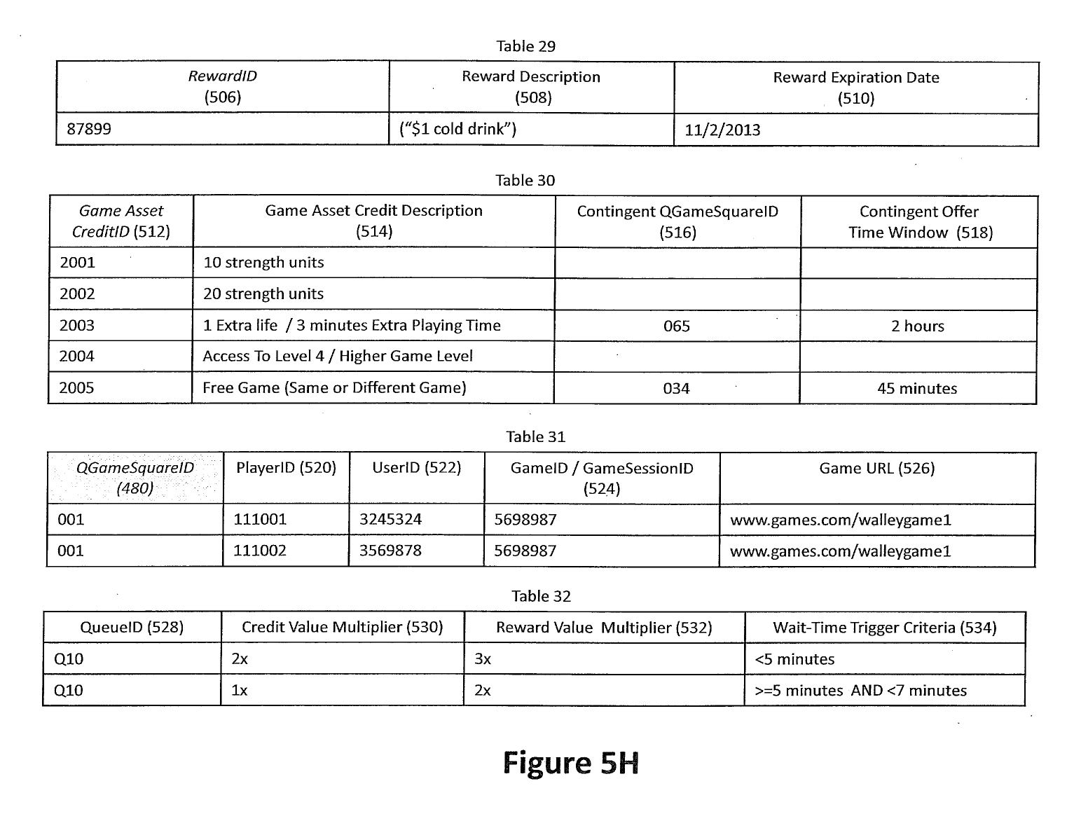

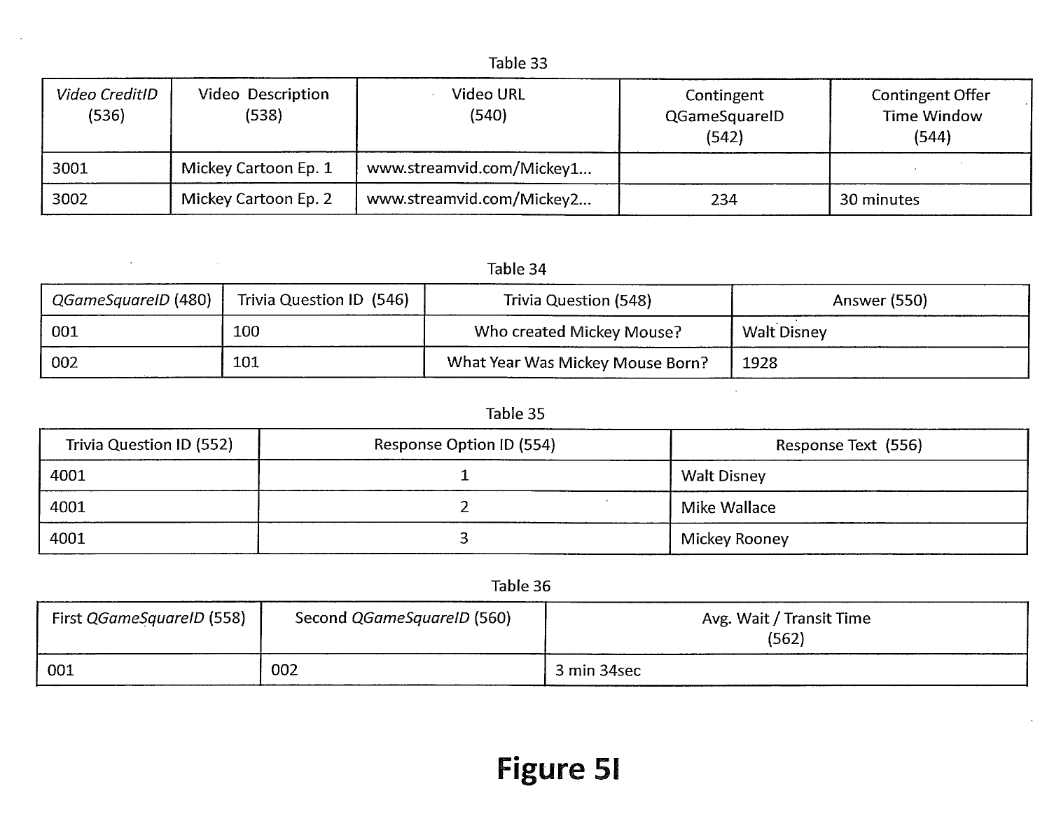

Shown in FIGS. 5A-5I are diagrams that generally illustrate exemplary, data, provisioning information flows and processing flows associated with embodiments of a scan-triggered queue management service system provided by a scan-triggered service platform. This service is referred to herein as Q-Game square service, which is a service that facilitates the entertaining of queue members, the management queue volumes, and measurement of queue wait times. This Q-Game service is triggered via the scanning of a Q-Game square service scan code by one or more users in a suitably provisioned/equipped queue or line. Exemplary use of Q-Game square service may involve a theme park, amusement park, concert venue, sporting event venue, a public transportation terminal, or any other venue or location where people are required to wait in a queue or line. In one example, a customer at a theme park enters a queue or line that is associated with an attraction. As the customer enters the queue, the customer scans a first Q-Game square scan code (e.g., a QR code, NFC tag/code, RFID tag/code, Bluetooth tag/code, etc.) that has been placed at the entrance to the queue. The user may scan this service scan code, for example, with a QR code scanner associated with the user's smartphone. Additional Q-Game square scan codes are placed at various points/waypoints along the queue, and as the customer proceeds through the queue, the customer scans some or all of these additional Q-Game square service codes. If the theme park operator spaces the multiple Q-Game square QR codes in an orderly, spatially well understood manner (e.g., every 5 meters, etc.), then the sequence of Q-Game square QR code scans associated with a customer can be used to effectively generate and report queue movement/transit/volume metric information. If such queue timing information is collected for many customers, then queue movement statistics may also be generated and reported by the Q-Game square service. It will be appreciated that Q-Game square service may be deployed using any sequence of spatially well-ordered/placed scan codes. For instance, the example given above could be implemented using Q-Game square QR codes that are identified to the customer as being part of a queue timing system for the purpose of collecting queue timing metric and statistical information. However, the intent of Q-Game square QR codes may be easily “camouflaged” and scan-compliance (e.g., the willingness of a customer to scan the Q-Game square code) may be increased by embedding or combining Q-Game square processing with other more interesting and entertaining uses for scan codes, which include the distribution of scan participation incentives. Exemplary Q-Game square scan participation incentives may include, but are not limited to, digital rewards (e.g., coupon for a good or service), an online game asset credit, and an online video credit. Q-Game square scan waypoints (e.g., a post, sign, computer display screen, etc.) that include a scanable (e.g., QR code, NFC tag/code, RFID tag/code, Bluetooth tag/code, etc.) Q-Game square scan code may be placed at various spatially well understood, intervals along a queue at an amusement park ride, attraction, venue entrance, ticket office, etc. Associated with each Q-Game square scan code is an identifier (e.g., QGameSquareID) that can be provided to an associated Q-Game square scan-triggered server via the scanning of the Q-Game square scan code by a user (e.g., via a scanner associated with the user's smartphone, etc.). In one embodiment, a trivia question and related possible response options/answers are associated with the QGameSquareID value encoded in the Q-Game square scan code. When the code is scanned by a user, the associated trivia question is displayed and/or the associated possible response options/answers. In one embodiment, a separate Q-Game square scan code may be provided for each possible response option/answer (e.g., each response option/answer scan code contains a different QGameSquareID value, where each value is associated with a different response option. For example, queue waypoint display number 1 with trivia question/answer option scan codes that are uniquely associated with that queue waypoint location is placed at the entrance to the attraction queue (i.e., the back or end of the queue). Queue waypoint display number 2 with question/answer option scan codes that are uniquely associated with that queue waypoint location is placed at the entrance to the attraction loading zone (i.e., the front or head of the queue). As a queue member reaches waypoint number 1, the customer scans a Q-Game square scan code associated with one of the possible answer options for an associated trivia question (which is displayed to the user). The scanned answer option for waypoint 1 is communicated to the Q-Game square service scan-triggered server, which logs information that, in one embodiment, identifies the scanning customer/user, the associated QGameSquareID value bound to/associated with that queue waypoint location (i.e., which implies the queue member's current position in the queue), and the time of the scan. In other embodiments of the present Q-Game square system that are focused primarily on in-queue entertainment, user identifying information may not be provided to or used by Q-Game square scan triggered server. As the same queue member reaches queue waypoint 2, the queue member scans one of the possible answer/response options. The scanned answer/response option associated with queue waypoint 2 is communicated to the Q-Game square service scan-triggered server, which logs information that identifies the scanning queue-member/user, the scanned Q-GameSquareID value (i.e., which implies the queue member's current position in the queue), and the time of the scan. Using this information, the Q-Game square service server can compute an estimate of the customer's traversal of the queue. As is generally illustrated above, a Q-Game square scan code as described herein can be used to provide concurrent services (i.e., monitor queue transit time/volume, and provide trivia quiz in-queue entertainment service).

The Q-Game square service may also provide the user with a participation incentive, such as a digital reward (e.g., coupon for a good or service) in return for scanning some or all of the scan codes in the queue at are used to provide Q-Game square service. In one embodiment, the value of new rewards granted or the value of previously granted (but not yet redeemed/expired) rewards may be increased based on the number of Q-Game squares scanned by a queue member in the same queue. For example, if a queue member is willing to wait in a long queue, and to scan the Q-Game Square associated with each queue waypoint, then the user may be granted a higher value reward (as compared to if the user had only scanned the first Q-Game Square scan code in the queue) or the value of a previously granted reward may be increased. In one embodiment, the value of a previously granted reward may be increased or a new reward granted contingent on the user entering a specified queue (and scanning one or more Q-Game square scan codes in that queue), where the specified queue is a different queue from the scanning user's current queue. In one embodiment, the value of a reward granted to queue members in response to scanning of one or more Q-Game square scan codes may be increased or decreased depending upon average queue wait times/queue transit times as determined by the associated Q-Game square service server. As such, scan-triggered Q-Game square server may include logic and control capabilities that allow users to be incentivized to enter a specified attraction queue, and as such may effectively serve to assist in the “steering” or guiding of customers/users preferentially to certain attraction/event queues at certain times to assist in smoothing usage patterns/attraction user traffic among multiple attractions/queues. The Q-Game square service server may also facilitate and track redemption of the participation reward by the user.

In another embodiment, instead of providing access to trivia questions and/or response options, a Q-Game square service code, when scanned by a queue member, causes a network/cloud-based or online game asset credit to be granted to the scanning user, which may be redeemed/used by the queue member to play an online/network-based game. Such participation incentive “credits” may be used immediately (either manually redeemed by the user or automatically redeemed) or may be used at a later time prior to expiration. Exemplary online game asset credits include, but are not limited to, game access privileges, game level access privileges, extra players/lives, extra power, extra game-specific assets (e.g., tools, weapons, game-specific resources, etc.), any associated game resource that can be otherwise eventually earned through extensive/experienced/prolonged play, extra playing time, a free game, access to a different game, etc. In one embodiment, the progressive value or magnitude of such online game asset credits may increase as the queue members traverses the queue and scans the associated Q-Game square scan code as each queue waypoint. In one embodiment, an online game asset credit may be granted to a queue member, where the asset credit grant is contingent on the user entering another queue and scanning a Q-Game square scan code in that queue within a prescribed window of time. If the user enters the specified queue and scans one or more of the waypoint Q-Game square scan codes in that queue within the prescribed time window, then the user may redeem/use the contingently granted online game asset credit. In one embodiment, the value of online game asset credits granted to queue members in response to scanning of one or more Q-Game square scan codes may be increased or decreased depending upon average queue wait times/queue transit times as determined by the associated Q-Game square service server.

In one embodiment, queue members who scan a Q-Game square scan code placed at a queue waypoint may be provided with access to an online game, where the scanning users are given access to the online game or an online game session in a manner that enables them to play against or with one another in a multi-player gaming session/environment. In one embodiment, all players in multi-player session are associated with the same queue. In another embodiment, players in one queue comprise a team for made up of queue members in that queue. Teams from one queue may play against teams from another queue. In one embodiment, the associated online game assets that each player receives when joining/playing the online, multi-player game are determined, based in part, on a queue wait time/transit time/volume metric that is computed at or near the time of each user's Q-Game square service code scan. For example, a queue member/user who scans a Q-Game square code associated with a queue that has a short wait time/light usage volume may be granted a more valuable or larger magnitude online game asset credit when joining the game. Such dynamic online game asset credit valuations may be used by Q-Game square service server to dynamically incent/dis-incent users to enter specific queues (e.g., based on excessive traffic at one queue versus another, uneven attraction usage patterns, etc.).

In another embodiment, instead of providing access to online game asset credits, a Q-Game square service code, when scanned by a queue member, causes a network/cloud-based or online/streaming video service credit to be granted to the scanning user, which may be redeemed/used by the queue member to watch video media. Such participation incentive “credits” may be used immediately (either manually redeemed by the user or automatically redeemed) or may be used at a later time prior to expiration. Exemplary online video service credits include, but are not limited to, video-on-demand access privileges where the scanning user may select the video content that the user would like to view from a menu of options, content-specific access privileges (e.g., Episode 1 of a cartoon, etc.), viewing time privileges (e.g., 60 seconds, 2 minutes, etc.), etc. In one embodiment, the progressive value or magnitude of such video service credits may increase as the queue members traverses the queue and scans the associated Q-Game square scan code as each queue waypoint. In one embodiment, a video service credit may be granted to a queue member, where the credit grant is contingent on the user entering another queue and scanning a Q-Game square scan code in that queue within a prescribed window of time. If the user enters the specified queue and scans one or more of the waypoint Q-Game square scan codes in that queue within the prescribed time window, then the user may redeem/use the contingently granted online video service credit. In one embodiment, the value of online video service credits granted to queue members in response to scanning of one or more Q-Game square scan codes may be increased or decreased depending upon average queue wait times/queue transit times as determined by the associated Q-Game square service server. For example, more/less video selection menu options may be made available, or the length of the video played may be increased/decreased, etc. Shown in FIG. 5A is exemplary Q-Game square service provisioning processing, where a provisioning entity uses computer terminal 600 to log into a provisioning interface associated with a scan-triggered application server 200 that is hosting the Q-Game square application, as indicated in step 1. In step 2, the provisioning entity provisions or configures Q-Game square information associated with the providing of Q-Game square queue management services. Exemplary Q-Game provisioning data is presented in the Tables 26-30, and 32-35, shown in FIGS. 5G-5I. Table 25 illustrates user information, which may be self-provisioned by each user or which may be provisioned by a scan-triggered service provisioning operator. Table 25 includes user identifying information 300 (e.g., scan-triggered service user identifier/user name, email address, mobile IP address, social media account username, phone number, etc.), username information 302, location/address/zip code information 304, gender information 306, a temporary identity/identifier assigned by the scan-triggered Q-Game square service provider, age information, a merchant/venue/ticket vendor generated user identifier, etc. In step 3, Q-Game logic control module 220 generates a QGameSquareID identifier value, which is used to create a binding record that is stored at/by server 200. Exemplary Q-Game square binding record information includes, but is not limited to, QGameSquareID identifier 480, a merchant/venue operator/theme park operator/event vendor identifier 482, a merchant/venue operator/theme park operator/event vendor name/description 484, a queueID (e.g., which can be used to identify a particular queue, such as the line associated with a particular theme park ride or attraction), a queue description or name 488. In one embodiment, also associated with each QGameSquareID is a queue WaypointID identifier 490, an associated Waypoint description 492, a GameAssetCreditID identifier 494, a VideoCreditID 495, a TrivaQuestionID 496, and a RewardID 497. As described above, in various embodiments, a participation incentive such as an online game asset credit, a video credit may be provided to a user who scans an associated Q-Game square scan code. In the case of the online game asset and video credits, these participation incentive credits may be immediately and automatically applied, such that the user is immediately provided with the opportunity to join/play an associated online game or view associated streaming video content. Alternatively, in other embodiments, a scanning user who is granted such credits may elect to redeem them at a later time of the user's choosing. In step 4, Q-Game square scan code information is communicated to provisioning entity 600. In step 5, each Q-Game square scan code may be deployed in the associated queue(s), in a manner that makes the codes available for users residing in the queue(s) to scan. Again, it will be appreciated that such Q-Game squares are deployed within the appropriate queues at the appropriate/associated queue waypoints, according to the QGameSquareID-WaypointID relationships established at provisioning time.

For example, the Q-Gamesquare QR code at the head waypoint of a queue would include an identifier that is unique with respect to the identifier associated with the Q-Game square QR code at the tail waypoint of the queue. It will be appreciated that in the exemplary embodiments shown herein, a single identifier (i.e., QGameSquareID) is used/encoded within each Q-Game square scan code, which through appropriate provisioning contains sufficient information to identify a particular waypoint location within a queue. In other embodiments, multiple identifiers could be used/encoded within each Q-Game square scan code, where the combination of identifiers encoded in the scan code can be used by scan-triggered Q-Game square server 200 to identify a particular waypoint location within a queue.

In cases where a venue operator (e.g., theme park operator) hosts a Q-Game square system that is used only in the operator's theme park, information that identifies a venue operator/merchant (i.e., MerchantID) is not necessarily required or needed. It will also be appreciated, as mentioned previously, that Q-Game squares scan codes may be concurrently used to provide other scan code-based services. In such cases, other information and identifiers (e.g., feedback survey question ID, feedback survey response option ID, rating scale ID, etc.) may also be incorporated, concatenated, hashed or otherwise included in a scan code that is used to provide Q-Game square service.

In one embodiment, information that identifies or can be used to identify application server 200 is also encoded in the Q-Game square QR code. The exemplary Q-Game square QR code also includes information that identifies or can be used to identify and establish communications with a network server or host computer that provides Q-Game square service. Exemplary information that identifies or can be used to identify a network server or host computer for providing Q-Game square service may include, but is not limited to, a uniform resource locator (URL) and URL parameters, an Internet protocol (IP) address and port identifier.

Once provisioning is completed, a Q-Game square QR codes are generated by or for the merchant/theme park operator entity with the aid of Q-Game square application server 200, where the Q-Game square QR codes include information that identifies or can be used to identify the attraction queue (e.g., Water Mountain ride, etc.) and a queue waypoint location or position within the queue (e.g., tail of the queue, +10 meters, +20 meters, loading platform, etc.). In this example, Q-Game square QR code 602 is associated with a first waypoint location in a queue and Q-Game square QR code 604 is associated with a second waypoint location in the queue. These scan codes may be deployed in any number of ways and formats including, but not limited to, on a printed display/sign, on a video monitor display screen, etc.

In FIG. 5B, a user scans Q-Game square code 602. Scanning of the Q-Game square code causes the scan-enabled client module 104 to extract the encoded QGameSquareID value from code 602 and communicate this information along with user identifying/user login credential information to Q-Game square application server 200, as indicated in step 1. It will be appreciated that user identifying information may include a temporary identification token value that is created by server 200 and assigned to mobile device 100 for the purposes of facilitating access to Q-Game square service. If server 200 determines that the scanning user is not a registered user of the scan-triggered service system (e.g., no user identifying information is initially passed in step 1), then such temporary user identification or mobile device identification information may be communicated by server 200 to mobile device 100, where it is stored in a cookie or other temporary file on the mobile device 100. As such, users who are not registered users of the scan-triggered service platform that is providing Q-Game square service may still access and enjoy Q-Game Square services.

In one embodiment, when the Q-Game square QR code is scanned by the user's QR code scanner, in addition to the encoded QGameSquareID information, information which can be used to identify serving Q-Game Square scan-triggered server 200, such as URL information, IP address information, etc. is also extracted from the Q-Game Square scan code by the QR code scanner and the information that identifies or can be used to identify a Q-Game square application server is used to facilitate communication of the extracted QGameSquareID information and user identifying information to the identified Q-Game square application server. It will be appreciated that in various embodiments of the subject matter described herein, the QGameSquareID information may be encrypted or obfuscated during communication from the user's mobile communication device to the Q-Game Square application server. In other embodiments, the information that identifies or can be used to identify a Q-Game square application server may itself be encrypted or obfuscated when read by the QR code scanner, and may be subsequently decrypted/de-obfuscated by scan control logic module 112 so as to obtain the information necessary to identify the Q-Game square application server to be contacted. Also communicated to the Q-Game square application server is information that identifies or can be used to identify the user (e.g., the queue member / person that scans the Q-Game square QR code). This user identifying information may be provided to the Q-Game square application server 200 before, after, or at the same time that the previously discussed scanned information is provided. For example, in one embodiment, the user may log in (i.e., provide login credentials that are sufficient to identify and authenticate the user) prior to scanning the Q-Game square QR code, and application server 200 is adapted to associate the subsequently received

QGameSquareID information with the user. Alternatively, the user's login credentials may be provided at the time of/as a result of the Q-Game square QR code scan, along with the QGameSquareID information.

In step 2, Q-Game square application server 200 receives the user identifying/user login credentials and queue waypoint identifying information (e.g., QGameSquareID) extracted from code 602, and logs some or all of the received information in a scan transaction record. Exemplary scan transaction record information is shown in Table 28 and includes user identifying information 498, received QGameSquareID information 480, and scan timestamp information 500. If module 220 determines that the scanning user should be granted an online game asset credit or a video credit, then this credit information is included in the scan transaction record, and may be stored in granted game asset credit field 502 or granted video credit field 503. In this example, module 220 selects a trivia question and associated response options, and in step 3, communicates the question and response option information to user via mobile device 100. The question and associated response options are displayed to the user on the screen of the user's mobile device 100. In one embodiment, each response option is associated with a touch or tap-selectable button on the screen. In step 4, the user selects an answer/response (e.g., by tapping the associated response option on-screen button) and information that can be used to identify the selected response option is communicated to server 200. The user's response is included in the scan transaction record, and stored in trivia question response field 504.

If module 220 determines that the scanning user should be granted a digital reward (e.g., digital coupon that can be used to obtain a good or service, or a discount on a good or service) granted reward information may also be included in the scan transaction record, and stored in granted RewardID field 505. Exemplary provisioned digital reward information is shown in Table 29, and includes reward identifier information 506, reward description/value information 508, reward expiration 510.

As the user/queue member moves through the queue, at sometime later, the same user scans Q-Game square code 604. User identifying information and QGameSquareID information is communicated to Q-Game square application server 200, as indicated in step 5. In step 6, Q-Game square application server 200 receives the user identifying/user login credentials and queue waypoint identifying information (e.g., QGameSquareID) extracted from code 604, and logs some or all of the received information in a scan transaction record, in a manner similar to that described previously. Module 220 selects another trivia question and associated response options, and in step 7, communicates the question and response option information to the user via mobile device 100. The question and associated response options are displayed to the user on the screen of the user's mobile device 100, in a manner similar to that described previously. In step 8, the user selects an answer/response (e.g., by tapping the associated response option on-screen button) and information that can be used to identify the selected response option is communicated to server 200. The user's response is included in the scan transaction record, and stored in trivia question response field 504. In step 9, module 220 determines that the user of mobile device 100 should be granted a participation reward (e.g., digital coupon), and grants a reward to the user. In one embodiment, the granted reward is credited to/placed in a digital reward wallet associated with the user's scan-triggered service account. In another embodiment, the reward may be communicated to the user and displayed on the screen of mobile device 100. In step 10, module 220 uses the information recorded in the scan transaction log to compute a “travel” time between the waypoints associated with Q-Game square scan codes 602 and 604. In one embodiment, the provisioned queue waypoint spatial placement information may also be accessed and used in conjunction with the time measurement to compute a queue transit speed. Module 220 may use similar data associated with many users (and waypoints) to generate and report queue metric statistics, such as average wait times, average transit speeds, etc. Exemplary queue metric data is shown in Table 32, which includes first waypoint identifier information 558 (e.g., the QGameSquareID associated with that waypoint), second waypoint identifier information 560, and an average queue wait/transit time metric 562. It will be appreciated that this, and similar queue metric data may be used in some embodiments to adjust the value(s) or magnitudes of online game asset credits, video credits, rewards dynamically in such a way as to assist in the steering or directing of users towards or away from a particular attraction queue.

FIG. 5C illustrates an exemplary embodiment of Q-Game square scan triggered service that includes two Q-Game square scan codes 602 and 604, which are associated with two queue waypoint locations in an associated queue (e.g., a queue associated with a theme park ride, etc.). In this example, scan code 602 includes an encoded QGameSquareID value of “001”, while scan code 604 includes an encoded QGameSquareID value of “002”, as illustrated in Table 27. It will be appreciated that, in some embodiments, additional information, such as URL or other network address information that may used to identify scan-triggered server 200, may also be included/encoded in scan codes 602 and 604. The user's mobile device 100 scans code 602 at the time the user first enters the queue/line. In step 1, the scanning of the 602 results in the communication of the extracted QGameSquareID value “001” to server 200, along with user identifying information. This step is similar to scanning steps described in detail with respect to the previous embodiment. In step 2, scan-triggered Q-Game square server 200 receives the scan code and user identifying information and logs some or all of this information in a scan transaction record, including received user identifying information 498, received QGameSquareID information 480, scan timestamp information 500. Exemplary scan transaction record information is shown in Table 28. Module 220 determines that the user should receive an online game asset credit and selects and grants an online game asset credit/token. In step 3, scan-triggered server 200 communicates information associated with the granted online game asset credit/token to an online game server 250. In various embodiments, the particular type of online game asset credit/token communicated to online game server 250 may vary. In one embodiment, information which identifies a specific online game/online game session may be communicated along with information that specifies a particular online game asset that has been granted/should be made available to the associated user. For example, the credit may effectively communicate that the associated user is to receive the specified online game asset credit, where the specified online game asset credit information can be used by server 250 to identify the particular online game asset that is to be credited to the user (e.g., give this user access to this particular game or game session and give the user 2 extra lives, etc.). In other embodiments, information that simply serves as a generic request for an online game asset credit may be communicated to server 250. For example, the online game asset credit information communicated to online game server 250 may be such that server 250 determines or selects the specific online game asset credit that is ultimately provided to the associated user (e.g., give the user a credit for a free game, any game will do). In the most general terms, scan-triggered server 200 may select and specify, in detail, the particular online game asset that is to be credited to the user and communicate this request/information to online game server 250, or scan-triggered server 200 may simply request/specify a general online game asset credit or type of online game asset credit, and allow online game server 250 to arbitrate/determine the actual online game asset that is credited to the user, including which online game or online game session the user is allowed to play. Scan-triggered server 200 facilitates scanning user access to the online game content provided by online game server 250 via the scanning of an associated Q-Game square service code by a user and the subsequent communication of online game asset credit information to online game server 250. It will be appreciated that in other embodiments, functionality provided by online game server 250 and functionality provided by scan-triggered Q-Game square server 200 may be combined and provided by a single server that is adapted to provide both the online game content and scan-triggered service code processing/functionality described in the embodiments presented herein. In such cases, information communicated between online game server 250 and scan-triggered server 200 may be considered internal or intra-system communications.

Returning to the embodiment illustrated in FIG. 5C, in step 4, information is communicated to scanning mobile device 100 which may be used to facilitate redemption of the granted online game asset credit or access to associated online game content provided by online game server 250. Exemplary online game access information may include online game server address information 526 (e.g., URL, IP address, network server address identifier, etc.) online game or game session identifying information 524, and online game asset credit information 512 and/or 514, as shown in Tables 30 and 31. In other embodiments, online game server 250 may be configured to communicate such information to mobile device 100. In step 5, once the necessary online game asset credit/access information has been provided, mobile device 100 may establish a connection (or continue using an already established) to online game server 250, which is adapted to provide online game content and redeem/provide the granted online game asset credit (i.e., the user can join/play an online game). It will be appreciated that, in some embodiments, user interface module 108, communication module 118 and processor 122 associated with exemplary mobile device 100 may be used (along with other modules/functions, as necessary) to facilitate access to/the playing of an online game associated with a granted online game asset credit. For example, user interface module may include, incorporate or have access to mobile web browsing capabilities, such that a web-based online game can be played by the user.

In step 6, the user advances within the queue to the next waypoint location at a later time and scans Q-Game square scan code 604 (which was provisioned to be associated with the second waypoint location). Scanning of the 604 results in the communication of the extracted QGameSquareID value “002” to server 200, along with user identifying information. This step is similar to scanning steps described in detail with respect to step 1. In step 7, scan-triggered Q-Game square server 200 receives the scan code and user identifying information and logs some or all of this information in a scan transaction record (or updates the user's previous scan transaction record), including received user identifying information 498, received QGameSquareID information 480, scan timestamp information 500. Module 220 determines that the user should receive an online game asset credit and selects and grants an online game asset credit/token. In one embodiment, module 220 may selectively grant the scanning user online game asset credits that are logically ordered or progressive in nature the further the user advances through the queue (and scans the associated progression of waypoint location Q-Game square scan codes). For example, after scanning the first Q-Game square scan code associated with a queue the scanning user may be awarded an online game asset credit that permits the user to play “Level 1” of an associated online game. When the same user scans the next (or subsequent) Q-Game square scan codes associated with the queue, the user is granted credits which permit the user to play/access “Level 2” of the same online game, etc. As such, these online game asset credits are referred to herein as progressive online game asset credits.

In step 8, scan-triggered server 200 communicates information associated with the granted online game asset credit/token to the online game server 250. In step 9, information is communicated to scanning mobile device 100 which may be used to facilitate redemption of the granted online game asset credit or access to associated online game content provided by online game server 250. In other embodiments, online game server 250 may be configured to communicate such information to mobile device 100. In step 10, once the necessary online game asset credit/access information has been provided, mobile device 100 may establish a connection (or continue using an already established) to online game server 250, which is adapted to provide online game content and redeem/provide the granted online game asset credit (i.e., the user can join/continue playing an online game). In step 11, module 220 uses the information contained in the scan transaction log to calculate queue wait time metrics and/or queue volume/speed metrics. Exemplary queue metrics are shown in Table 36, and in this case an average queue wait time is calculated based on the time difference between the scanning of code 602 and 604. Table 36 includes a first QGameSquareID waypoint/location identifier 558, a second QGameSquareID waypoint/location identifier 560, and average queue/inter-waypoint transit time value 562.

Calculated queue metric information may be used by module 220 to incentivize, steer, or otherwise encourage users to preferentially elect to enter one queue versus another by dynamically varying the value of online game asset credits that are offered in one queue versus another. For example, module 220 may grant an online game asset credit, such as a credit for one free online game, where redemption of the online game asset credit is conditional/contingent on the user entering a specific queue and scanning one or more Q-Game scan codes associated with the specified queue. In Table 30, a contingent QGameSquareID 516, which identifies a Q-Game square associated with a specific queue waypoint location, is associated with an online game asset credit that may be awarded/granted to a user. Also specified is a duration or expiration time window 518 associated with the contingent offer (i.e., if the user does not enter the specified queue and scan the specified Q-Game square scan code, then the granted online game asset credit may not be redeemed. Such contingent credit and reward functionality may be applied in a similar manner to all embodiments of Q-Game square service including, online game asset credit embodiments, online video credit embodiments, and trivia question embodiments.

In another embodiment, module 220 may dynamically apply credit multipliers to credit and rewards that are granted to a user in response to the scanning of a Q-Game square scan code. Such dynamic credit/reward multipliers may be used in a manner similar to that described above so as to incentivize users to enter a specific queue within a specified period of time. Exemplary credit multiplier data is shown in Table 32, and includes a credit value multiplier or scaling factor 530, which is indirectly associated with a Q-GameSquareID via an inter-relating QueueID identifier 528. For example, an online game asset credit originally worth 10 strength units may be scaled times two and have a post-scaling value of 20, etc. In the exemplary data shown in Table 32, credit multipliers may be specified/associated with a queue or Q-Game square scan code based on a wait time trigger criteria 534. For example, a queue with a shorter wait time may be assigned a higher credit multiplier, so as to incentivize users to enter that queue, etc. Such credit and reward scaling/multiplier functionality may be applied in a similar manner to all embodiments of Q-Game square service including, online game asset credit embodiments, online video credit embodiments, and trivia question embodiments.

FIG. 5D illustrates another embodiment of Q-Game square service that involves a multi-player online game. In step 1, a first user with mobile device 100 enters a queue and scans Q-Game square scan code 602. The scanning of the 602 by the user's mobile device 100 results in the communication of the extracted QGameSquareID value “001” to server 200, along with user identifying information. This step is similar to scanning steps described in detail with respect to previous embodiments. In step 2, scan-triggered Q-Game square server 200 receives the scan code and user identifying information and logs some or all of this information in a scan transaction record, including received user identifying information 498, received QGameSquareID information 480, scan timestamp information 500. Module 220 determines that user/mobile device 100 should receive an online game asset credit and selects and grants an online game asset credit/token which is associated with a multi-player online game or a session of a multi-player online game. In step 3, the first user's granted online game asset credit information is communicated to online game service provider server 250, in a manner similar to that described in the previous embodiment. Online game asset credit information communicated to online game service provider server 250 may include information that identifies a multi-player online game or multi-player online game session to which the user has been granted permission/the right to join as a player. In one embodiment the functionality of online game server 250 and scan triggered Q-Game square service server 200 may be provided by a single server or service platform, in which case the above mentioned communication of information may be an internal or intra-system or intra-platform communication. In step 4, multi-player online game access and/or asset credit information is provided to the first user/mobile device 100. The provided information may be used by the first user/mobile device 100 to access a multi-player online game or multi-player online game session, as indicated in step 5.

In step 6, a second user with mobile device 101 enters a queue and scans Q-Game square scan code 602. The scanning of the scan code 602 by the user's mobile device 101 results in the communication of the extracted QGameSquareID value “001” to server 200, along with user identifying information. This step is similar to scanning steps described in detail with respect to previous embodiments. In step 7, scan-triggered Q-Game square server 200 receives the scan code and user identifying information and logs some or all of this information in a scan transaction record, including received user identifying information 498, received QGameSquareID information 480, scan timestamp information 500. Module 220 determines that user/mobile device 101 should receive an online game asset credit and selects and grants an online game asset credit/token which is associated with a multi-player online game or a session of a multi-player online game. In step 8, the first user's granted online game asset credit information is communicated to online game service provider server 250, in a manner similar to that described in the previous embodiment. Online game asset credit information communicated to online game service provider server 250 may include information that identifies a multi-player online game or multi-player online game session to which the user has been granted permission/the right to join as a player. In one embodiment, the multi-player online game asset credit may be associated with the same multi-player online game/game session as that being played by the first user/mobile device 100 (and other users waiting in the same queue). As such, in one embodiment, some or all members of the same queue may engage in the same multi-player game. In another embodiment, members of one queue may engage in a multi-player game against members of another queue, and as such some or all members of one queue may be placed on the same multi-player online game team. In step 9, multi-player online game access and/or asset credit information is provided to the second user/mobile device 101. The provided information may be used by the first user/mobile device 101 to access a multi-player online game or multi-player online game session, as indicated in step 10, where in one case the multi-player online game/game session may be the same multi-player online game as that being played by the first user/mobile device 100. The first and second users may play competitively (i.e., against one another) or may play cooperatively (i.e., with one another).

In steps 11 through 20, the users of mobile devices 100 and 101 advance through the queue and, at a second time, scan Q-Game square scan code 604, which is associated with a second waypoint location in the same queue. The processing involved in these steps is very similar to that described above and in previous embodiments and, as such is not repeated in detail here. It should suffice to state that the scanning of code 604 at later time points provides both users with additional multi-player online game credits and also enables module 220 to calculate queue metric information (step 21), as described and discussed previously. In one embodiment, the more users in a queue that scan Q-Game squares associated with waypoint locations in that queue, the larger/more valuable the online game asset credits or rewards granted.

Shown in FIG. 5F is another embodiment of Q-Game square service that involves the granting of online video/streaming video credits to a user who scans a Q-Game square service scan code associated with a queue or queue waypoint location. In step 1, a user scans Q-Game square code 602. Scanning of the Q-Game Square code causes the scan-enabled client module 104 to extract the encoded QGameSquareID value from code 602 and communicate this information along with user identifying/user login credential information to Q-Game square application server 200. In step 2, scan-triggered Q-Game square server 200 receives the scan code and user identifying information and logs some or all of this information in a scan transaction record, including received user identifying information 498, received QGameSquareID information 480, scan timestamp information 500. In this embodiment, module 220 determines that user/mobile device 100 should receive an online video content credit and selects and grants an online video credit/token which is associated with an online video content service/server 260, such as a streaming video server. In step 3, the user's granted online video credit information is communicated to online/streaming video service provider server 260.

In various embodiments, the particular type of online video content credit/token communicated to online game server 260 may vary. In one embodiment, information which identifies a specific element of online video content (e.g., “Mickey Cartoon, Episode 1”, music video, etc.) may be communicated. Exemplary online/streaming video credit information is shown in Table 33, and includes a video credit identifier 536, credit description information 538, video content identifier/address information 540 (e.g., URL information and additional identifying parameters, etc.), contingent QGameSquareID information 542, and contingent offer period/time window information 544. For example, the credit may effectively communicate that the associated user is to receive the specified online/streaming video content, where the specified online video credit information can be used by server 260 to identify the particular online/streaming video content that is to be credited to the user (e.g., give this user access to this particular video content for 3 minutes, etc.). In other embodiments, information that simply serves as a generic request for an online video content credit may be communicated to server 260. For example, the online video credit information communicated to online video server 260 may be such that server 260 determines or selects the specific online video asset credit that is ultimately provided to the associated user (e.g., give the user a credit for 3 minutes of free video content, any video content will do). In the most general terms, scan-triggered server 200 may select and specify, in detail, the particular online video content that is to be credited to the user and communicate this request/information to online video server 260, or scan-triggered server 200 may simply request/specify a general online video credit or type of online video, content credit, and allow online video server 260 to arbitrate/determine the actual online video content that is credited/presented to the user, including which online video show/clip/element the user is allowed to watch. Scan-triggered server 200 facilitates scanning user access to the online video content provided by online video server 260 via the scanning of an associated Q-Game square service code by a user and the subsequent communication of online video credit information to online video server 260. It will be appreciated that in other embodiments, functionality provided by online video server 260 and functionality provided by scan-triggered Q-Game square server 200 may be combined and provided by a single server that is adapted to provide both the online video content and scan-triggered service code processing/functionality described in the embodiments presented herein. In such cases, information communicated between online video server 260 and scan-triggered server 200 may be considered internal or intra-system communications.

In step 4, information is communicated to scanning mobile device 100 which may be used to facilitate redemption of the granted online video credit or access to associated online video content provided by online video server 260. Exemplary online video content access information may include online video server address information 540 (e.g., URL, IP address, network server address identifier, etc.), and online video identifying information 538, as shown in Table 33. In other embodiments, online video server 260 may be configured to communicate such information to mobile device 100. In step 5, once the necessary online video credit/access information has been provided, mobile device 100 may establish a connection (or continue using an already established) to online video server 260, which is adapted to provide online video content and redeem/provide the granted online video credit (i.e., the user can watch an online video associated with the credit). It will be appreciated that, in some embodiments, user interface module 108, communication module 118 and processor 122 associated with exemplary mobile device 100 may be used (along with other modules/functions, as necessary) to facilitate access to/the viewing of online video content (e.g., streamed video) associated with a granted online video asset credit. For example, user interface module may include, incorporate or have access to mobile web browsing capabilities, such that a web-based online video can be viewed by the device user.

In step 6, the user advances within the queue to the next waypoint location at a later time and scans Q-Game square scan code 604 (which was provisioned to be associated with the second waypoint location). The scanning of the scan code 604 results in the communication of the extracted QGameSquareID value “002” to server 200, along with user identifying information. This step is similar to scanning steps described in detail with respect to step 1. In step 7, scan-triggered Q-Game square server 200 receives the scan code and user identifying information and logs some or all of this information in a scan transaction record (or updates the user's previous scan transaction record), including received user identifying information 498, received QGameSquareID information 480, scan timestamp information 500. Module 220 determines that the user should receive an online video credit and selects and grants an online video credit/token (e.g., a credit to watch a music video, an episode of a cartoon, etc.). In one embodiment, module 220 may selectively grant the scanning user online video credits that are logically ordered or progressive in nature the further the user advances through the queue (and scans the associated progression of waypoint location Q-Game square scan codes). For example, after scanning the first Q-Game square scan code associated with a queue the scanning user may be awarded an online video credit that permits the user to watch/view Episode 1 of a cartoon. When the same user scans the next (or subsequent) Q-Game square scan codes associated with the queue, the user is granted credits which permit the user to view episode 2 of the same cartoon, etc. As such, these online video credits are referred to herein as progressive online video credits.

In step 8, scan-triggered server 200 communicates information associated with the granted online video credit/token to the online video server 260. In step 9, information is communicated to scanning mobile device 100 which may be used to facilitate redemption of the granted online video credit or access to associated online video content provided by online video server 260. In other embodiments, online video server 260 may be configured to communicate such information to mobile device 100. In step 10, once the necessary online video credit/access information has been provided, mobile device 100 may establish a connection (or continue using an already established connection) to online video server 260, which is adapted to provide online video content and redeem/provide the granted online video credit (i.e., the user can view/continue viewing an online/streaming video). In step 11, module 220 uses the information contained in the scan transaction log to calculate queue wait time metrics and/or queue volume/speed metrics. Exemplary queue metrics are shown in Table 32, and in this case an average queue wait time is calculated based on the time difference between the scanning of code 602 and 604.

Calculated queue metric information may be used by module 220 to incentivize, steer, or otherwise encourage users to preferentially elect to enter one queue versus another by dynamically varying the value of online game asset credits that are offered in one queue versus another in a manner to that described in detail previously. For example, module 220 may grant an online video credit, such as a credit to view one episode of a cartoon, where redemption of the online video credit is conditional/contingent on the user entering a specific queue and scanning one or more Q-Game scan codes associated with the specified queue. In Table 33, a contingent QGameSquareID 542, which identifies a Q-Game square associated with a specific queue waypoint location, is associated with an online video credit that may be awarded/granted to a user. Also specified is a duration or expiration time window 544 associated with the contingent offer (i.e., if the user does not enter the specified queue and scan the specified Q-Game square scan code, then the granted online video credit may not be redeemed).

In one embodiment the functionality of online video server 260 and scan triggered Q-Game square service server 200 may be provided by a single server or service platform, in which case the above mentioned communication of information may be an internal or intra-system or intra-platform communication.

It will be appreciated with regard to the Q-Game square service embodiments described above that such services may also be provided via a native Q-Game square application that is installed on the user's smartphone. In such cases, information that identifies or can be used to identify the address of a Q-Game square server to which the appointment information should be communicated need not be encoded within the Q-Game square QR code that is displayed to and scanned by a user. In such native application deployments, the information that identifies or can be used to identify the address of a Q-Game square server may be pre-configured and stored in the smartphone's memory, such as in data storage module 116. Alternatively, the native application may dynamically determine the address of the appropriate Q-Game Square server at the time of the Q-Game square QR code scan by a user. In such scenarios, Q-Game square processing is very similar to that described above, except that the address of the Q-Game square server is not obtained by a user scan of a Q-Game Square QR code.

According to one aspect, the subject matter described herein includes a system for generating queue traversal time metrics and statistics via the scanning of a scanable code by a scan-enabled client module comprises a computing platform including at least one processor. A server application module is executable by or embodied within the at least one processor. The server application module is configured to receive from the scan-enabled client module first information that identifies or can be used to identify a user and a first position in a queue. The server application module is further configured to timestamp and store the information that identifies or can be used to identify a user and a first position in a queue. The server application module is further configured to receive from the scan-enabled client module at a second time second information that identifies or can be used to identify the user and a second position in a queue. The server application module is further configured to use the first and second information to compute a queue traversal time metric.

The system for generating queue traversal time metrics and statistics may grant the user a participation incentive (e.g., digital reward, an online game asset credit, and/or an online/streaming video credit) in response to receiving the first or second information.

### FreeBie Square

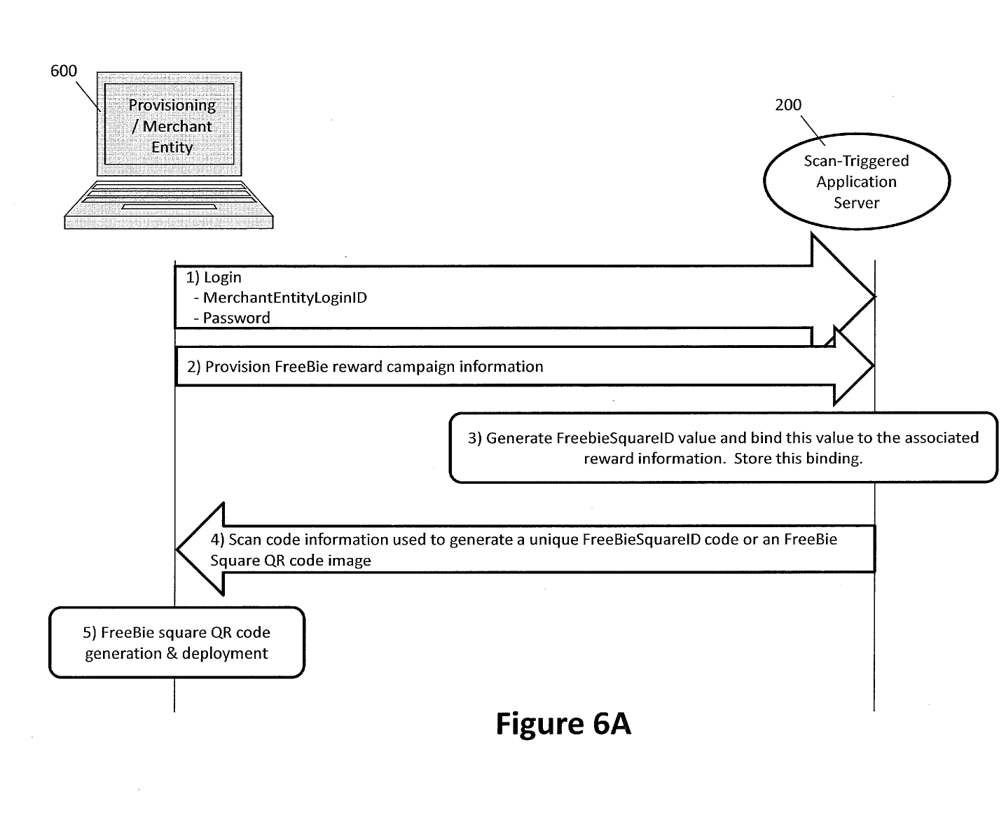

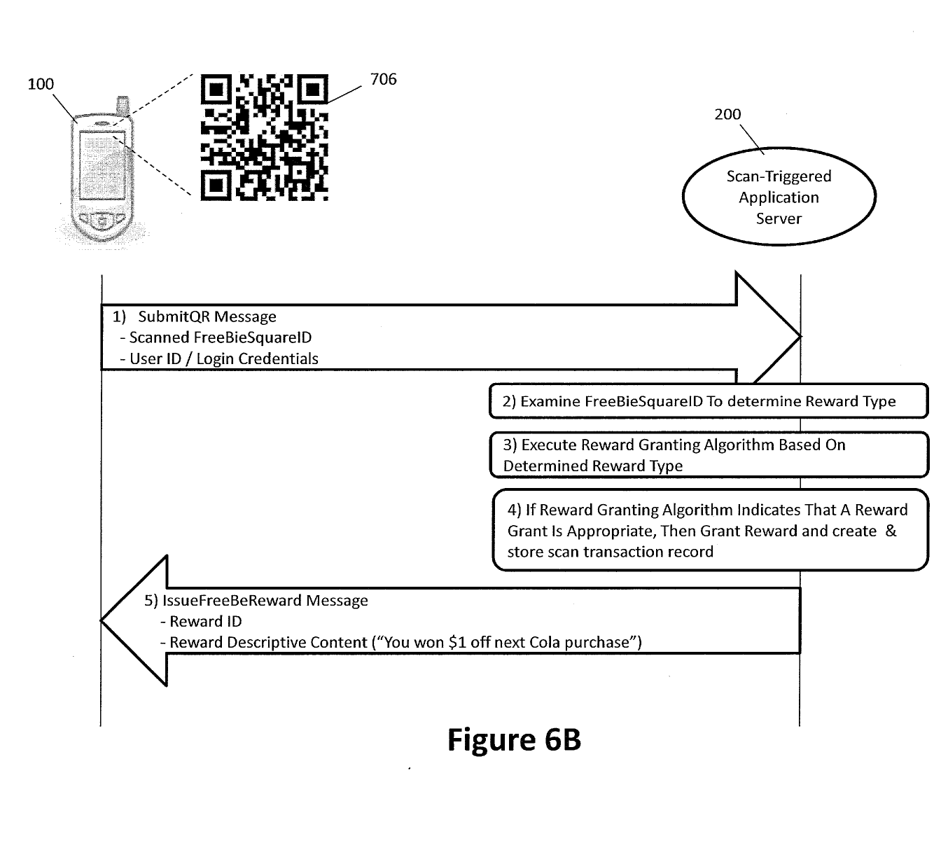

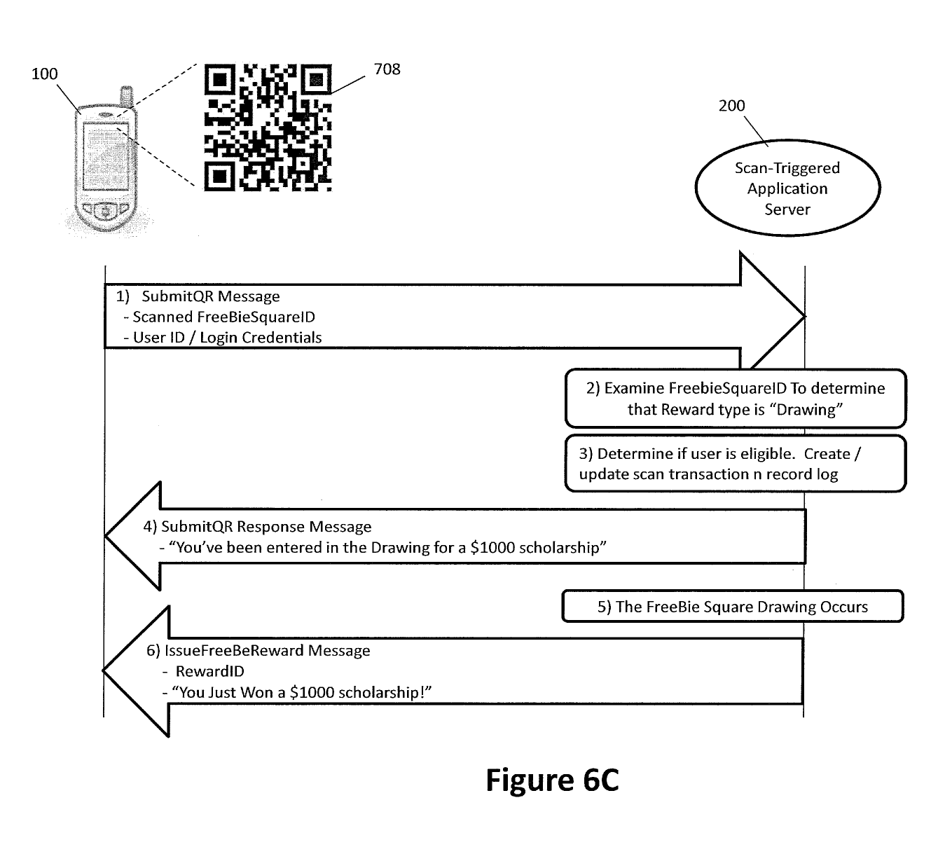

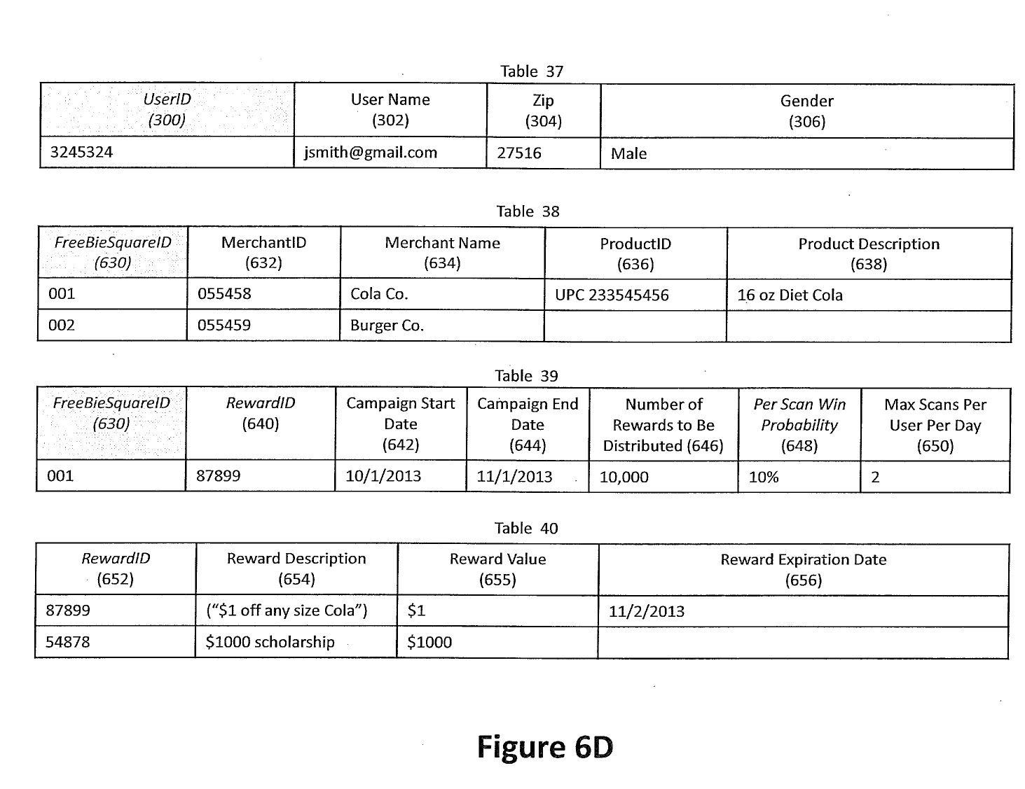

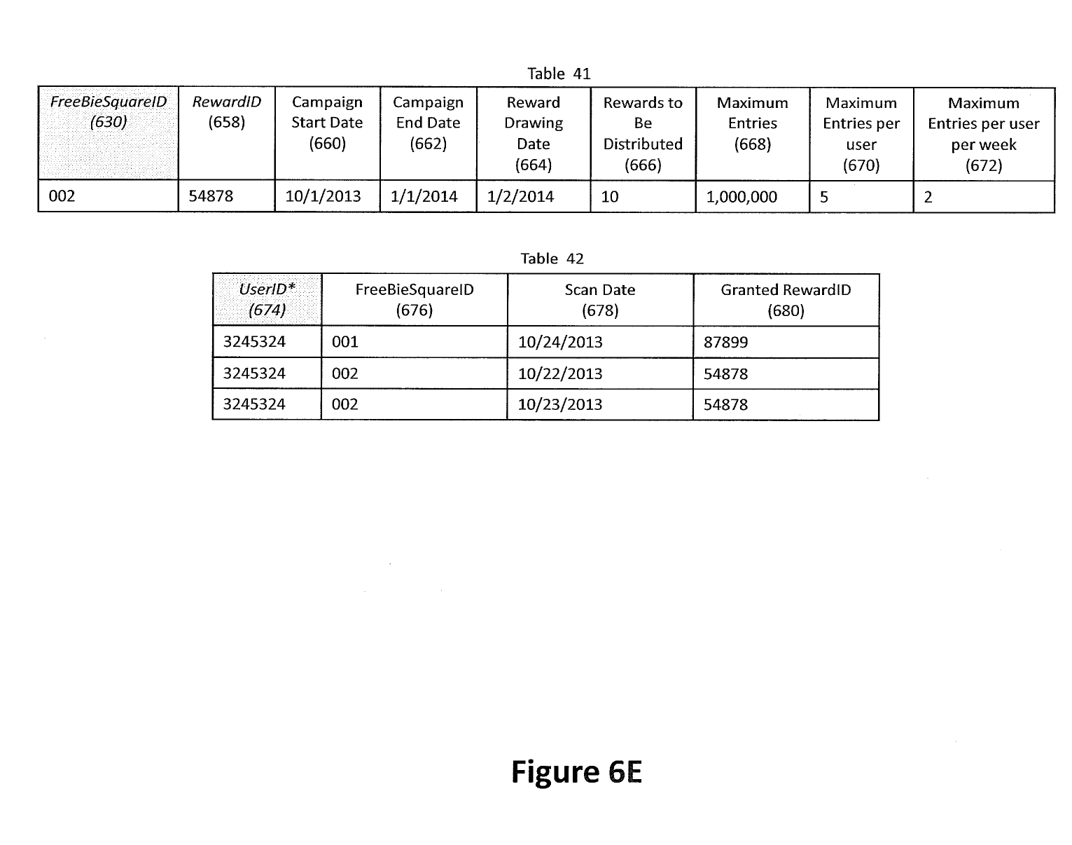

Shown in FIG. 6A is diagram that generally illustrates the provisioning of information associated with one embodiment of a service of a scan code-based service system of the present invention. This service is referred to herein as FreeBie square service, which is a service that facilitates the addition of a reward and reward information to a reward vault or wallet associated with a user that is triggered via the scanning of a FreeBie Square service scan code by the user. One exemplary use of FreeBie square service might involve a merchant who would like to distribute a reward associated with their food or drink product to a consumer. A user who would like to obtain the reward scans a FreeBie square QR code associated with the particular merchant or food product item using the QR code scanner on their mobile phone. In a first mode of operation/deployment, referred to herein as an “instant reward” mode of operation or service, the scanning of a FreeBie Square by a user essentially triggers a request for the reward from a FreeBie square service provider. The FreeBie reward request may or may not be granted by the FreeBie square service provider. For example, a FreeBie square service provider may provision a reward distribution rule that specifies the odds of winning per request. As each reward request is received, a distribution module or function associated with the FreeBie Square service makes a distribution selection decision based on the provisioned winning odds. Any number of different distribution selection algorithms or techniques may be employed by the distribution module to make the distribution selection decision. Ultimately, a request for a FreeBie reward is received from a user via the scanning of a FreeBie square scan code (e.g., QR code) and a dynamic decision is made by the FreeBie square service as to whether the user should be granted an associated reward. A user may be limited to no more than a predetermined number of scans (e.g., 5) of the same FreeBie square code or codes per a prescribed time period (e.g., per day).

In a second mode of operation/deployment, referred to herein as a “drawing” mode of operation or service, the scanning of a FreeBie square by a user essentially triggers a request for the user to be entered in a Drawing for a reward from a FreeBie square service provider. Entry into a FreeBie square facilitated drawing for a reward does not guarantee that the entering user (i.e., the user that scanned the FreeBie square scan code) will win a reward. For example, a FreeBie Square service provider may provision a FreeBie Square Drawing campaign that includes an entry starting date, an entry ending date, a drawing date, and a reward. A FreeBie square Drawing campaign may also include limits on the minimum and maximum number of users that may be entered, thereby establishing or controlling the odds of winning for any entered user. A user who scans a FreeBie square drawing scan code during the entry period will be entered into a drawing for the reward. A FreeBie square drawing campaign may include multiple rewards, such that more than one reward may be given out, thereby enabling multiple users the opportunity to win a reward during a single FreeBie Square drawing campaign. In one embodiment, of a FreeBie square drawing campaign, a user may be permitted to enter multiple times for the same Drawing, thereby increasing their odds of winning a reward. In one embodiment, a user may be limited to no more than a predetermined number of scans (e.g., 1) of the same FreeBie square drawing scan code or codes per a prescribed time period (e.g., per week).

Presented below is a first example that is intended to illustrate an “instant reward” mode of FreeBie square service operation. In this first example, to provision a FreeBie Square code, a provisioning or merchant entity uses computer terminal 600 to log into a provisioning interface associated with a scan-triggered application server 200 that is hosting the FreeBie square application, as indicated in step 1. In step 2, the merchant entity provisions FreeBie square instant reward campaign information. Exemplary instant reward mode campaign provisioning may include, but is not limited to, merchant identifier 632, merchant name 634, associated product name 638, associated product identifier 636 (e.g., SKU, GTIN or UPC code information), reward identifier information 640, reward description information 654, Reward value information 655, Reward expiration date information 656, reward redemption details and limitation information, FreeBie square campaign start date 642, FreeBie square campaign end date 644, maximum rewards to be distributed information 646, per scan win probability/odds information 648, and maximum allowed scans per user per day 650. Such exemplary provisioning data is shown in Tables 38-39, in FIG. 6D. Exemplary participation reward information is shown in Table 40 and includes reward ID information 652, reward description information 654, reward value information 655, reward expiration information 656.

It will be appreciated that in other embodiments, the entity that is provisioning or “sponsoring” the FreeBie square campaign may also provision information which can be encoded into FreeBie square scan codes that can be used to identify a particular distribution entity associated with a FreeBie square marked or tagged product. For example, a unique identifier could be associated with each grocery store that distributes cans of a cola manufacturer's cola. If the cola manufacturer is hosting/sponsoring/provisioning the FreeBie square campaign, the cola manufacturer can then place a unique FreeBie square scan code on all cola cans that will be sold through grocery store chain A. Likewise a unique FreeBie square scan code is placed on all cola cans that will be sold through grocery store chain B. As users scan these FreeBie square QR codes, the cola manufacturer can compile metrics and statistics related to the number of scans attributable to each distribution partner/grocery store chain. Such meta-data tagging of FreeBie Square scan codes may be employed to compile similar metrics and statistics for any type of distribution analysis that the cola manufacturer wishes. FreeBie Square QR codes could be uniquely meta-tagged by geographic region, by distribution location, by event venue, etc.

Continuing with the instant reward campaign example shown in FIG. 6A, once provisioning is completed, in step 3, a FreeBieSquareID value is generated by server 200 and bound to the provisioned data, as generally illustrated in Tables 38-40. In one embodiment, the binding is facilitated by a binding record that is stored by and is accessible to server 200. In step 4, FreeBie Square scan code information is communicated to provisioning entity 600. In step 5, the FreeBie square scan code, which includes the FreeBieSquareID value that can be used to identify the provisioned FreeBie square campaign is deployed for users to scan. In this example, a FreeBieSquareID value is generated by FreeBie square control logic module 222 and incorporated into the FreeBie square QR code(s). It will be appreciated that in other embodiments, multiple identifiers may be employed to facilitate association with a provisioned FreeBie Square campaign.

In one embodiment, information (e.g., URL, IP address, etc.) that identifies or can be used to identify scan-triggered application server 200 is also encoded in the FreeBie Square QR code. As such, a FreeBie square QR code also includes information that identifies or can be used to identify and establish communications with a network server or host computer that provides FreeBie square service. Exemplary information that identifies or can be used to identify a network server or host computer for providing FreeBie Square service may include, but is not limited to, a uniform resource locator (URL) and URL parameters, an Internet protocol (IP) address and port identifier.

FreeBie square QR codes may be deployed in any number of ways and formats including, but not limited to, on packaging of food or drink products, on displays or shelves where a food or drink product is sold, on a receipt associated with the purchase of a food or drink item, printed tags that are placed on the shelf that holds/displays the associated product, direct mailing collateral, in-store displays, computer monitor display, magazine advertisements, purchase receipts, as per step 5.

Shown in FIG. 6B is exemplary processing and information flow associated with embodiments of FreeBie square scan-triggered service. A io user/mobile device 100 scans FreeBie square code 706, which causes scan-enabled client module 104 to communicate user identifying/user login credentials and the FreeBieSquareID information extracted from code 706 to FreeBie Square application server 200, as indicated in step 1. When the FreeBie square QR code is scanned by the user's QR code scanner, the encoded FreeBieSquareID information and FreeBie Square server identifier or address information is extracted by the QR code scanner and the information that identifies or can be used to identify a FreeBie square application server is used to facilitate communication of the extracted FreeBieSquareID information to the identified FreeBie square application server 200. It will be appreciated that in various embodiments of the subject matter described herein, the FreeBieID information may be encrypted or obfuscated during communication from the user's mobile communication device to the FreeBie square application server. In other embodiments, the information that identifies or can be used to identify a FreeBie square application server may itself be encrypted or obfuscated when read by the QR code scanner, and may be subsequently decrypted/de-obfuscated by scan control logic module 112 so as to obtain the information necessary to identify the FreeBie square application server to be contacted. Also communicated to the FreeBie square application server is information that identifies or can be used to identify the user (e.g., the person that scans the FreeBie square QR code). This user identifying information may be provided to the FreeBie square application server 200 before, after, or at the same time that the previously discussed scanned information is provided. For example, in one embodiment, the user may log in (i.e., provide login credentials that are sufficient to identify and authenticate the user) prior to scanning the FreeBie square QR code, and application server 200 is adapted to associate the subsequently received FreeBieID information with the user. Alternatively, the user's login credentials may be provided at the time of/as a result of the FreeBie square QR code scan, along with the FreeBieID information.

FreeBie square application server 200 receives the scan-related information, which includes user identifying/user login credentials and FreeBie Square campaign identifying information (e.g., FreeBieSquareID), and FreeBie Square Control Logic Module 222 is adapted to use the received FreeBieSquareID information to access the previously provisioned FreeBie Square reward campaign information/record(s), as indicated in step 2. Module 222 may also use the received information to determine whether the associated requesting/scanning user has exceeded the maximum number of allowed request attempts for the associated FreeBie square reward campaign. To perform such analysis, FreeBie square control logic module 222 examines historical scan/reward request data associated with the user that has been logged and stored in data storage module 212, and may include determining whether the associated requesting/scanning user has already received or been granted a reward associated with the same FreeBie square campaign (i.e., determining whether the user is eligible to receive a reward).

Once such preliminary screening is completed, and assuming that the user request passes this screening, FreeBie square control logic module 222 executes a reward grant selection algorithm to determine whether the requesting user is granted a reward, where in one embodiment the particular reward grant selection algorithm may be evaluated based, at least in part, on the received FreeBieSquareID value associated with the user scan (step 3). In practice any number and type of reward grant selection algorithms may be employed. In the example present herein, the reward grant selection algorithm generates a random selection outcome (e.g., “win”, “lose”) that complies with the provisioned per-scan-win-probability value for the campaign. A random or pseudo-random number may be generated and used to determine the selection outcome. In step 4, a reward grant decision is made, based at least in part, on the evaluated reward grant selection algorithm. In one embodiment, as indicated reward grant decision is made, based at least in part, on the previously provisioned FreeBie Square service data. A scan transaction record is created by module 222 and some or all of the received, scan-related information is stored. Exemplary scan transaction data is shown in Table 42 and includes user identifying information 674, associated/received FreeBieSquareID identifier information 676, scan timestamp information 678, and granted RewardID information 680. As indicated in step 5, the scanning user is notified of the resulting selection outcome and, depending on the selection outcome, may be granted a reward accordingly.

Presented in FIG. 6C and described below is a second exemplary embodiment of FreeBie Square service that is intended to illustrate a “drawing” mode of operation. In this second example, to provision a FreeBie Square code, a provisioning entity uses computer terminal 600 in a similar manner to that previously described to log into a provisioning interface associated with an application server 200 that is hosting the FreeBie square application. The provisioning entity provisions FreeBie square reward drawing campaign information. Exemplary Drawing mode campaign provisioning may include, but is not limited to, merchant identifier, merchant name, associated product name, associated product UPC code information, reward identifier information 658, reward description information 654, reward value information 655, reward expiration date information 656, Reward redemption details and limitation information, FreeBie square drawing campaign start date 660, FreeBie square drawing campaign end date 662, FreeBie square drawing campaign drawing date 664, rewards to be distributed information 666, maximum entries information 668, maximum entry scans per user 670, and maximum entry scans per user per week 672. Such exemplary provisioning data is shown in Tables 39 and 41.

It will be appreciated that in other embodiments, the entity that is provisioning or “sponsoring” the FreeBie square campaign may also provision information which can be encoded into FreeBie square scan codes that can be used to identify a particular distribution entity associated with a FreeBie square marked or tagged product. For example, a unique identifier could be associated with each grocery store that distributes cans of a cola manufacturer's cola. If the cola manufacturer is hosting/sponsoring/provisioning the FreeBie square campaign, the cola manufacturer can then place a unique FreeBie square scan code on all cola cans that will be sold through grocery store chain A (e.g., a FreeBie square scan code which contains an encoded FreeBieSquareID value that can be used to uniquely identify store chain A as the associated selling venue/location/entity, etc.). Likewise a FreeBie Square scan code is placed on all cola cans that will be sold through grocery store chain B, which contains information that may be used by server 200 to associate the scan code with store chain B. As users scan these FreeBie square QR codes, the cola manufacturer can compile metrics and statistics related to the number of scans attributable to each distribution partner/grocery store chain. Such meta-data tagging of FreeBie square scan codes may be employed to compile similar metrics and statistics for any type of distribution analysis that the cola manufacturer wishes. FreeBie square QR codes could be uniquely meta-tagged by geographic region, by distribution location, by event venue, etc.

Continuing with the drawing campaign example shown in FIG. 6C, once provisioning is completed, FreeBie square QR codes are generated, where the FreeBie Square QR codes includes information that can be used to identify the associated FreeBie square drawing campaign. In this example, a FreeBieSquareID value is generated by FreeBie square control logic module 222 and incorporated into the FreeBie Square QR code(s). However, it will be appreciated that in other embodiments, multiple identifiers may be employed to facilitate association with a provisioned FreeBie Square reward “Drawing” campaign.

In one embodiment, information that identifies or can be used to identify application server 200 is also encoded in the FreeBie square QR code. The exemplary FreeBie square QR code also includes information that identifies or can be used to identify and establish communications with a network server or host computer that provides FreeBie square service. Exemplary information that identifies or can be used to identify a network server or host computer for providing FreeBie Square service may include, but is not limited to, a uniform resource locator (URL) and URL parameters, an Internet protocol (IP) address and port identifier.

A user scans FreeBie Square code 708 associated with a FreeBie Square Drawing campaign. Scanning of the FreeBie Square code causes the scan-enabled client module 104 to communicate user identifying/user login credentials and FreeBie information to FreeBie square application server 200, as indicated in step 1. When the FreeBie square QR code is scanned by the user's QR code scanner, the encoded FreeBieID information and FreeBie square server identifier or address information is extracted by the QR code scanner and the information that identifies or can be used to identify a FreeBie square application server is used to facilitate communication of the extracted FreeBieID information to the identified FreeBie square application server. It will be appreciated that in various embodiments of the present invention, the FreeBieID information may be encrypted or obfuscated during communication from the user's mobile communication device to the FreeBie square application server. In other embodiments, the information that identifies or can be used to identify a FreeBie Square application server may itself be encrypted or obfuscated when read by the QR code scanner, and may be subsequently decrypted/de-obfuscated by scan control logic module 112 so as to obtain the information necessary to identify the FreeBie square application server to be contacted. Also communicated to the FreeBie square application server is information that identifies or can be used to identify the user (e.g., the person that scans the FreeBie square QR code). This user identifying information may be provided to the FreeBie square application server 200 before, after, or at the same time that the previously discussed scanned information is provided. For example, in one embodiment, the user may log in (i.e., provide login credentials that are sufficient to identify and authenticate the user) prior to scanning the FreeBie square QR code, and application server 200 is adapted to associate the subsequently received FreeBieID information with the user. Alternatively, the user's login credentials may be provided at the time of/as a result of the FreeBie square QR code scan, along with the FreeBieID information.

FreeBie square application server 200 receives the scan code information, which includes user identifying/user login credentials and extracted FreeBieSquareID campaign identifying information (e.g., FreeBieID), and FreeBie square control logic module 222 is adapted to use the received information to determine/identify the associated reward campaign (step 2). Server 200 logs or records the received information in a scan transaction record. In step 3, module 222 uses the received user identifying information to determine whether the scanning user is eligible to enter the associated reward drawing. For example, module 222 may determine whether the associated scanning user has exceeded the maximum number of allowed/permitted drawing entry request attempts. To perform such preliminary screening, FreeBie square control logic module 222 examines historical scan/reward request data associated with the user that has been logged and stored in Data Storage Module 212. Preliminary screening may include determining whether the associated requesting/scanning user has already received or been granted a reward associated with the same FreeBie square reward drawing campaign.

Once preliminary screening is completed, and assuming that the user request passes this screening, FreeBie square control logic module 222 is adapted to generate and store in data storage module 212 a scan transaction/drawing entry record for the user, which effectively servers to enter the user in the drawing. An exemplary drawing entry record is shown in Table 42 of FIG. 6E. Exemplary drawing entry/scan transaction information in Table 42 includes user identifying information 674, FreebieSquareID information 676, scan transaction timestamp information 678, granted reward identifier information 680. It will be appreciated that, in some embodiments, a user may submit and be granted multiple entries in the same drawing, depending on provisioned reward drawing campaign rules/entry criteria. In step 4, the drawing entry status information is communicated to the user/mobile device 100.

Once the drawing campaign entry period closes and the Drawing date arrives, FreeBie square control logic module 222 is adapted to randomly select one or winners using the collection of drawing entry records that have been amassed during the entry period for the drawing campaign (step 5). Any number of techniques or methodologies may be utilized to select one or more winners from the pool of entries, including for example, generating a random or pseudo-random number that is used to index into the table or data structure containing the drawing entry records. Once the winner or group of winners is selected, each winner may be notified by application server 200 as shown in step 6.

It will be appreciated with regard to the FreeBie square service embodiments described above that such services may also be provided via a native FreeBie square application that is installed on the user's smartphone. In such cases, information that identifies or can be used to identify the address of a FreeBie square server to which the appointment information should be communicated need not be encoded within the FreeBie square QR code that is displayed to and scanned by a user. In such native application deployments, the information that identifies or can be used to identify the address of a FreeBie square server may be pre-configured and stored in the smartphone's memory, such as in data storage module 116. Alternatively, the native application may dynamically determine the address of the appropriate FreeBie square server at the time of the FreeBie square QR code scan by a user. In such scenarios, FreeBie square processing is very similar to that described above, except that the address of the FreeBie square server is not obtained by a user scan of a FreeBie square QR code.

It will be appreciated that embodiments of the FreeBie square service enable a user to interact and participate in merchant-sponsored reward promotions in a manner that keeps their identity and interest hidden from the merchant who generates and displays the FreeBie square scan code. Users may, at their discretion, choose to allow a vendor associated with a FreeBie square code that the users have scanned to obtain access to information that identifies the users.

According to one aspect of the subject matter described herein, a system for facilitating the distribution of a reward via the scanning of a scanable code by a scan-enabled client module is provided. The system includes a computing platform including at least one processor. The system further includes a server application module executable by or embodied within the at least one processor and configured to receive, from the scan-enabled client module, information that can be used to identify a reward grant request. The server application module is further configured to determine based on a reward grant probability whether to grant the user a reward. The server application module is further configured to, in response to determining that a reward should be granted to the user, granting a reward to the user.

According to another aspect of the subject matter described herein, a system for facilitating the distribution of a reward via the scanning of a scanable code by a scan-enabled client module includes a computing platform including at least one processor. The system further includes a server application module executable by or embodied within the at least one processor. The server application module is configured to receive, from the scan-enabled client module, information that can be used to identify the user and, as a result of the scanning of a scanable code, information that can be used to identify a drawing for a reward. The server application module is further configured to enter the user in the drawing for the reward.

### Question Square

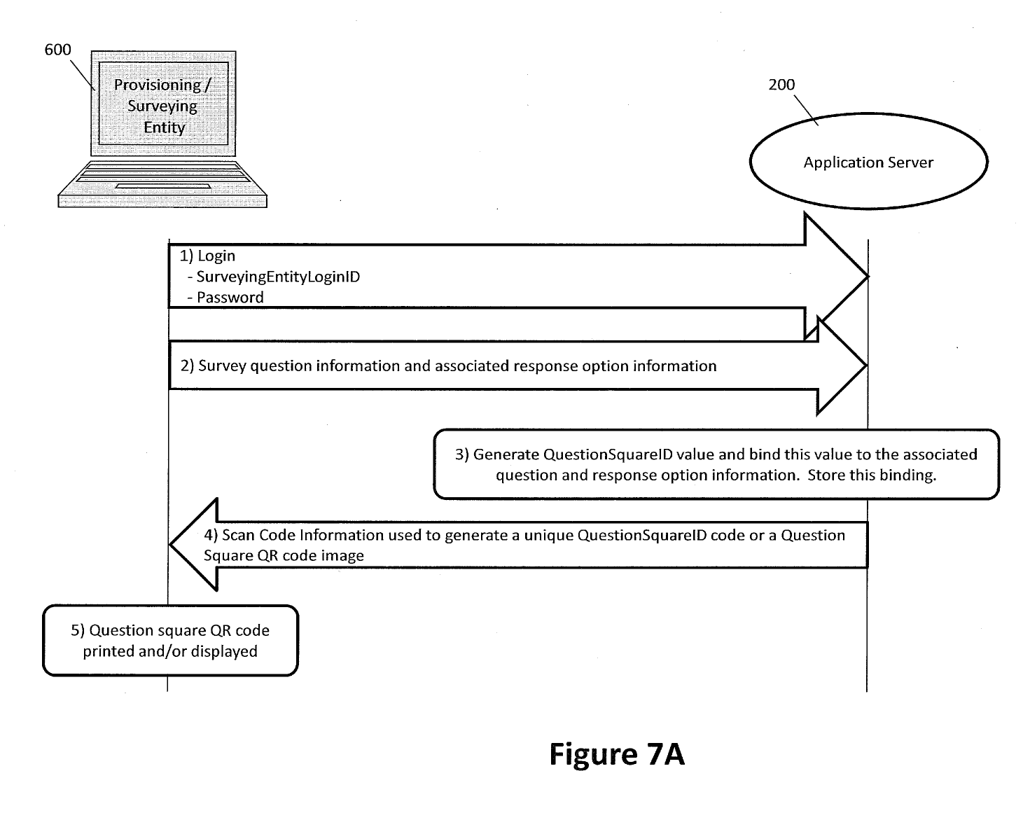

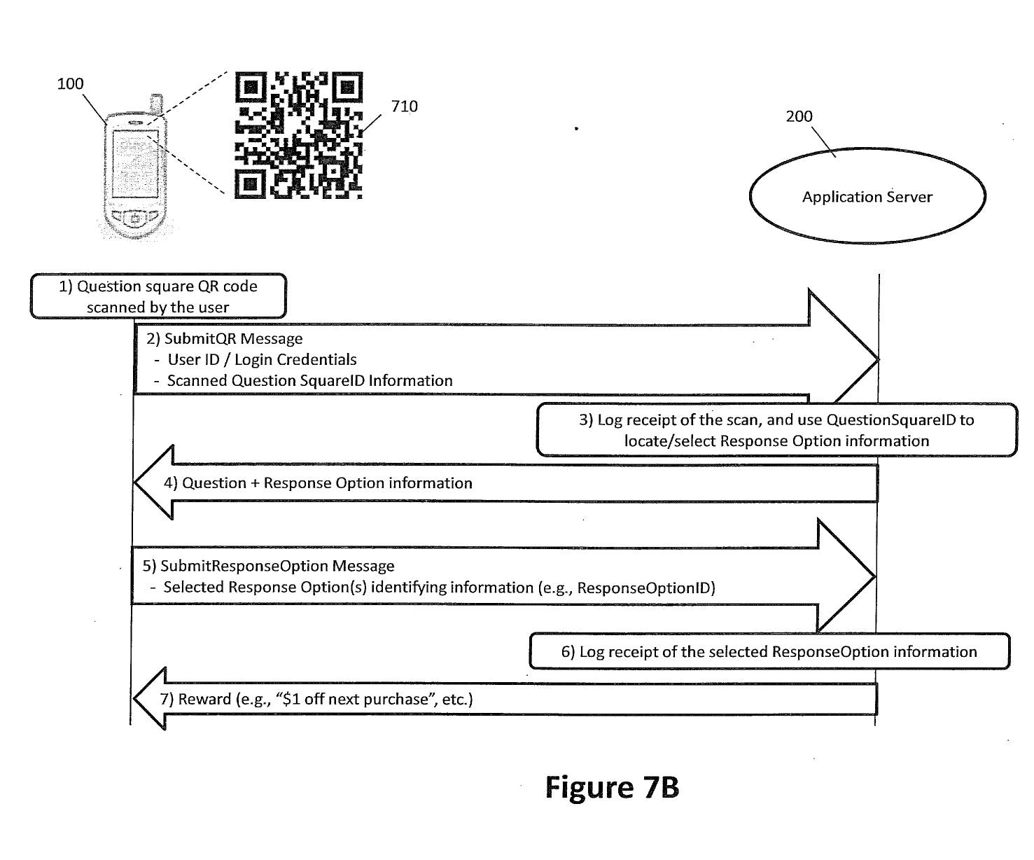

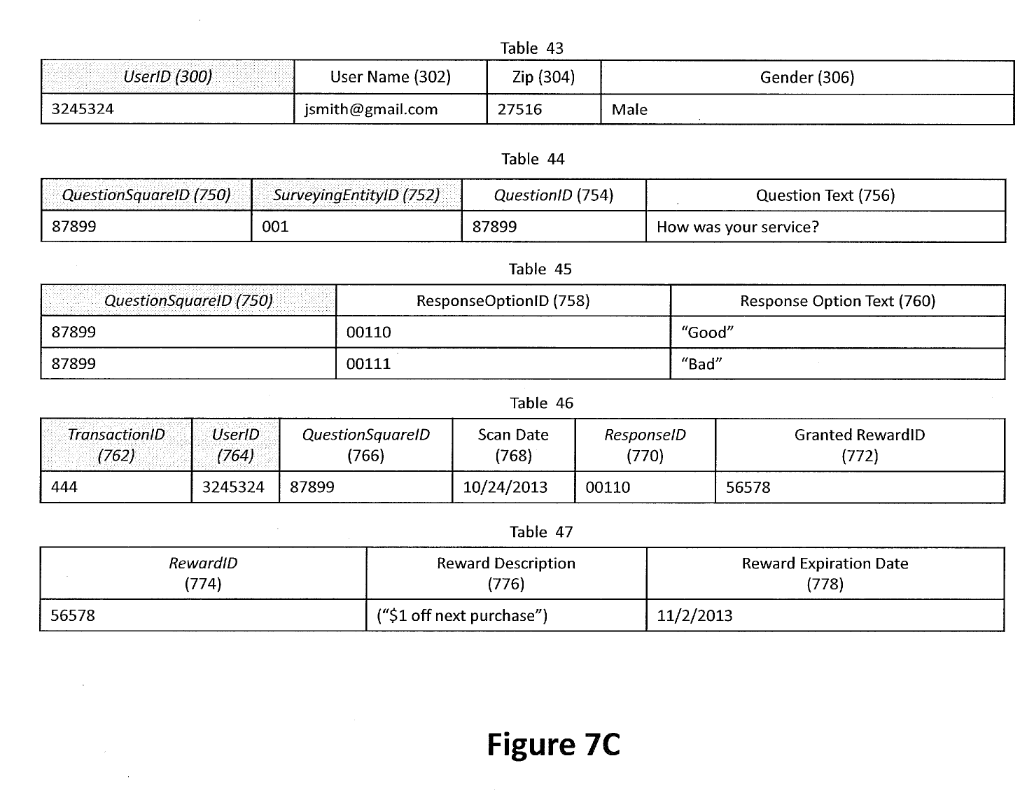

Shown in FIG. 7A is diagram that generally illustrates the provisioning of information associated with one embodiment of a service of a scan code-based service system. This service is referred to herein as question square service, which is a service that enables a surveying entity (e.g., a merchant) to collect survey information (e.g., customer satisfaction information, opinion poll information, etc.) from mobile phone or mobile computer (e.g., tablet) users via the use a scanner (e.g., QR code scanner, NFC scanner, RFID scanner, Bluetooth scanner, etc.) associated with the mobile device.

One exemplary use of question square service might involve a merchant who would like to solicit feedback from the merchant's customers. A customer who would like to provide feedback scans a question square QR code associated with the text of a particular question (e.g., “How as your service?”) using the QR code scanner on the user's mobile phone. Scanning of the question square causes a set of possible responses to the question (i.e., response options) to be displayed to the customer on the customer's mobile phone. The customer can select one or more of the displayed response options. The selected response option information is communicated to a server associated with the scan-code based survey system and stored. Information that identifies or can be used to identify the customer may also be communicated to the server and stored. The question square service may also provide the customer with a participation reward for scanning the question square scan code (e.g., QR code) associated with a particular survey question. The question square service may facilitate and track redemption of the participation reward by the customer.

User information, such as user scan-triggered service account information may be provisioned for or by a user. Exemplary user information is shown in Table 43 and includes user identifier information 300, username information 302, user address/zip code information 304, and user gender information 306.

In this example, to provision a question square code, a provisioning/surveying entity (e.g., a merchant) uses computer terminal 600 to log into a provisioning interface associated with an application server 200 that is hosting the question square application, as indicated in step 1. In step 2, the surveying entity provisions question information (e.g., question text, etc.), response option information (e.g., response option text), and participation reward information and distribution criteria. In this example, a unique QuestionSquareID identifier 750 is assigned or bound to provisioned question information (step 3), where such provisioned question information may include, but is not limited to, a SurveyingEntityID identifier 752 for identifying a surveying entity such as a merchant or pollster, etc., a QuestionID identifier 754 for identifying survey question content, question text content 756, ResponseOptionID identifier 758 for identifying possible answers/response options associated with the question, and response option/answer text content 760, as shown in Tables 44 and 45. Server 200 stores this QuestionSquareID binding information. As such, server 200 is adapted to use a received QuestionSquareID value to lookup or otherwise access/locate associated question and response option information. In one embodiment, one or more participation rewards may also be associated with a QuestionSquareIDinformation. Such rewards may, for example, be granted to a user who scans the associated Question Square scan code, or who subsequently provides response option information to server 200. Exemplary participation reward information is shown in Table 47 and includes reward ID information 774, reward description/reward value information 776, reward expiration information 778.

Exemplary data tables and data structures associated with various embodiments of question square service are presented in FIG. 7C. Once provisioning is completed for the product, a Question Square QR code 710 is generated, where the question square QR code includes information (e.g., QuestionSquareID) that identifies or can be used to identify the associated surveying entity, the question, and the response option(s) associated with the question (step 4). In this example, a QuestionID value is generated by question square control logic module 208 and incorporated into the question square QR code. It will be appreciated that multiple independent identifiers could be incorporated into the question square QR code, or a single identifier which contains sufficient information to identify the surveying entity, question and response options could also be used.

In one embodiment, information that identifies or can be used to identify application server 200 is also encoded in the question square QR code. The exemplary question square QR code also includes information that identifies or can be used to identify and establish communications with a network server or host computer that provides question square service. Exemplary information that identifies or can be used to identify a network server or host computer for providing question square service may include, but is not limited to, a uniform resource locator (URL) and URL parameters, an Internet protocol (IP) address and port identifier.

Copies of the question square QR code 710 may be deployed in any number of ways and formats including, but not limited to, on packaging of food or drink products, on displays or shelves where a food or drink product is sold, on a receipt associated with the purchase of a food or drink item, printed tags that are placed on the shelf that holds/displays the associated product, direct mailing collateral, in-store displays, computer monitor display, magazine advertisements, purchase receipts, as per step 5.

In FIG. 7B, step 1, user/mobile device 100 scans question square code 710. Scanning of the question square code causes the scan-enabled client module 104 to communicate user identifying/user login credentials and question identifying information to question square application server 200, as indicated in step 2. When the question square QR code is scanned by the user's QR code scanner, the encoded QuestionSquareID information and question square server identifier or address information is extracted by the QR code scanner and the information that identifies or can be used to identify a question square application server is used to facilitate communication of the extracted QuestionSquareID information to the identified question square application server. It will be appreciated that in various embodiments of the subject matter described herein, the QuestionID information may be encrypted or obfuscated during communication from the user's mobile communication device to the question square application server. In other embodiments, the information that identifies or can be used to identify a question square application server may itself be encrypted or obfuscated when read by the QR code scanner, and may be subsequently decrypted/de-obfuscated by scan control logic module 112 so as to obtain the information necessary to identify the question square application server to be contacted. Also communicated to the Question Square application server is information that identifies or can be used to identify the user (e.g., the person that scans the question square QR code). This user identifying information may be provided to the question square application server 200 before, after, or at the same time that the previously discussed scanned information is provided. For example, in one embodiment, the user may log in (i.e., provide login credentials that are sufficient to identify and authenticate the user) prior to scanning the question square QR code, and application server 200 is adapted to associate the subsequently received QuestionSquareID information with the user. Alternatively, the user's login credentials may be provided at the time of/as a result of the question square QR code scan, along with the QuestionSquareID information.

Question square application server 200 receives the scan code information, which may include user identifying/user login credentials and question identifying information (e.g., QuestionSquareID) and logs receipt of the scan, as indicated in step 3. Server 200 logs or records the received information in a scan transaction record. Exemplary scan transaction record information is shown in Table 46 and includes a scan transaction identifier 762, user identifying information 764, QuestionSquareID information 766, scan timestamp information 768, user provide response option identifying 770, granted reward ID information 772. The QuestionSquareID information is used to locate one or more associated response options that have been provisioned for the question and which have been stored in Data Storage Module 212. Application server 200 responds to the mobile user with the response option information, which is displayed to the user of mobile device 100, as indicated in step 4.

In step 4, the user of mobile device 100 selects one or more of the displayed response options (e.g., by tapping or touch a response option button that is displayed on the screen of the user's mobile device. In step 5, information that can be used by control module 218 to identify the selected response option is communicated to application server 200. Question square control logic module 218 receives stores the provided response option information, as indicated in step 6. If user identifying information has also been provided, the user identifying information is bound to the received question/response option information and also stored/logged.

In one embodiment, question square control logic module 218 may determine (based on prior provisioned rules) whether the user should be granted a reward in exchange for scanning the question square code. If a reward is to be granted, reward control logic module 210 may facilitate the crediting of the granted reward to the user's account, as indicated in step 7. Exemplary reward information is present in Table 47, and includes RewardID information 774, reward description information 776, and reward expiration information 778. In one embodiment, a granted reward may be credited to a digital reward wallet associated with the user's scan-triggered question square account/scan-triggered services account.

It will be appreciated with regard to the question square service embodiments described above that such services may also be provided via a native question square application that is installed on the user's smartphone. In such cases, information that identifies or can be used to identify the address of a question square server to which the appointment information should be communicated need not be encoded within the question square QR code that is displayed to and scanned by a user. In such native application deployments, the information that identifies or can be used to identify the address of a question square server may be pre-configured and stored in the smartphone's memory, such as in data storage module 116. Alternatively, the native application may dynamically determine the address of the appropriate question square server at the time of the question square QR code scan by a user. In such scenarios, question square processing is very similar to that described above, except that the address of the question square server is not obtained by a user scan of a question square QR code.

It will be appreciated that embodiments of the question square service enable a user to provide feedback to, receive rewards, and generally interact with a surveying entity (e.g., a merchant) in a manner that keeps the user's identity and interest hidden from the surveying entity who generates and displays the question square scan code. That is, the surveying entity need not ever be shown the user's actual identity. An alias or internal identifier other than the user's name or email address, such as UserID in Table 1 of FIG. 3F, may be associated with the user, and only the alias user identifier is shown to the surveying entity. Users may, at their discretion, choose to allow a surveying entity associated with a question square code that the users have scanned to obtain access to information that identifies the users.

According to another aspect of the subject matter described herein, a system for soliciting and collecting user feedback using information obtained from the scanning of a scanable code by the user of a scan-enabled client module is provided. The system includes a computing platform including at least one processor. The system further includes a server application module executable by or embodied within the at least one processor and configured to receive from the scan-enabled client module associated with a user first identifying information obtained from the scanning of a scanable question code which can be used to identify one or more response options associated with the question The server application module is further configured to, in response to receiving the first identifying information, communicate response option information associated with the question to the client module. The server application module is further configured to receive from the client module second identifying information which can be used to identify a response option selected by the user.

It will be appreciated that in all of the above described embodiments, in cases where a scanning user is not registered with the scan-based service system at the time of the service code scan, the user may be prompted to register first, before proceeding further. In some cases, where appropriate, service may be made available to un-registered users. For example, question square service may be made available using the present scan-based service system to unregistered users. Any user information that is needed to provide the requested scan-code triggered service which is not available to the service at the time of the user scan may be collected by the service following the scan. Such user information may be stored in the scan code-based system for future use in providing requested services to the user.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A system for alerting a user to the presence of a food allergen or a food attribute via the scanning of a scanable code by a scan-enabled client module, the system comprising:
a computing platform including at least one processor:
a server application module executable by or embodied within the at least one processor and configured to:
receive, from the scan-enabled client module of a user, information that can be used to identify the user and food or beverage product identifying information obtained from the scanning of an associated scanable service code by a user;
use the food or beverage product identifying information to access allergen information associated with the food or beverage product;
use the user identifying information to access a food or beverage product allergen profile associated with the user; and
based on the food or beverage product identifying information and the food or beverage product allergen profile associated with the user, determine if a food allergen notification should be provided to the user; and
in response to determining that a food allergen notification should be provided to the user, provide the user with a food or beverage allergen alert notification.

2. The system of claim 1 wherein the information that can be used to identify the user includes scan-triggered service user access credential information.

3. The system of claim 1 wherein the food or beverage product identifying information includes an EatSafeSquareID identifier value.

4. The system of claim 1 wherein the food or beverage product allergen profile associated with the user includes a food or beverage product allergen profile associated with one of the user, the user's family members, and the user's friends.

5. The system of claim 1 wherein the server application module is adapted to communicate one of food or beverage product recall information and food or beverage product expiration information to the user.

6. The system of claim 1 including collecting feedback information from the user.

7. The system of claim 1 including granting the user a reward.

8. A method of for alerting a user to the presence of a food allergen or a food attribute via the scanning of a scanable code by a scan-enabled client module, the method comprising:
receiving, from the scan-enabled client module of a user, information that can be used to identify the user and food or beverage product identifying information obtained by the scan-enabled client module in response to scanning of an associated scanable service code by a user;
using the food or beverage product identifying information to access allergen information associated with the food or beverage product;
using the user identifying information to access a food or beverage product allergen profile associated with the user; and
based on the food or beverage product identifying information and the food or beverage product allergen profile associated with the user, determining if a food allergen notification should be provided to the user; and
in response to determining that a food allergen notification should be provided to the user, providing the user with a food or beverage allergen alert notification.

9. The method of claim 8 wherein the information that can be used to identify the user includes scan-triggered service user access credential information.

10. The method of claim 8 wherein the food or beverage product identifying information includes an EatSafeSquareID identifier value.

11. The method of claim 8 wherein the food or beverage product allergen profile associated with the user includes a food or beverage product allergen profile associated with one of the user, the user's family members, and the user's friends.

12. The method of claim 8 including communicating one of food or beverage product recall information and food or beverage product expiration information to the user.

13. The method of claim 8 including collecting feedback information from the user.

14. The method of claim 8 including granting the user a reward.

15. A system for providing scan-triggered product notification messages, the system comprising:
a computing platform including at least one processor:
a server application module executable by or embodied within the at least one processor and configured to:
receive product identifier information from a scan-enabled client module associated with a user, wherein the product identifier information is obtained by the scan-enabled client module in response to scanning of a scanable service code;
use the received product identifier information to determine whether product notification information should be communicated to the user; and
in response to determining that product notification information should be communicated to the user, communicate the product notification information to the user.

16. The system of claim 15 wherein the product identifier information includes an EatSafeSquareID value.

17. The system of claim 15 wherein the product notification information includes product recall information and product expiration information.

18. The system of claim 16 wherein the EatSafeSquareID value includes a global trade identification number (GTIN).

19. The system of claim 15 including collecting feedback information from the user.

20. The system of claim 15 including granting the user a reward.

21. A method for providing scan-triggered product notification messages, the method comprising:
receiving product identifier information from a scan-enabled client module associated with a user, wherein the product identifier information is obtained by the scan-enabled client module in response to scanning of a scanable service code;
using the received product identifier information to determine whether product notification information should be communicated to the user; and
in response to determining that product notification information should be communicated to the user, communicating the product notification information to the user.

22. The method of claim 21 wherein the product identifier information includes an EatSafeSquareID value.

23. The method of claim 21 wherein the product notification information includes product recall information and product expiration information.

24. The method of claim 22 wherein the EatSafeSquareID value includes a global trade identification number (GTIN).

25. The method of claim 21 including collecting feedback information from the user.

26. The method of claim 21 including granting the user a reward.
